(19) United States
(12) Patent Application Publication
(10) Pub. No.: US 2025/0348269 A1
(43) Pub. Date: Nov. 13, 2025

(54) STORING, DETERMINING, AND RENDERING SUBSETS OF CORRELATED INFORMATION FOR LANGUAGE TRANSLATIONS

(71) Applicant: Tracy Burnett, Briones, CA (US)

(72) Inventor: Tracy Burnett, Briones, CA (US)

(21) Appl. No.: 19/060,617

(22) Filed: Feb. 21, 2025

Related U.S. Application Data
(60) Provisional application No. 63/556,312, filed on Feb. 21, 2024.

(51) Int. Cl. G06F 3/16

(52) U.S. Cl. CPC G06F 3/165; G06F 3/162

(57) ABSTRACT

Various embodiments are disclosed that relate to creating, updating, processing, rendering, teaching, and learning from language metadata that is time-aligned to audio data. Some embodiments use one data-efficient, time-aligned written translation to document how meaning and contextual meaning correspond with sound in spoken audio data. Some embodiments use different sets of language metadata, time-aligned to audio data, to create matched pairs of language segments in gradated lengths and different languages. Some embodiments process time-aligned language metadata according to user input received through a graphical user interface (GUI) of one or more computers. Various related techniques of formatting and presenting time-aligned metadata through a GUI of one or more computers are disclosed herein.

### BACKGROUND

The present disclosure relates to the computerized documentation, preservation, translation, and teaching/training/learning of languages and dialects.

Written languages are often standardized for general use. There are many spoken languages and dialects that do not adhere to the standards of any written language. Current methods that are used to transcribe spoken languages and dialects are: 1) transcribing them phonetically, for example by using the International Phonetic Alphabet (IPA), and 2) transcribing them approximately in a way that adheres to the standards of a written language. Phonetic transcription preserves information about the original sounds of the spoken/audible language but does not preserve explicit information about the meanings of the sounds. Transcription into a closely related, standardized written language preserves some meaning from the source language but does not preserve all the sounds of the source language.

The software ELAN, commonly used by linguists for language documentation and presently described as “an annotation tool for audio and video recordings” (https://archive.mpi.nl/tla/elan, accessed Jan. 27, 2024), enables users to transcribe spoken/audible language phonetically and/or into a written language, and it also enables users to annotate the spoken/audible language with translations of it into other written languages. Another software, SayMore (https://software.sil.org/saymore/, accessed Jan. 28, 2024), further enables users “to easily record Careful Speech annotations and Oral Translations”—in other words, to record additional spoken/audible versions or translations of the source language. By using combinations of these options for creating transcriptions, translations, and other audible versions of spoken/audible language, linguists preserve many of the sounds and meanings of a language. The data and metadata recorded using these methods are all indexed by existing software such as ELAN and SayMore using the corresponding ranges of audio timestamps in the original spoken/audible data (see FIG. 16).

### SUMMARY OF THE INVENTION

Spoken/audible language data and associated metadata of transcriptions, translations, and other audible versions have been preserved in archives and used for language analysis and description; for example, linguists have used them to create dictionaries, grammars, and concordances. To use them for teaching and learning source languages (the languages undergoing documentation), or for training language models to translate or otherwise use a source language, requires access to often prohibitively large scales of data, metadata, and/or processing ability, such as the processing ability required to map out relationships between different tokens, words, and/or phrases within a source language or between a source and a target language. The present disclosure includes a new method of storing language data and metadata that preserves explicit information about relationships within and between different parts of the language data and metadata. In some embodiments, the new method reduces the amounts of data, metadata, and processing ability required for teaching and learning source languages and for training language models to translate or otherwise use a source language.

Customary language documentation methods have used an ordered, one-to-one mapping for associating language data with metadata: once words, phrases, sentences, or even paragraphs are transcribed, translated, and/or rerecorded in audible form, they are stored as metadata in the same sequence that they were originally ordered in in the source language (see FIG. 16). Each of the different types of metadata's sequences cannot be reordered because software such as ELAN and SayMore maintain one-to-one associations between sequential chunks of source data and sequential chunks of each type of metadata by aligning them with one another using timestamps from the source data. The rigid one-to-one, sequential association between language data and each type of metadata creates a trade-off within the metadata between the granularity of the metadata and the metadata's faithfulness to the authentic expression and grammatical syntax of the source data. For example, the Chinese phrase “ [symbol] ?” may be translated as the entire phrase, “Where are you going?” or it may be translated word-by-word as “You-to-where-go?” Prior art software would store these two different translations as two different types of sequential metadata. Prior art software would not store the single English phrasal translation “Where are you going?” of the Chinese phrase “ [symbol] ?” in a way that maintained explicit information about how each of the words in the English phrase mapped to its original representation in the words of the Chinese phrase.

What is needed is a system and process for recording and rendering audible/spoken, transcribed, translated, and reuttered language information in such a way that mappings between two languages or versions of language are, or can be, simultaneously explicit for multiple lengths of language segment (e.g. word, phrase, paragraph).

Embodiments of the present disclosure relate to systems and processes for representing information from a source language in a target language while retaining information related to the etymologies, ontologies, epistemologies, intonations, connotations, and/or grammatical syntaxes employed by the source language. Embodiments of the present disclosure are particularly, but not exclusively, useful for documenting, preserving, translating, and teaching/training/learning about spoken/audible languages that have no popular written script.

Disclosed embodiments enable people, machines, systems, and software to use the new disclosed methods and create further innovations for language teaching, learning, training, and translating. Embodiment of this disclosure further enables users to build and showcase portfolios of audio data with searchable time-aligned metadata, thereby increasing the visibility of freelance data collectors, transcribers, and translators to clients and employers who otherwise have trouble locating field workers, transcribers, and translators to work with the languages and dialects that they need. Finally, disclosed embodiments enable users to rapidly assess and validate other users' description, transcription, and translation styles, providing increased data transparency in fields that use audio recordings and their content. These and other aspects of the disclosure and its embodiments are more fully disclosed herein.

### BRIEF DESCRIPTION OF THE DRAWINGS

FIG. 1 illustrates the two-way flow of information within the preferred embodiment of the present disclosure, from users through a browser-based interface and the Internet to databases hosted by servers and back again.

FIG. 2 illustrates a one-way flow of audio data and metadata from a user through a browser-based interface to databases.

FIG. 3 shows one view of the browser-based interface of the preferred embodiment of the present disclosure, in which a search box, a login button, and two cards each representing a set of audio data are displayed as they would be to a logged-out user.

FIG. 4 shows one view of the browser-based interface of the preferred embodiment in which an audio player, a logout button, and options to create, upload, or view time-aligned metadata are displayed as they would be to a logged-in user interacting with a set of audio data.

FIG. 5 is a view of a form that can accept user input, displayed by the browser-based interface of the preferred embodiment, that can cause the preferred embodiment to create a new empty set of time-aligned metadata.

FIG. 6A is a view of a form called “Upload Interpretation File”, displayed by a computer in a browser-based interface of the preferred embodiment, which can accept user input that causes the preferred embodiment to take time-aligned metadata from a file on the computer, process it, and deposit it into databases. FIG. 6B is a view of the “Upload Interpretation File” form with an opened dropdown menu showing options of different filetypes for the user to select from to describe the selected file containing time-aligned metadata. FIG. 6C is a view of the “Upload Interpretation File” form with an altered structure that corresponds to the selection of filetype Pangloss/LACITO (.xml) in the dropdown menu. FIG. 6D is a view of the “Upload Interpretation File” form that has identified four sets of time-aligned metadata in the selected file and is requesting user input specifying whether metadata in each set should be tokenized using a delimiter or as individual characters.

FIG. 7 depicts the fields of four tables in the database used by the preferred embodiment for storing time-aligned metadata.

FIG. 8 shows one view of the browser-based interface of the preferred embodiment in which one console, corresponding to one set of time-aligned metadata, has been opened in Viewing mode and is displaying the time-aligned metadata.

FIG. 9 shows one view of the browser-based interface of the preferred embodiment in which two consoles, corresponding to two different sets of time-aligned metadata, have been opened in Viewing mode and are displaying the respective time-aligned metadata.

FIG. 10 shows one view of the browser-based interface of the preferred embodiment in which three consoles, each corresponding to a different set of time-aligned metadata, have been opened in Viewing mode and are displaying the respective time-aligned metadata.

FIG. 11 shows one view of the browser-based interface of the preferred embodiment in which one console, corresponding to one set of time-aligned metadata, and the user has opened a dropdown menu from which they can select an alternative set of metadata to view.

FIG. 12 shows one view of the browser-based interface of the preferred embodiment in which two consoles, corresponding to two different sets of time-aligned metadata, have been opened—the left-most console in Editing mode and the right-most console in Viewing mode.

FIG. 13 shows one view of the browser-based interface of the preferred embodiment in which two consoles, corresponding to two different sets of time-aligned metadata, have been opened—the left-most console in Refining mode and the right-most console in Viewing mode.

FIGS. 14a-14c are close-up views of the audio player. In FIG. 14a, the audio player is paused and is displaying the complete waveform of corresponding audio data. In FIG. 14b, the audio player is paused, is displaying the complete waveform of corresponding audio data, and has a region of the waveform selected. In FIG. 14c, the audio player is playing, zoomed in on the waveform, and has a region of the waveform selected.

FIG. 15a is a view of the audio player in which, by typing a new timestamp into the timestamp box corresponding to the beginning of the selected region of the waveform, a user is preparing to cause the preferred embodiment to adjust the beginning of the selected region. FIG. 15b is a view of the audio player in which, by typing a new timestamp into the timestamp box corresponding to the audio timestamp being currently played in the audio player, a user is preparing to cause the audio player to seek to another part of the waveform. FIG. 15c is a view of the audio player in which, by typing a new timestamp into the timestamp box corresponding to the ending of the selected region of the waveform, a user is preparing to cause the preferred embodiment to adjust the ending of the selected region.

FIG. 16 is a schema of how time-aligned metadata is associated with other time-aligned metadata and audio data in prior art.

FIG. 17 is a schema of how time-aligned metadata is associated with other time-aligned metadata and audio data in the preferred embodiment of the present disclosure.

FIG. 18 is a demonstration of the first few steps used by the preferred embodiment of the present disclosure to identify language segments corresponding to one another and of a particular approximate length between a spoken Chinese phrase, a written Chinese transcription of the phrase, and a written English translation of the phrase.

FIG. 19 is a demonstration of the final few steps used by the preferred embodiment of the present disclosure to identify language segments corresponding to one another and of a particular approximate length between a spoken Chinese phrase, a written Chinese transcription of the phrase, and a written English translation of the phrase.

FIGS. 20A-20C are a flowchart illustrating how the preferred embodiment of the present disclosure processes time-aligned metadata to create a list of language segments with associated timestamp ranges and reading index ranges. FIG. 20A is a view of steps of processing involving two lists of Language Token Objects, two lists and of lists, an Interpretation ID, and a Constant Value. FIG. 20B is a view of subsequent steps of processing involving two lists of Language Token Objects, one list of lists, and one list of Language Segment Objects. FIG. 20C is a view of final steps of processing involving two lists of Language Segment Objects that concludes with sending one list of Language Segment Objects to the Browser-Based Interface.

FIG. 21 shows one view of the browser-based interface of the preferred embodiment in which two consoles, corresponding to two different sets of time-aligned metadata, have been opened—the left-most console in Studying mode and the right-most console in Viewing mode.

FIG. 22 shows one view of the browser-based interface of the preferred embodiment in which two consoles, corresponding to two different sets of time-aligned metadata, have been opened in Viewing mode and are highlighting corresponding nested time-aligned language segments.

FIG. 23 shows one view of the browser-based interface of the preferred embodiment in which two consoles have been opened, and in the left-most console in Studying mode the user has moved the phrase length slider to the right, causing the preferred embodiment to generate relatively longer language segments.

FIGS. 24a-24b compare two views of the browser-based interface to demonstrate that each console displaying metadata can scroll up and down independently of the others. FIG. 24a shows two corresponding language segments between the left console and the right console, with the one in the left console displayed higher in the interface than the one in the right. FIG. 24b shows the same two corresponding language segments between the left console and the right console, with the one in the left console displayed lower in the interface than the one in the right.

FIGS. 25a-25c show views of three forms that can be displayed by the browser-based interface to accept user input. FIG. 25a is a view of Registration Form, which the user can use to cause the preferred embodiment to deposit user information into databases. FIG. 25b is a view of Login Form, which the user can use to login to the preferred embodiment. FIG. 25c is a view of Upload Audio Form, which the user can use to cause the preferred embodiment to take audio data from the computer displaying the browser-based interface and deposit it into a database.

FIG. 26 shows one view of the browser-based interface of the preferred embodiment in which information about the audio data and time-aligned metadata that a logged-in user has access to can be viewed, searched through, and shared with other specific users and the public.

FIGS. 27a-27b show views of two forms that can be used to accept user input through the browser-based interface. FIG. 27a is a view of a form that a user can use to give access to a specific set of audio data to another user. FIG. 27b is a view of a form that a user can use to give access to a specific set of time-aligned metadata to another user.

FIG. 28a is one view of the browser-based interface of the preferred embodiment in which a user has opened a dropdown menu of a console in Viewing mode, giving them the option to download a file containing the time-aligned metadata being displayed in that console. FIG. 28b is a view of a form through which a user can cause the preferred embodiment to adjust the time-alignments of an entire set of time-aligned metadata forward or backward.

FIG. 29 shows one view in which two consoles, corresponding to two different sets of time-aligned metadata, have been opened—the left-most console in Scribing mode and the right-most console in Viewing mode—and the user, informed by the console in Viewing mode, has typed a text string into the Scribing console for the preferred embodiment to use in conjunction with timestamps from the audio player to create more time-aligned metadata.

FIG. 30 shows an example of a computer system, one or more of which may be used to implement one or more of the apparatuses, systems, and methods illustrated herein.

FIG. 31 shows an example of how time-aligned metadata is formatted in a SRT (SubRip Subtitle) file.

### DETAILED DESCRIPTION OF THE INVENTION

The following description is presented to enable any person skilled in the art to make and use the invention and is provided in the context of particular applications and their requirements. Various modifications to the exemplary embodiments will be readily apparent to those skilled in the art, and the generic principles defined herein may be applied to other embodiments and applications without departing from the spirit and scope of the invention. Thus, the present disclosure is not intended to be limited to the embodiments shown, but is to be accorded the widest scope consistent with the principles and features disclosed herein.

A preferred embodiment of the present disclosure is a browser-based interface through which one or more users can deposit audio data and associated metadata into databases and subsequently interact with those audio data and metadata. After depositing audio data and metadata into the databases, a user interacting with the browser-based interface in an open browser window or browser tab may select audio data and then any or all of its associated metadata to interact with. Metadata is available in various “interpretations,” and multiple interpretations can be displayed side-by-side in the browser window.

In an embodiment, the system tokenizes each interpretation using a custom delimiter (chosen by the user that created or uploaded that interpretation) as well as carriage returns; if the user chooses no custom delimiter, then it treats each normalized Unicode character as a language token. Each individual language token is stored in the database with an identifier that links it to the interpretation it is part of, a number indicating its place in the sequence of language tokens composing that interpretation, and information that is or can be used to ascertain the starting and ending values of the timestamp range it is associated with in the audio data. The system assumes that each language token represents information that corresponds with information found in the portion of the audio data described by its associated timestamp range. The information about the timestamp ranges can be sourced from a file uploaded by the user (e.g. an .srt “SubRip” file or an .eaf “ELAN Annotation Format” file) or assigned by a user using features of the browser-based interface.

In an embodiment, while interacting with an interpretation, the user can adjust a “phrase length” (sometimes called “highlight less/more”) setting. When the phrase length setting is set or adjusted, a list of segments of the interpretation (each segment comprising one or more language tokens) is created based on the phrase length value. When phrase length is set to a large value, it usually results in the creation of a shorter list of longer segments; when phrase length is set to a small value, it usually results in the creation of a longer list of shorter segments. In an embodiment, the system creates the list by beginning with a list of the language tokens composing the interpretation, ordered by the median timestamp associated with each language token, then splitting the list over and over again, each placing the split at the largest difference (or the last instance of the largest difference, in the case of multiple locations all qualifying as having the largest difference) between median values of timestamps of language tokens that neighbor each other within a list or sublist. The splitting of each list and sublist stops when the difference between the smallest median timestamp value associated with a language token in the list or sublist and the largest median timestamp value associated with a language token in the same list or sublist is less than or equal to the phrase length value. After splitting of all lists and sublists stops, the system evaluates the remaining lists and sublists, identifying for each i) the minimum contiguous range of timestamps that includes all of the complete timestamp ranges of the language tokens it contains as well as ii) the one or two language tokens it contains that are, respectively, earliest and latest in the original reading sequence of the interpretation. In an embodiment, the system then strings the two language tokens together along with any other language tokens that came between them in the original reading sequence—adhering to that sequence and using delimiters between them if a custom delimiter has been set by the user for that interpretation—to compose a language segment, and, in an embodiment, it associates that language segment both with the contiguous range of timestamps that it identified and with the reading index range of the language tokens used to compose it. In some embodiments, the system may then further identify language segments that, in the original reading sequence, overlapped with one another (but were not perfectly nested one within another) and combine them together, with their timestamp ranges and reading index ranges also combined into a new contiguous timestamp range and contiguous reading index range.

While interacting with audio data using the browser-based interface, the user can adjust the current time that the built-in audio player is played or paused at using various features of the browser-based interface. When the current time is set or adjusted, in some embodiments, the browser-based interface will display and highlight, for all open interpretations, the language segments they contain that have associated timestamp ranges that include the current timestamp; in some other embodiments, the browser-based interface will display and highlight the minimum contiguous sequence of language tokens that includes all of the language segments with associated timestamp ranges that include the current timestamp. In some embodiments, the system will use different colors to highlight multiple language segments that are nested one inside another: it will highlight language segments that correspond to the current timestamp in one color, except that it will highlight areas of overlap between two and only two language segments that correspond to the current timestamp in another color, and it will highlight areas of overlap between more than two language segments that correspond to the current timestamp in other colors (depending on the number of overlapping segments). When the user clicks “Play,” the audio data is played and the current time being played within the audio will be changing continuously; which language segments are being highlighted by the embodiment will change, as necessary, based on the current time. In an embodiment, when the user clicks on a language token, the shortest language segment containing that language token (if any) will be highlighted, and the corresponding region of audio data will be played in the audio player.

For a user, causing the audio data to play and watching the changing highlighting of displayed language segments as it plays constitutes engaging in a language-learning activity based on audio data and some timestamped metadata associated with that audio data, enabled by the present disclosure. The preferred embodiment of the present disclosure provides another language-learning activity based on audio data and some timestamped metadata associated with the audio data for a single interpretation at a time using a “Studying” feature of the browser-based interface: the browser-based interface plays a segment of audio data for the user and displays the shortest written language segment associated with it alongside other language segments of similar length sourced from the same interpretation—if they exist—that are not necessarily associated with the playing segment of audio data. If the user clicks on or accurately retypes the correct language segment, associated with the audio that has just been played—or is still being played—by the system, then the browser-based interface will confirm the correct selection and provide a new audio clip with a new corresponding set of potential answers for the user to choose from. When the user adjusts the phrase length setting within this language-learning activity, the system will correspondingly increase or decrease the length of audio data that it selects to play and language segments that it selects to display.

In an embodiment, while an interpretation is displayed in the browser-based interface, the user may assign or revise the timestamp ranges associated with individual language tokens or groups of language tokens within it using the “Refining” feature. While using the Refining feature, the user specifies the beginning and ending timestamps of a region of the audio data by typing the corresponding timestamps into boxes or by “clicking and dragging” with a pointer to highlight a region of the displayed audio waveform, then clicks on particular language tokens within the interpretation (or drags the pointer over them with its left-click button depressed) that they wish to associate with the specified region of audio data (i.e. range of timestamps), then finally clicks a “Save” button. When the user clicks the Save button, the associated timestamp range of each language token that the user has selected will be updated in the database to the newly specified range. Each language token can have only one timestamp range associated with it at a time; the system deletes a prior range associated with a language token when a new one is assigned. Associating timestamp ranges with language tokens has no effect on the reading order sequence of language tokens composing an interpretation.

The system stores each interpretation in a database as the individual language tokens it comprises. Individual language tokens each have a data property, “reading index,” indicating their position in the reading order sequence of the language tokens composing the interpretation. In an embodiment, a user can change the language tokens of an interpretation, and/or their sequence, using an “Editing” feature of the browser-based interface. While using the Editing feature to interact with an interpretation, the entire text of the interpretation is displayed to the user inside of a textbox. The user is able to edit the text in the textbox and at any point to click “Save.” Once the user clicks “Save,” the system compares the new sequence of language tokens that composes the continuous text (containing the user's edits) with the former sequence using a difference algorithm such as, for example, Patience Diff Plus, and, according to the results, adds newly inserted language tokens into the database; removes newly deleted language tokens from the database; and updates accordingly in the database the “reading index” property of language tokens that have been moved from one position to another in the sequence or displaced by the insertion and/or deletion of other language tokens. After these changes are made, the information in the database can be used to reproduce the new (edited) continuous text, and any information that was associated with language tokens that were retained from the former to the edited version of the metadata has also been retained (excepting the information contained in the “reading index” property, which could have changed). For example, if the original version of the text was “Hello, my name is Bob.” and the new (edited) version of the text was “My name is Bob. Hi!” and the text was tokenized using white space “ ” as the custom delimiter—and if each of the language tokens “Hello,” and “my” and “name” and “is” and “Bob.” was associated in the database with particular ranges of audio timestamps—then, after the user clicked Save and the corresponding updates to the database were completed, “name” and “is” and “Bob.” would still be associated with their respective original timestamp ranges. In an embodiment, “My” and “Hi!” would have no associations with timestamp ranges immediately after the update because those language tokens were not present in the original version of the text (“My” and “my” are considered to be different language tokens, as are “Hello,” and “Hi!”).

In an embodiment, the user can view multiple interpretations at the same time, side-by-side, and can independently scroll through or interact with each interpretation even while multiple interpretations are displayed. While audio data is playing or paused, each open interpretation associated with the audio will have language segments being highlighted—if there are any to be highlighted—accordingly as described earlier in this Summary. The user is able to open multiple interpretations, and each time a new interpretation is opened the amount of horizontal space allotted in the browser-based interface to each open interpretation is reduced so that the open interpretations can all be viewed side-by-side, simultaneously, in the browser-based interface. The user is also able to close open interpretations, which causes each remaining open interpretation to expand width-wise to occupy more horizontal space in the browser-based interface. The user is also able to change which interpretation is being viewed in any one vertical column of the browser-based interface, giving the user control over the order with which they are viewing interpretations from left-to-right within the browser-based interface.

An embodiment of the present disclosure allows users to collaborate in collecting and contributing language metadata to accompany audio data. Different users may contribute their own interpretations (written metadata) to accompany the same audio data, and the different interpretations may then be viewed side-by-side by both contributing and non-contributing users. Each user's contributed work constitutes a portfolio, accessible to themselves and other users via the browser-based interface, of audio data and interpretation data that they have deposited in the databases through the embodiment of the system. Each user can make their portfolio partially or wholly accessible to particular other users and/or to the public. A user's online, searchable portfolio demonstrates the quality of time-aligned metadata and/or audio data that the user can produce; a user's portfolio is thus useful for advertising their skills, demonstrating their qualifications, and attracting clients (or impressing future employers) who may be in search of a contractor (or employee) to produce audio data and/or time-aligned metadata for their audio data. Users' usernames and the metadata they contribute through the browser-based interface (including but not limited to audio titles, descriptions, interpretations, and language names) can be searched by other users who input text strings into a built-in search feature of the browser-based interface, making it easy for potential clients and employers to search for users' portfolios that contain the types of content, languages, or dialects that are relevant to their work. Finally, since translators fluent in low-resource languages can be difficult to find, increasing visibility of translators fluent in low-resource languages and helping connect them with jobs is a way of providing support for, and increasing the market value of, knowledge of those low-resource languages.

The preferred embodiment of the present disclosure uses audio data as a basis for associating timestamp ranges with language tokens in written interpretations of that audio data. Other embodiments of the present disclosure might use written data or other types of data as a basis for associating value ranges with language tokens in written interpretations of that data. Still other embodiments of the present disclosure might use audible language tokens and use median timestamp values in place of the “reading index” described above (which was used for storing information about how language tokens would be arranged in sequence). The present disclosure is not limited in application to particular formats of language data and metadata.

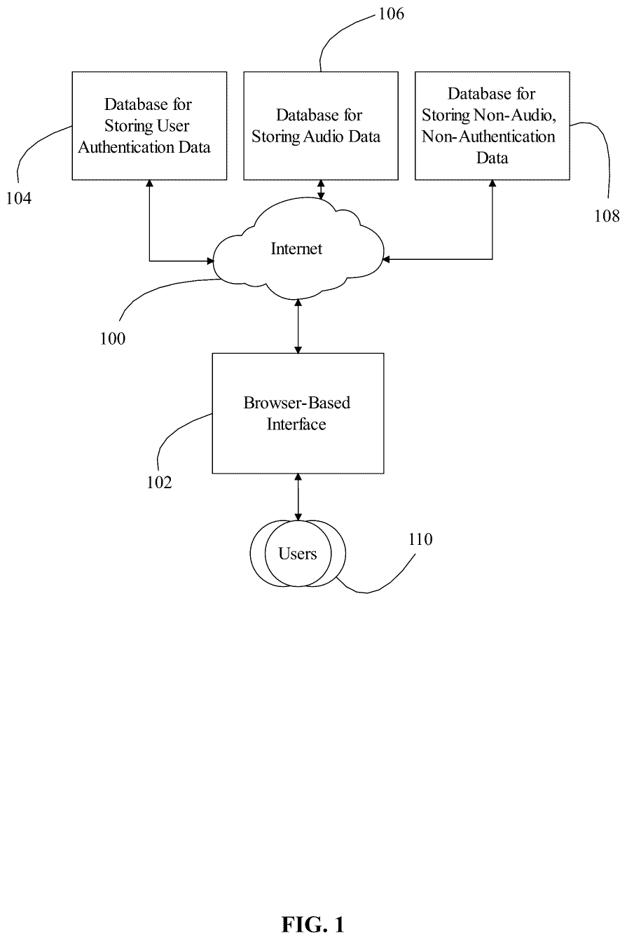

FIG. 1 illustrates the two-way flow of information within the preferred embodiment of the present disclosure, from users 110 through a browser-based interface 102—which was designed using HTML, JavaScript, and CSS—then through the Internet 100 to databases 104 (for storing user authentication data), 106 (for storing audio data), and 108 (for storing all other data) hosted by servers and then back again.

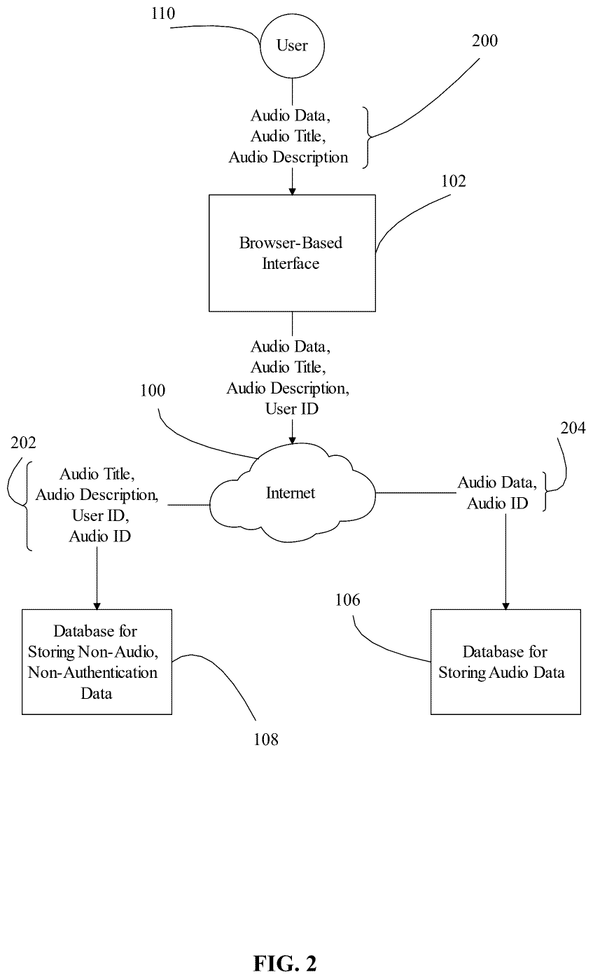

FIG. 2 illustrates a one-way flow of audio data and metadata 200 from a user 110 through a browser-based interface 102, which sends the metadata and uploading user ID and an audio ID 202 through the Internet 100 to a database 108 and sends the audio data and the same audio ID 204 through the Internet 100 to a database 106. This is how the information is processed when a user 110 deposits audio data and metadata 200 using the preferred embodiment of the present disclosure.

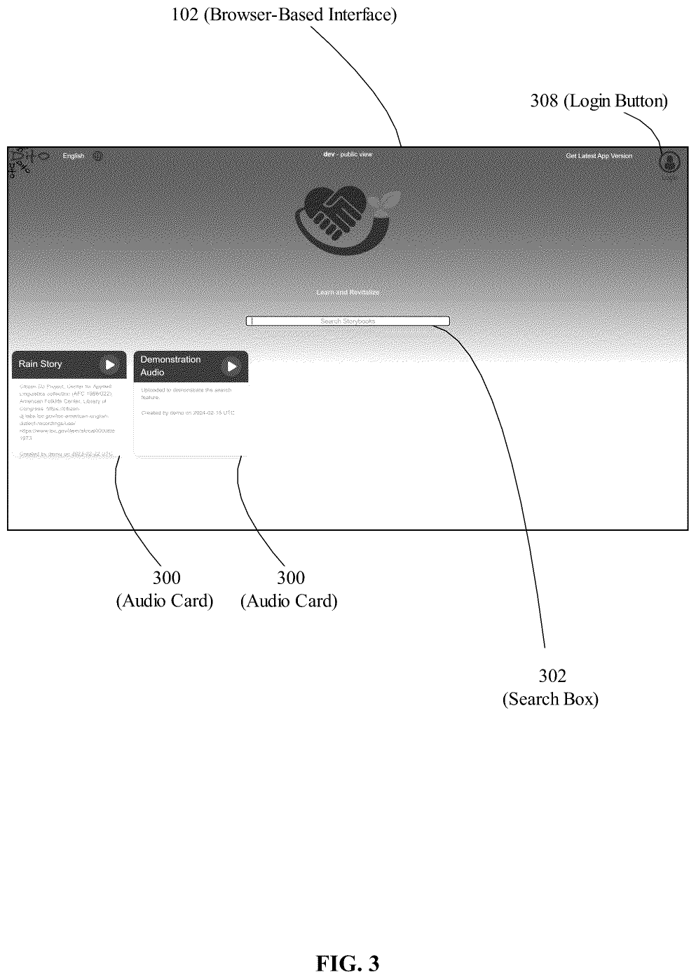

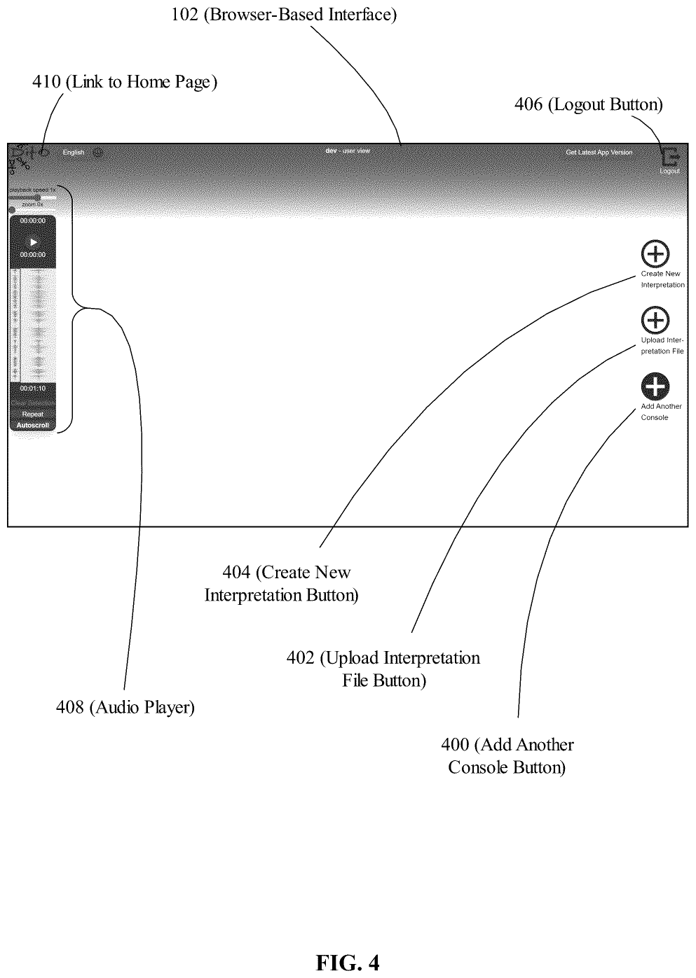

FIG. 3 illustrates one view of the browser-based interface 102 as seen by a logged-out user 110. In this view, audio cards 300 representing correlated sets of audio data 204 and audio metadata 202 can be seen by the user 110. Audio metadata 202 is displayed on each of the audio cards 300. The user is not logged in and can only see audio cards 300 representing data that the public is permitted to see. The user can log in using the Login Button 308 or search through the data they have access to by typing a text string into the Search Box 302 and pressing “Enter” on their keyboard. The user can click on an audio card 300 to begin interacting with the audio data 204 it represents through a view of the browser-based interface represented by FIG. 4 (though FIG. 4 represents it from the perspective of a logged-in user).

FIG. 4 illustrates one view of the browser-based interface 102 as seen by a user 110. The user 110 is logged in and can choose to log out using the Logout Button 406. The user can also return to the home page represented by FIG. 3 (though FIG. 3 represents it from the perspective of a logged-out user) by clicking the graphic representing Link to Home Page 410. The user can interact with the audio data 204 loaded into Audio Player 408 to control playback speed of the audio, zoom in or out on the audio waveform, play or pause the audio, seek through the audio, view different parts of the audio waveform, select regions of the audio, adjust the starting and ending points of audio regions, and repeatedly play the entire audio or an audio region. The user can contribute time-aligned metadata for the audio data by clicking Create New Interpretation Button 404 or Upload Interpretation File Button 402. The user can interact with existing time-aligned metadata from database 108 such as transcriptions or translations by clicking Add Another Console Button 400.

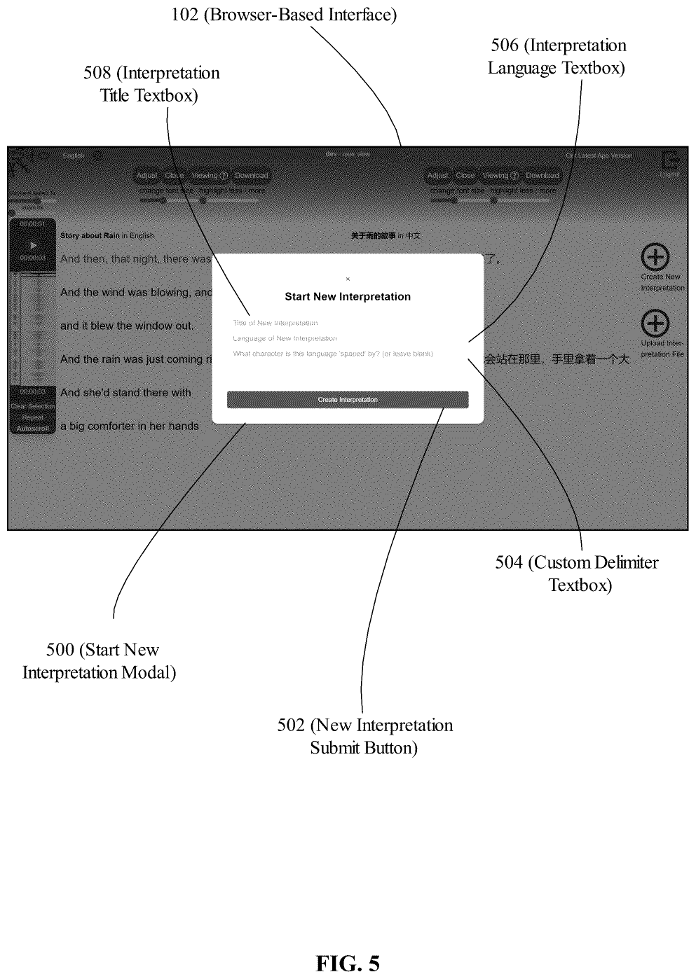

FIG. 5 illustrates Start New Interpretation Modal 500 (a “modal” is sometimes known as a “modal window”), which appears when a user 110 clicks Create New Interpretation Button 404. From the view of the Browser-Based Interface 102 illustrated by FIG. 5, a user 110 can deposit into database 108 values of a title, language, and custom delimiter for time-aligned metadata that they will later create. To do so, the user will type the title into Interpretation Title Textbox 508, the language name into Interpretation Language Textbox 506, and the custom delimiter (if any) into Custom Delimiter Textbox 504, then click New Interpretation Submit Button 502. The information will be deposited into database 108 as text strings along with a new randomly generated Interpretation ID 714 for the set of metadata, a Creating User ID 724 referencing the logged-in user, and the Audio ID 704 of the audio data 204 that is loaded into Audio Player 408. In the preferred embodiment of the present disclosure, interpretations are sets of metadata.

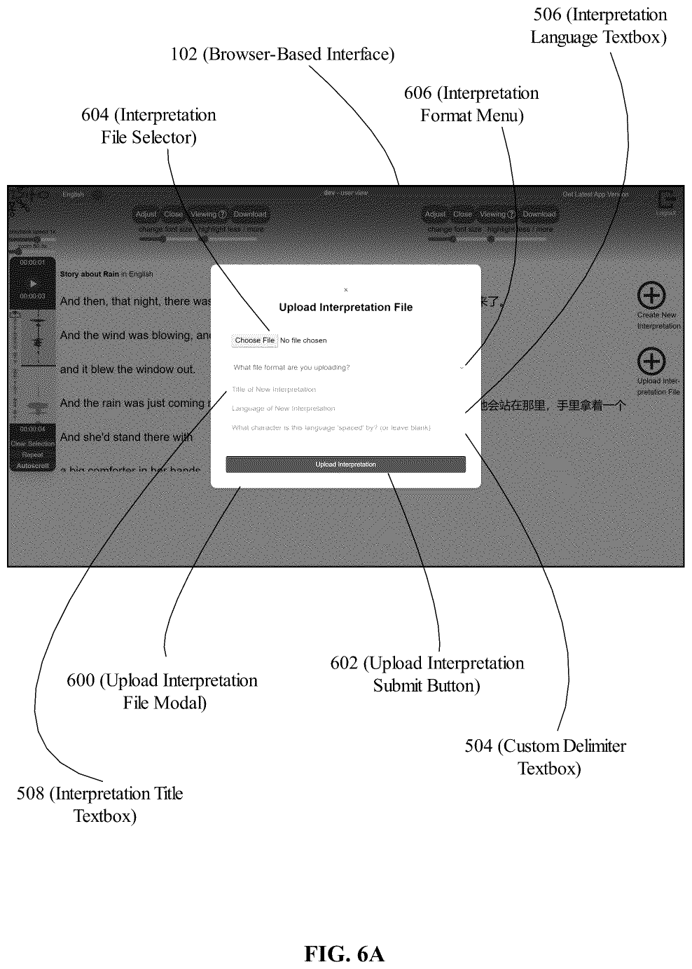

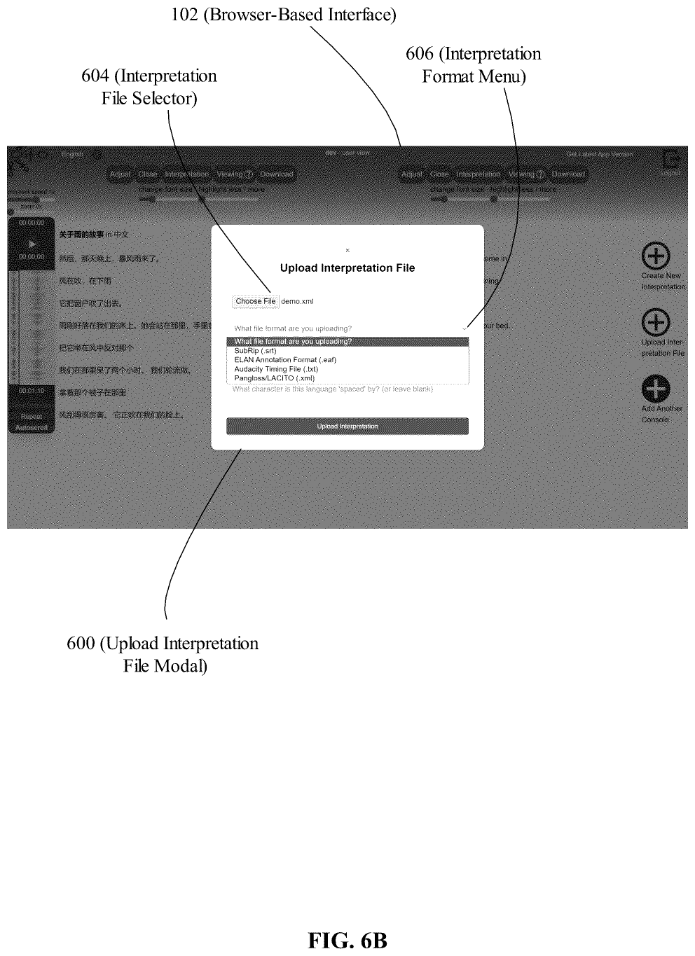

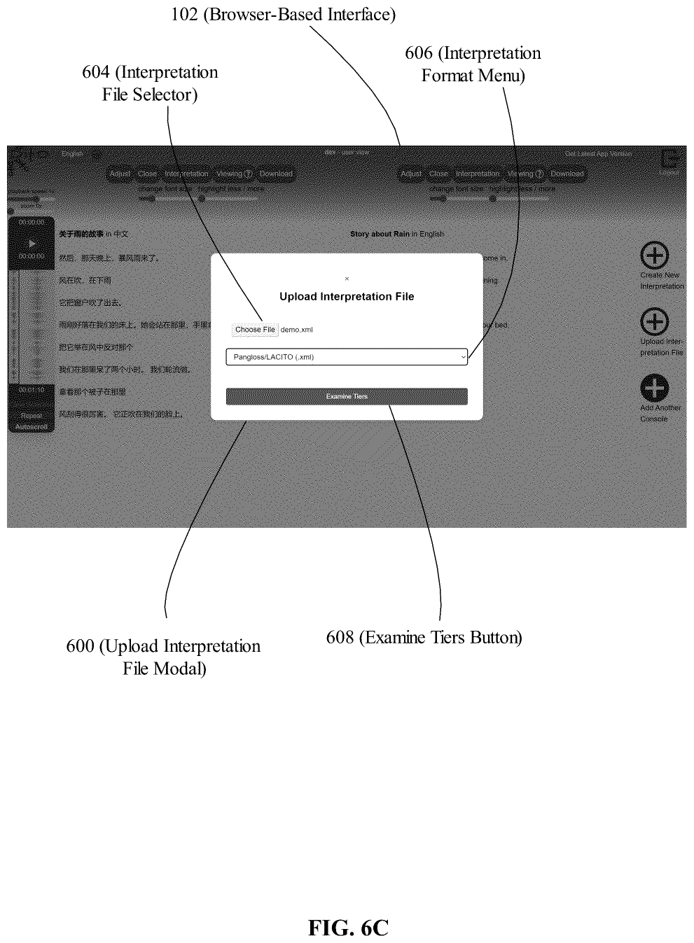

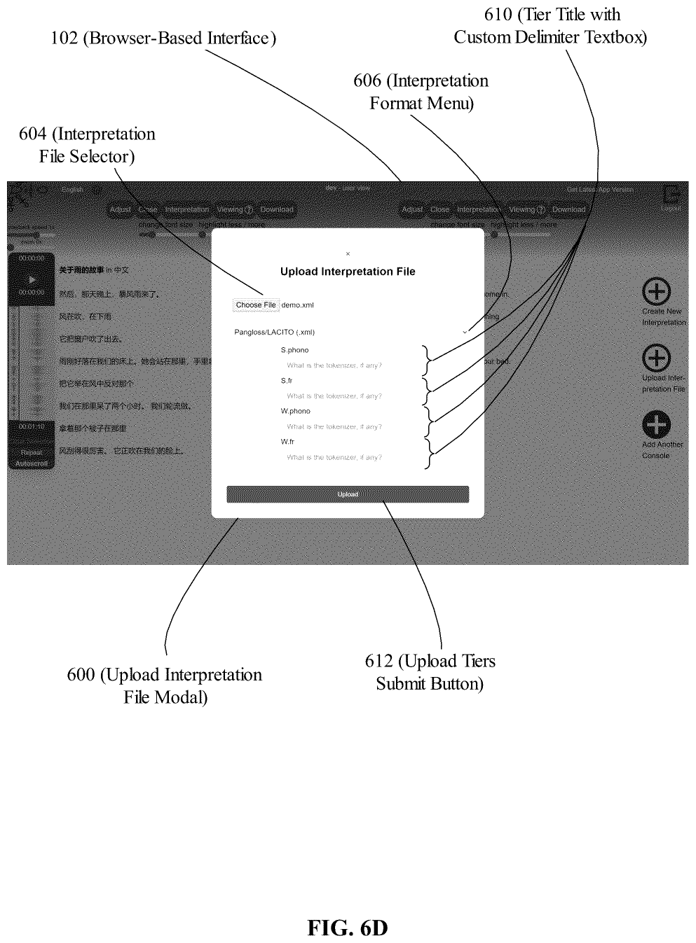

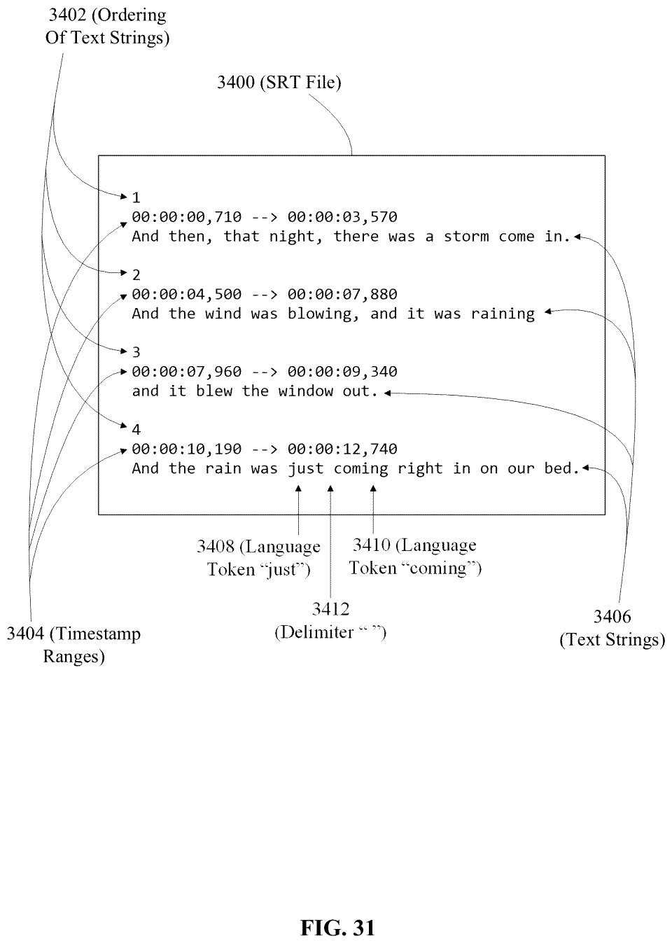

FIG. 6A illustrates Upload Interpretation File Modal 600, which appears when a user 110 clicks Upload Interpretation File Button 402. From the view of the Browser-Based Interface 102 illustrated by FIG. 6, a user 110 can deposit into database 108 values of a title, language, and custom delimiter for time-aligned metadata that already exists in a file on their computer. To do so, the user will choose the time-aligned metadata file using Interpretation File Selector 604; select the file format from Interpretation Format Menu 606 (displayed in full in FIG. 6B); type the metadata's title into Interpretation Title Textbox 508, the metadata's language name into Interpretation Language Textbox 506, and a custom delimiter for tokenizing the metadata into Custom Delimiter Textbox 504; then click Upload Interpretation Submit Button 602. However, if the file type selected in Interpretation Format Menu 606 might contain multiple tiers of metadata, as an .eaf or .xml file might, then Upload Interpretation File Modal 600 will change formats to that illustrated in FIG. 6C, substituting Examine Tiers Button 608 for Upload Interpretation Submit Button 602. When the user 110 clicks Examine Tiers Button 608, Upload Interpretation File Modal 600 then changes formats to that illustrated in FIG. 6D, displaying a Tier Title with Custom Delimiter Textbox 610 for each tier that the preferred embodiment of the present disclosure identified in the file selected using Interpretation File Selector 604. The user 110 may then input a custom delimiter into any or all of the Custom Delimiter Boxes and click Upload Tiers Submit Button 612. When the user 110 clicks Upload Interpretation Submit Button 602 (visible in FIG. 6B) or Upload Tiers Submit Button 612 (visible in FIG. 6D), the preferred embodiment formats metadata for input into database 108 from the file that was selected using Interpretation File Selector 604 (see FIG. 31 for an example using a .srt file).

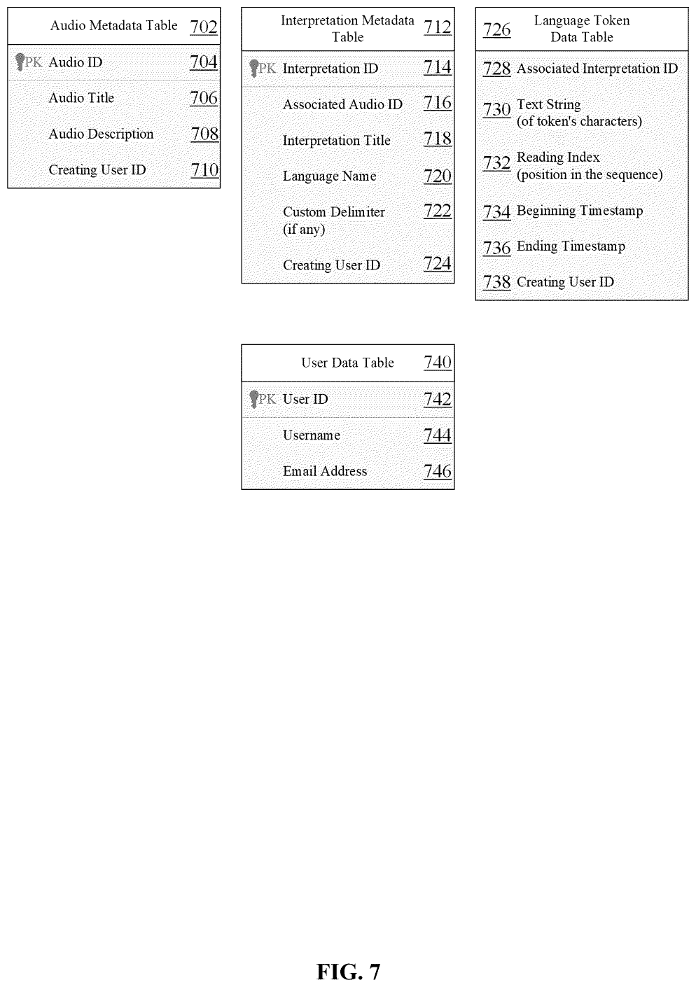

FIG. 7 illustrates how audio metadata 202, time-aligned metadata from a file selected using Interpretation File Selector 604, and data about the user(s) 110 depositing those audio and time-aligned metadata into database 108 is organized within database 108 in the preferred embodiment of the present disclosure. The data are organized into Audio Metadata Table 702, Interpretation Metadata Table 712, Language Token Data Table 726, and User Data Table 740. In this description of the preferred embodiment of the present disclosure, a language token is a Text String (of token's characters) 730 value in Language Token Data Table 726. In this description of the preferred embodiment of the present disclosure, a language segment refers to a set of language tokens arranged in the contiguous increasing order of their associated Reading Index (position in the sequence) 732 values, optionally with an associated Custom Delimiter (if any) 722 value between the language tokens. Data entries in Audio Metadata Table 702 each contain an Audio ID 704, Audio Title 706, Audio Description 708, and a Creating User ID 710. Data entries in Interpretation Metadata Table 712 each contain an Interpretation ID 714, an Associated Audio ID 716 to identify the related audio metadata 202 in Audio Metadata Table 702, an Interpretation Title 718, a Language Name 720, a Custom Delimiter (if any) 722 that can be placed between language tokens stored in Language Token Data Table 726 to make a language segment, and a Creating User ID 724. Data entries in Language Token Data Table 726 each contain an Associated Interpretation ID 728 to identify the related interpretation metadata in Interpretation Metadata Table 712, a Text String (of token's characters) 730 representing the language token, a Reading Index (position in the sequence) 732 representing the language token's position in the sequence of language tokens composing the readable interpretation, a Beginning Timestamp 734 representing a moment in the associated audio data 204 that occurs before the segment with the meaning or sound that most closely corresponds to the language token, an Ending Timestamp 736 representing a moment in the associated audio data 204 that occurs after the segment with the meaning or sound that most closely corresponds to the language token, and a Creating User ID 738. Data entries in the User Data Table 740 each include a User ID 742, a Username 744, and an Email Address 746. The preferred embodiment of the present disclosure can match the Creating User IDs 710, 724, and 738 in data entries in tables 702, 712, and 726, respectively, with User ID 742 in table 740 to reference and obtain data about the user(s) 110 whose accounts deposited the various data entries into database 108. This information is useful to the preferred embodiment for, among other things, providing proper means of contact for, and attribution to, any user 110 who contributes data. It will be appreciated by those skilled in the art that other information stored in database 108 is outside the scope of FIG. 7, since FIG. 7 is an illustration focused on how Audio metadata, Interpretation metadata, and Language Token data are distinct from one another yet associated with one another—and with data about the user(s) 110 that created them—in database 108.

FIG. 31 shows how the preferred embodiment of the present disclosure interprets the different components of an SRT File 3400, which is a common file format used to store and transmit textual data that corresponds to audio data in a separate file. When processing the SRT File 3400 information, the preferred embodiment of the present disclosure first compiles a sequence of Text Strings 3406 that follows the consecutive sequence of the Ordering Of Text Strings 3402 and attributes to each text string the timestamp range corresponding to it (directly above it, in FIG. 31) from the many Timestamp Ranges 3404. The preferred embodiment compares each range of timestamps with the duration of the audio data 204 that is loaded into Audio Player 408, discarding any text strings that have corresponding ranges of timestamps that fall in whole or in part outside of the timestamp bounds of the audio data. If one or more text strings are not discarded, then the preferred embodiment will create a data entry in Interpretation Metadata Table 712 with a unique Interpretation ID 714, the Associated Audio ID 716 of the audio data 204 that is loaded into Audio Player 408, the Interpretation Title 718 input by user 110 into Interpretation Title Textbox 508, the Language Name 720 input by user 110 into Interpretation Language Textbox 506, the Custom Delimiter (if any) 722 that the user 110 input into Custom Delimiter Textbox 504, and the Creating User ID 724 of the currently logged-in user 110. Next, the preferred embodiment of the present disclosure will use the Custom Delimiter (if any) 722, as well as any carriage returns present within the Text Strings 3406, to split the Text Strings 3406 and combine all of the results into a list of language tokens that follows the orders of words in the text strings as well as the order of the text strings given by Ordering Of Text Strings 3402. Given SRT File 3400 in FIG. 31, for example, and a Custom Delimiter (if any) 722 of “ ” that was chosen by the user 110, the preferred embodiment of the present disclosure would differentiate Language Token “just” 3408 from Language Token “coming” 3410 based on Delimiter “ ” 3412 and place Language Token “just” 4308 just preceding Language Token “coming” 3410 in the resulting list of language tokens combined from all remaining text strings. For each language token that the preferred embodiment identified from SRT File 3400, it would create one new data entry in Language Token Data Table 726. Each new data entry would include the Associated Interpretation ID 728 of the newly-created relevant data entry in the Interpretation Metadata Table 712, the Text String (of token's characters) 730 representing the language token, the Reading Index (position in the sequence) 732 representing the language token's place in the reading order of the complete list of all the language tokens that the preferred embodiment sourced from SRT File 3400, the Beginning Timestamp 734 and Ending Timestamp 736 given by the timestamp range from Timestamp Ranges 3404 that originally corresponded with the text string from Text Strings 3406 that contained the language token, and the Creating User ID 738—identical to the user ID of the currently logged-in user 110. Two identical words located in a single text string that the preferred embodiment sourced in one instance from SRT File 3400 would therefore be represented in the Language Token Data Table 726 by two different data entries that were identical except for their different values of Reading Index (position in the sequence) 732. If no Custom Delimiter (if any) 722 was specified by the user 110, then the preferred embodiment of the present disclosure would treat each single character (excluding carriage returns) in the text strings sourced from SRT File 3400 as a language token. When processing files—such as .eaf or .xml files—that contain multiple tiers, the preferred embodiment of the present disclosure would process each tier individually: each tier for which data is deposited into database 108 will receive its own data entry in Interpretation Metadata Table 712.

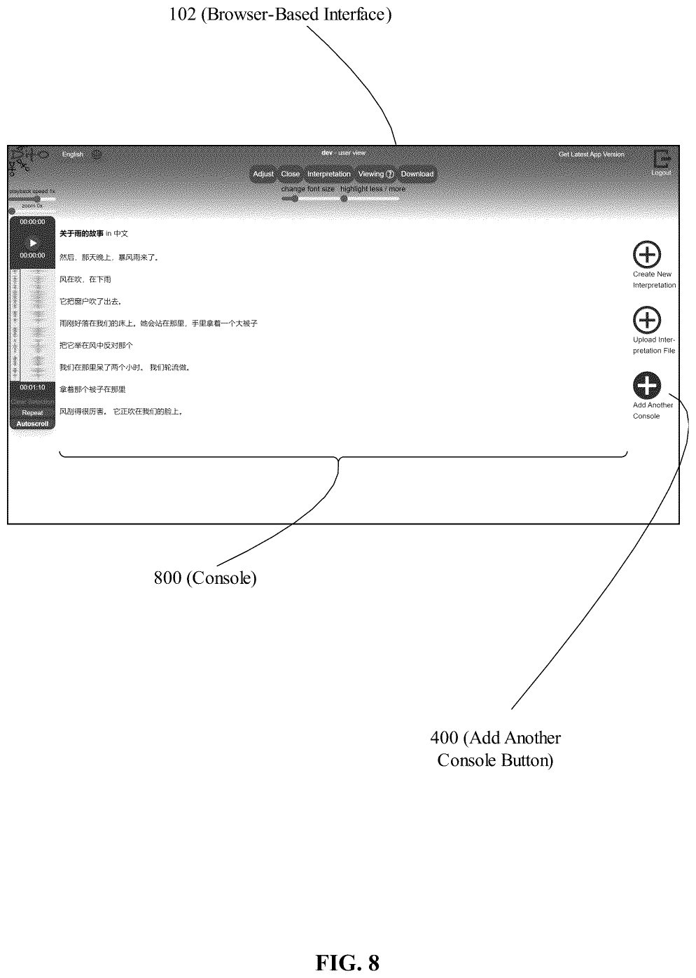

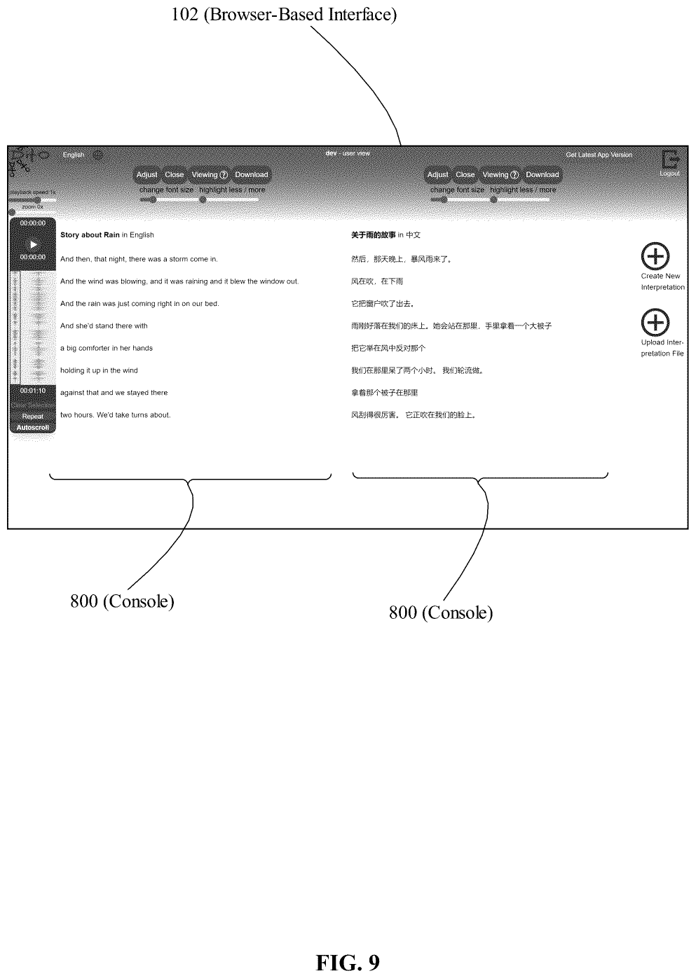

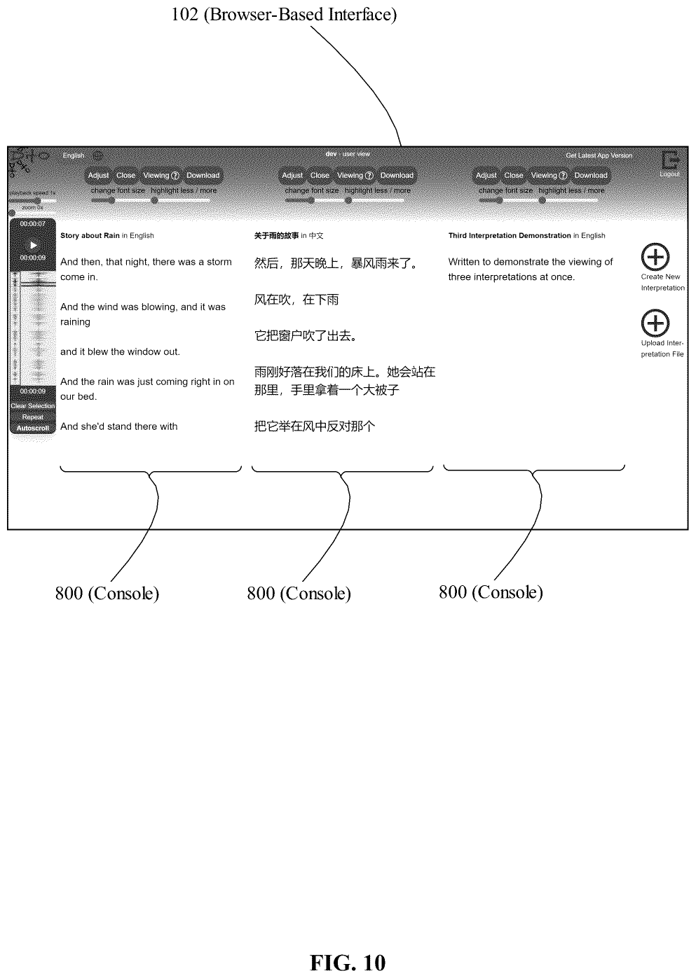

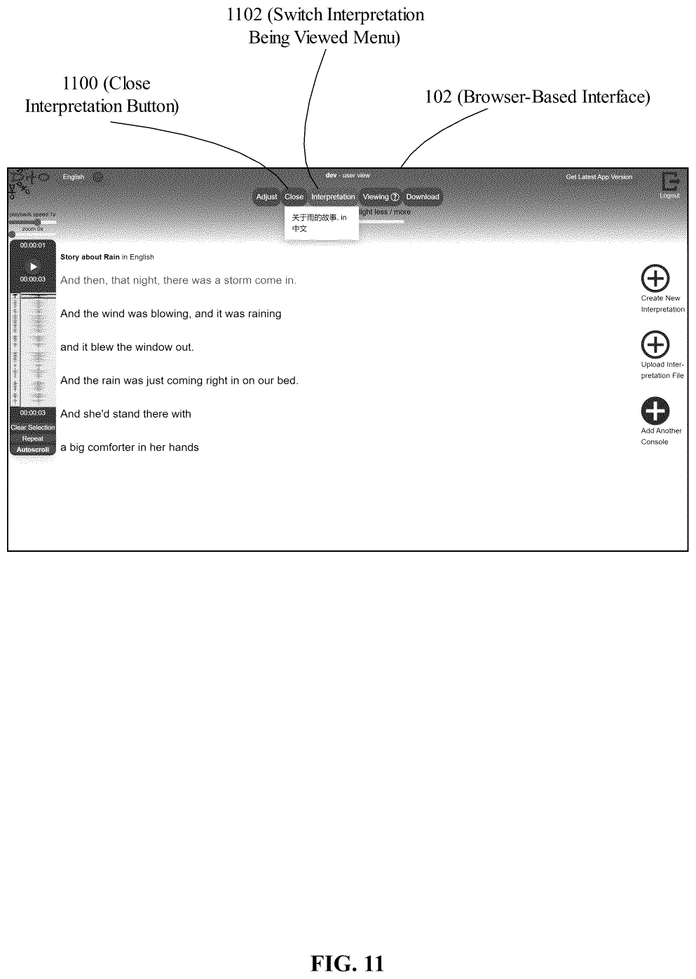

FIG. 8 illustrates one view of the browser-based interface 102 as seen by a user 110 who is viewing a single console 800 of time-aligned metadata for audio data 204. Each time the Add Another Console Button 400 is clicked, if the user has access to more time-aligned metadata that is not already being displayed, the preferred embodiment of the present disclosure will display another console 800 of time-aligned metadata in the browser-based interface 102. The side-by-side alignment of these consoles is illustrated in FIG. 9 and FIG. 10. The preferred embodiment of the present disclosure calculates how much space to allot to each console in the browser-based interface 102 based on the size of the browser window, the size of other elements displayed in the browser-based interface 102, and the number of open consoles. The user 110 may close individual consoles using Close Interpretation Button 1100 and/or may switch which metadata is being viewed in any open console 800 using the Switch Interpretation Being Viewed Menu 1102; both features are illustrated in FIG. 11.

FIG. 9 illustrates one view of the browser-based interface 102 as seen by a user 110 who is viewing two consoles 800 of time-aligned metadata for audio data 204. The preferred embodiment of the present disclosure calculates how much space to allot to each console in the browser-based interface 102 based on the size of the browser window, the size of other elements displayed in the browser-based interface 102, and the number of open consoles. The user 110 may close individual consoles using Close Interpretation Button 1100 and/or may switch which metadata is being viewed in any open console 800 using the Switch Interpretation Being Viewed Menu 1102; both features are illustrated in FIG. 11.

FIG. 10 illustrates one view of the browser-based interface 102 as seen by a user 110 who is viewing three consoles 800 of time-aligned metadata for audio data 204. The preferred embodiment of the present disclosure calculates how much space to allot to each console in the browser-based interface 102 based on the size of the browser window, the size of other elements displayed in the browser-based interface 102, and the number of open consoles. The user 110 may close individual consoles using Close Interpretation Button 1100 and/or may switch which metadata is being viewed in any open console 800 using the Switch Interpretation Being Viewed Menu 1102; both features are illustrated in FIG. 11.

FIG. 11 illustrates one view of the browser-based interface 102 as seen by a user 110 who is viewing a single console 800 of time-aligned metadata for audio data 204. The user 110 may close the console using Close Interpretation Button 1100 and/or may switch which metadata is being viewed in the open console 800 by using the Switch Interpretation Being Viewed Menu 1102. The user 110 may also click the Add Another Console Button 400 to—if the user has access to more time-aligned metadata that is not already being displayed—cause the preferred embodiment to display another console 800 of time-aligned metadata in the browser-based interface 102, as seen in FIG. 9.

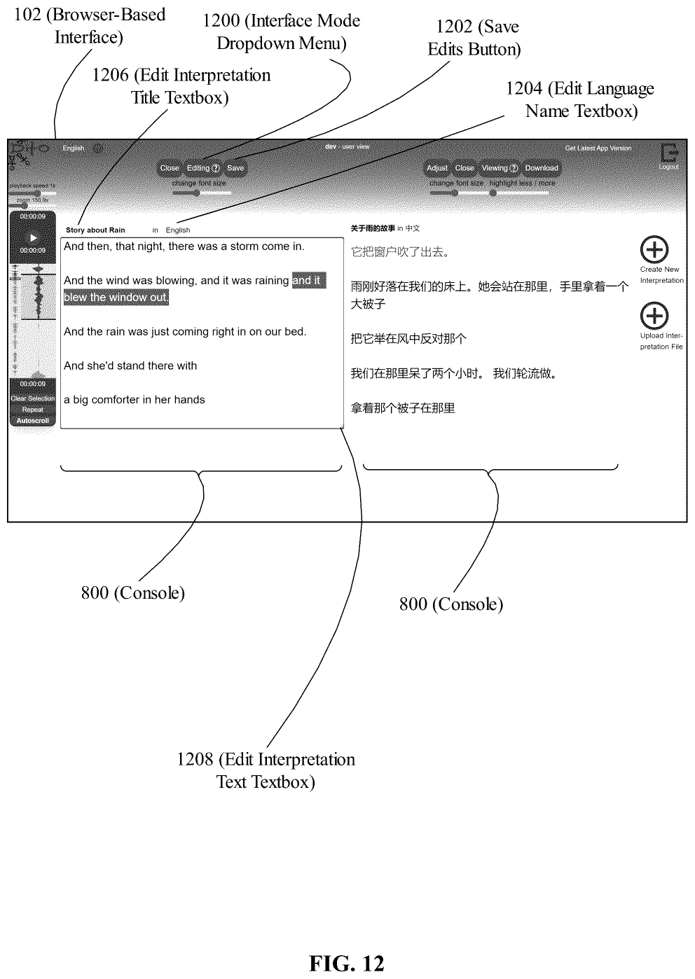

FIG. 12 illustrates a view of the browser-based interface 102 as seen by a user 110 who has used Interface Mode Dropdown Menu 1200 to switch from Viewing mode to Editing mode of interacting with an interpretation (one set of time-aligned metadata for audio data) in a console 800. In Editing mode, the user 110 can edit the title of an interpretation in Edit Interpretation Title Textbox 1206, edit the language name of an interpretation in Edit Language Name Textbox 1204, and edit the language tokens and their sequence in Edit Interpretation Text Textbox 1208. The editing process is that of a standard HTML textbox, and all edits are saved to database 108 every time the Save Edits Button 1202 is clicked by the user 110. The edits made to interpretation title and interpretation language name are saved by replacing the former text strings with the new text strings in Interpretation Title 718 and Language Name 720 fields of Interpretation Metadata Table 712 in database 108, based on matching the Interpretation ID 714 of the database entry with Interpretation ID 714 of the metadata currently being edited in the relevant console 800. To save the interpretation text edits made in Edit Interpretation Text Textbox 1208 to the database 108, the preferred embodiment first compares the language tokens (and their sequence) of the old text with the language tokens (and their sequence) of the new text via a difference algorithm such as, for example, Patience Diff Plus. From this comparison, the preferred embodiment creates a list of: language tokens, their positions in the old sequence (if they were there at all), and their positions in the new sequence (if they are there at all). The preferred embodiment then discards from the list any entries for which the value of the old position is the same as the value of the new position. Data entries for language tokens that existed in the old sequence but not in the new sequence are located in Language Token Data Table 726 in database 108 by the combination of their Reading Index (position in the sequence) 732 and their Associated Interpretation ID 728, and they are removed. Data entries for language tokens that exist in the new sequence but not in the old sequence are added to Language Token Data Table 726 in database 108, including the language tokens' Associated Interpretation ID 728, new Reading Index (position in the sequence) 732, Text String (of token's characters) 730, and Creating User ID 738 that is identical to the ID of the currently logged-in user 110—but with no Beginning Timestamp 734 nor Ending Timestamp 736. Data entries for language tokens whose position in the sequence changed from the old sequence to the new sequence are located in Language Token Data Table 726 in database 108 based on their Associated Interpretation ID 728 and their Reading Index (position in the sequence) 732 in the old sequence, and their Reading Index (position in the sequence) 732 is then updated to reflect their position in the new sequence.

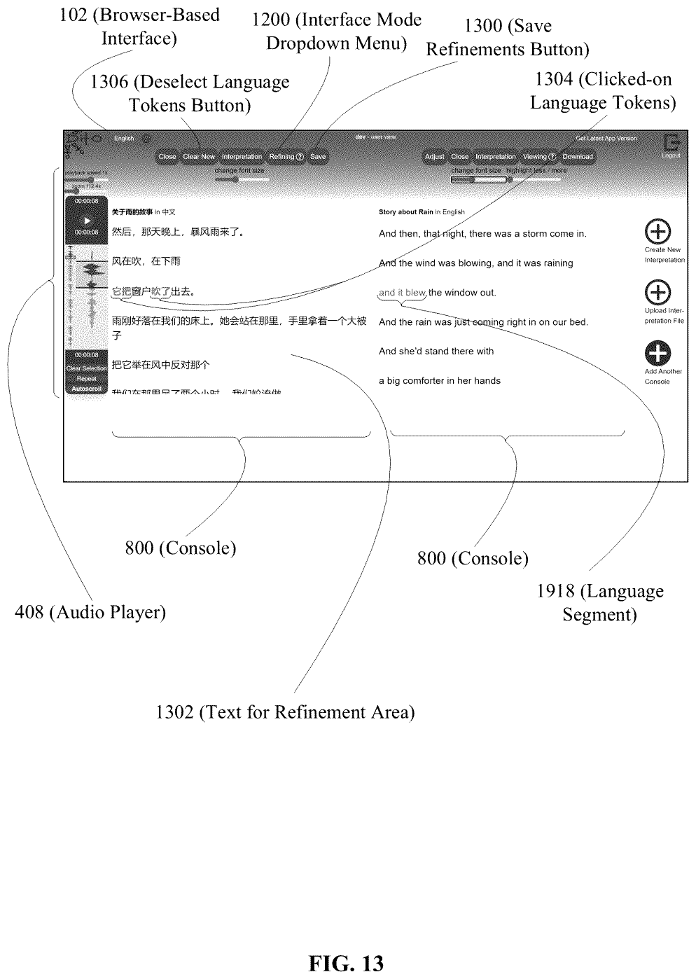

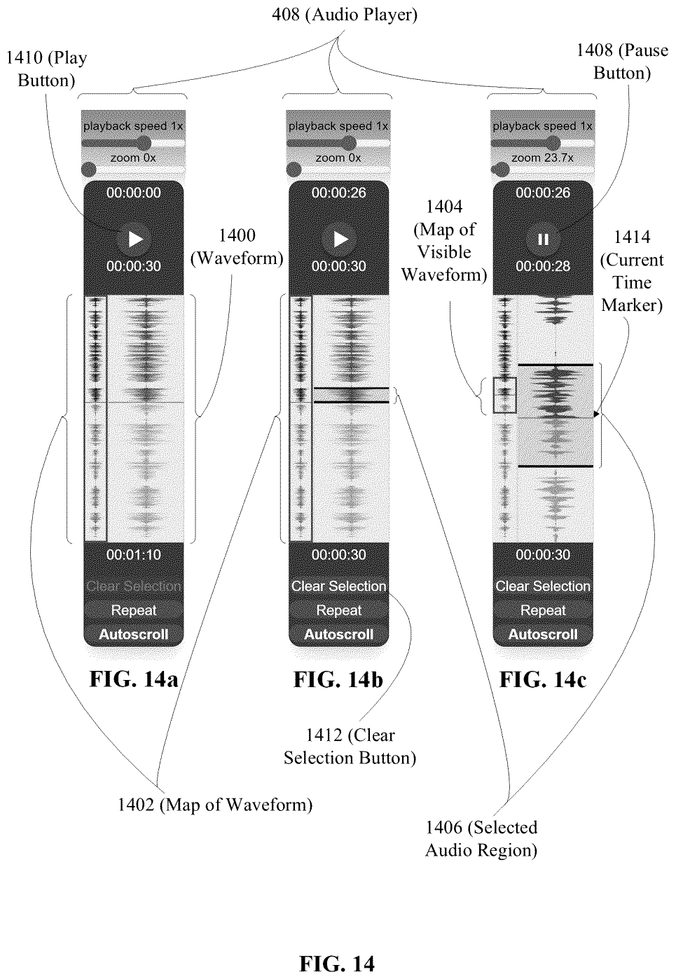

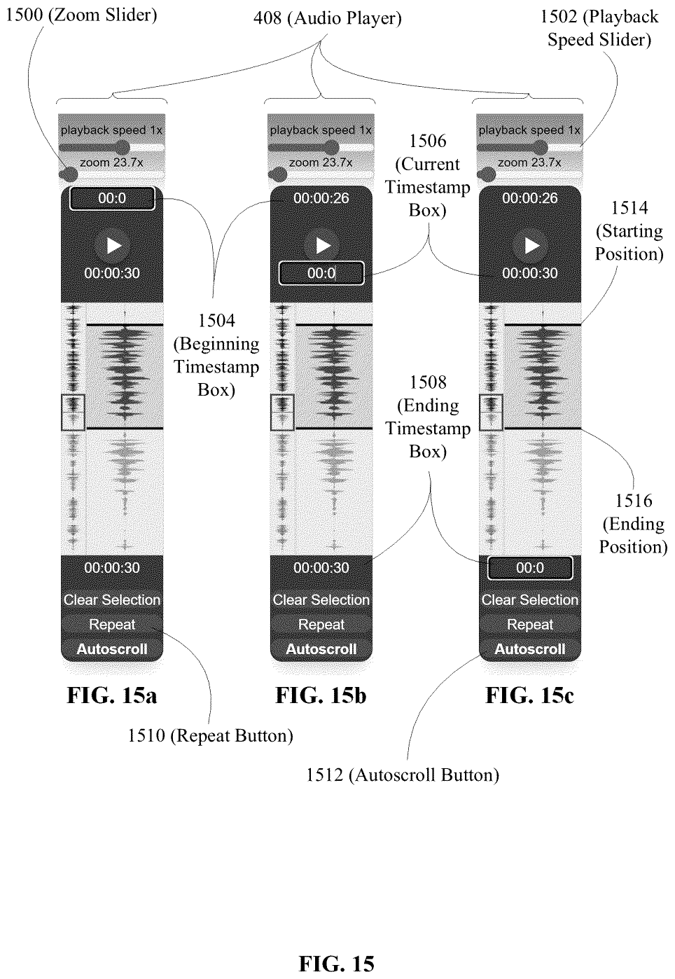

FIG. 13 illustrates one view of the browser-based interface 102 as seen by a user 110 who is viewing two consoles 800 of side-by-side time-aligned metadata for audio data 204. The user 110 has changed the left-most console into Refining mode via Interface Mode Dropdown Menu 1200. Since some language tokens in the time-aligned metadata may have no timestamp ranges associated with them—for example, language tokens added into the metadata via the Editing mode of the browser-based interface 102—and other language tokens may have—based on erroneous input by user(s) 110—acquired imprecise, inaccurate, or at any rate undesirable timestamp ranges associated with them, the Refining mode of interacting with an interpretation allows the user 110 to assign new timestamp ranges to existing language tokens without changing their reading order. In Refining mode, language tokens are displayed in reading order in Text for Refinement Area 1302 in console 800, and if a user 110 clicks on them (or clicks and drags the mouse over them), then the preferred embodiment of the present disclosure displays them in bold green font in the browser-based interface 102 to indicate to the user 110 that they have been selected. In FIG. 13, Clicked-on Language Tokens 1304 have been thus selected. The user 110 can then assign a new timestamp range to the selected language tokens by also selecting a timestamp range in Audio Player 408 (shown in more detail in FIGS. 14a-14c and FIGS. 15a-15c), then clicking Save Refinements Button 1300 in the same console 800 in which they selected the language tokens. Once the user 110 clicks Save Refinements Button 1300, the preferred embodiment of the present disclosure identifies the relevant data entries in Language Token Data Table 726 in database 108 using each selected language token's Associated Interpretation ID 728 and Reading Index (position in the sequence) 732, then updates the Beginning Timestamp 734 and Ending Timestamp 736 fields for those data entries to the beginning and ending values of the timestamp range currently selected in Audio Player 408. The preferred embodiment then returns all language tokens that are displayed in Text for Refinement Area 1302 in the relevant console 800 in browser-based interface 102 to their deselected state. Whenever the user 110 clicks Deselect Language Tokens Button 1306, the preferred embodiment will return all language tokens that are displayed in Text for Refinement Area 1302 in the relevant console 800 to their deselected state. Also, whenever the user 110 presses ALT (a key on the user 110's keyboard) while clicking on or clicking and dragging over (with a pointer) selected tokens such as Clicked-on Language Tokens 1304, each of the language tokens clicked on or clicked-and-dragged over will be deselected by the preferred embodiment of the present disclosure.

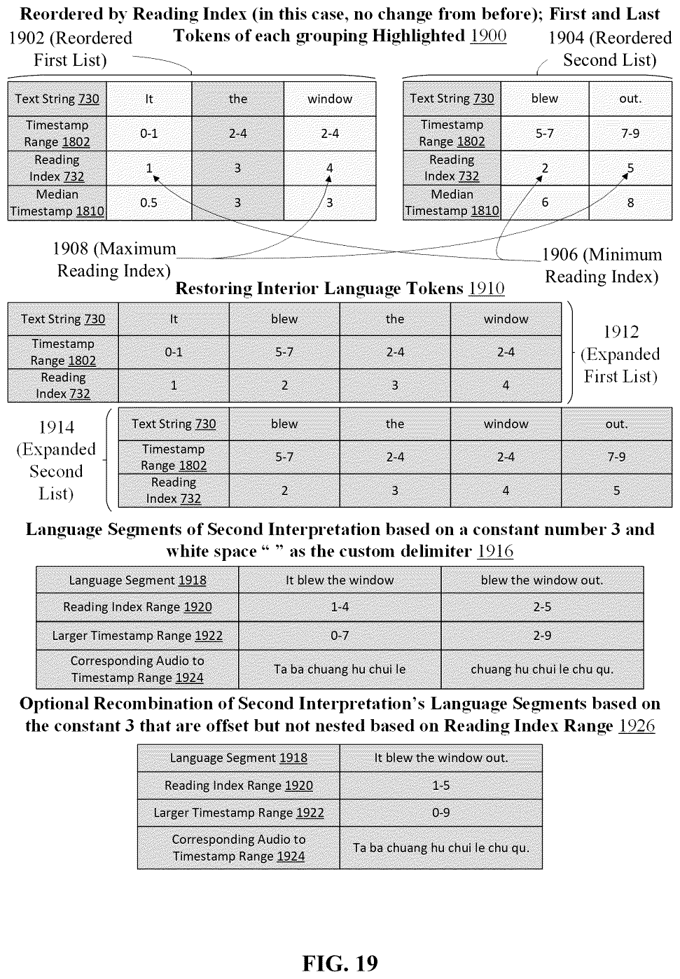

In the view shown in FIG. 13, the user 110 made use of right-most Console 800 in Viewing mode to select a timestamp range in Audio Player 408 by clicking on the Language Segment 1918 (described in FIG. 19) “and it blew,”. This caused Audio Player 408 to select and play the Selected Audio Region 1406 (described in FIG. 14) that corresponds to “and it blew,” based on the language metadata informing the right-most Console 800. The user 110 can, by clicking Save Refinements Button 1300, now cause the preferred embodiment of the disclosure to further associate the timestamp range corresponding to “and it blew,” in the right-most Console 800 with Clicked-on Language Tokens 1304 in the left-most Console 800. Using this process can save time for two users 110 who are both interpreting or time-aligning the same audio data 204; they can share their interpretations with each other in the preferred embodiment of the present disclosure and use this method to reuse each others' segmentations of the audio data 204 if and whenever they want to (though they are not constrained to do so). This method can also save time for a single user 110 that is creating two versions of time-aligned metadata for a single set of audio data 204.

FIGS. 14a, 14b, and 14c and FIGS. 15a, 15b, and 15c are different views of Audio Player 408. Audio Player 408 plays or pauses the audio data 204 that loaded into it whenever the user 110 clicks the Play Button 1410 or the Pause Button 1408, respectively. Map of Waveform 1402 is displayed on the left side of Audio Player 408, and Waveform 1400 is displayed on the right side of Audio Player 408. The user 110 can click and drag the Zoom Slider 1500 to zoom in or zoom out of Waveform 1400. When Waveform 1400 is zoomed in (as in FIG. 14c and FIG. 15), Map of Waveform 1402 includes a green box surrounding Map of Visible Waveform 1404, which is the part of Map of Waveform 1402 that is visible in Waveform 1400. Within Waveform 1400, the user 110 may select a region 1406 of the audio data 204 or deselect such a region 1406 by clicking Clear Selection Button 1412. The user 110 may also select a region 1406—or adjust the Starting Position 1514 or Ending Position 1516 of an existing Selected Audio Region 1406—of the audio data 204 by entering new timestamps into Beginning Timestamp Box 1504 or Ending Timestamp Box 1508, respectively, then pressing Enter (a button on the keyboard that user 110 is using). The user 110 may also select a region 1406—or adjust the Starting Position 1514 or Ending Position 1516 of an existing Selected Audio Region 1406—of the audio data 204 by clicking and dragging on Waveform 1400. The preferred embodiment of the present disclosure keeps the values in Beginning Timestamp Box 1504 and Ending Timestamp Box 1508 up-to-date with the beginning and ending timestamps of the selected audio region 1406 (if it is present) irrespective of how Starting Position 1514 and Ending Position 1516 are set or adjusted. If no region is selected in the audio data 204, then Beginning Timestamp Box 1504 and Ending Timestamp Box 1508 display the beginning and ending timestamps, respectively, of the audio data in full.

The user 110 can seek through the audio data by clicking on Waveform 1400 or by changing the timestamp in Current Timestamp Box 1506 and then pressing Enter (a button on the keyboard that user 110 is using). The user 110 can also speed up or slow down audio playback by clicking, or clicking and dragging on, Playback Speed Slider 1502 with their pointer. The user 110 can also cause Audio Player 408 either to pause when it reaches the end of a Selected Audio Region 1406 (or the end of the audio data 204 if no region is selected) or to replay a selected region 1406 (or replay audio data 204 in full if no region is selected) by clicking Repeat Button 1510 to toggle it on (represented by bold font within the button 1510) or off (represented by normal-weight font within the button 1510). By similarly clicking on Autoscroll Button 1512 to toggle it on or off, the user 110 can cause Waveform 1400 to either a) scroll to follow Current Time Marker 1414 or b) display only a static Waveform 1400 irrespective of whether or not Current Time Marker 1414 (and, correspondingly, the portion of audio data 204 currently being played by Audio Player 408) is within it.

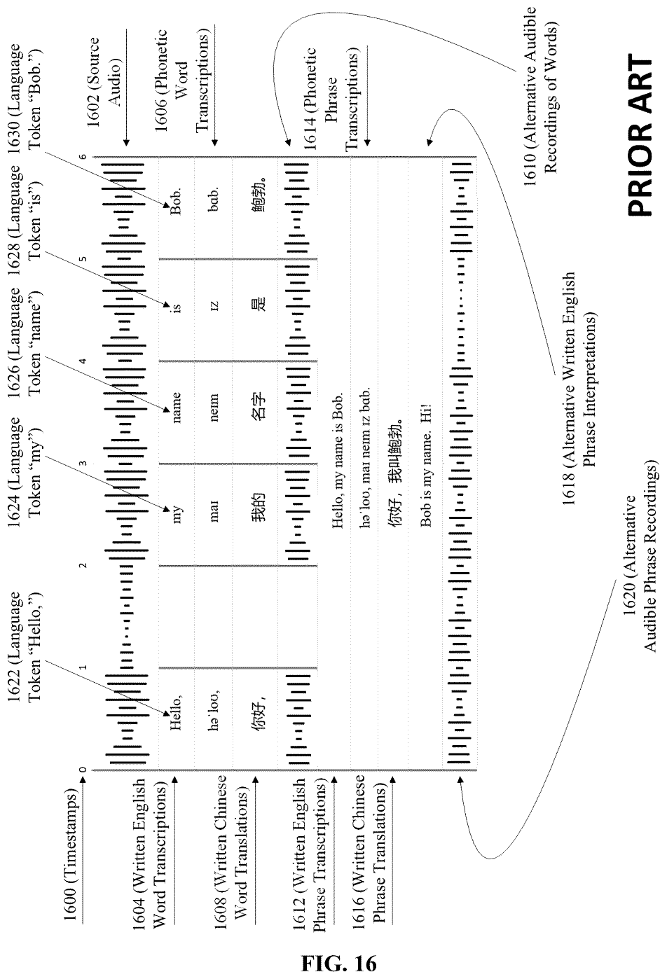

FIG. 16 is a table representing how timestamps are used to index language data and metadata by prior art software. Source Audio 1602 is recorded and Timestamps 1600 are used to index the recording. In the example illustrated in FIG. 16, Source Audio 1602 is an English recording of somebody saying, “Hello, my name is Bob.” Written English Word Transcriptions 1604 of sounds in the Source Audio 1602 can be stored by the prior art software, and the software preserves one-to-one relationships between the Written English Word Transcriptions 1604 and corresponding segments of the Source Audio 1602 using their corresponding ranges of Timestamps 1600. Phonetic Word Transcriptions 1606 of sounds in the Source Audio 1602 can also be stored by the software, and the software can preserve one-to-one relationships between the Phonetic Word Transcriptions 1606 and corresponding segments of the Source Audio 1602 using their corresponding ranges of Timestamps 1600. Similarly, translations in other written languages—such as Written Chinese Word Translations 1608—of sounds in the Source Audio 1602 can be stored by the software, and the software can preserve one-to-one relationships between those translations—such as Written Chinese Word Translations 1608—and corresponding segments of the Source Audio 1602 using their corresponding ranges of Timestamps 1600. Alternative Audible Recordings of Words 1610 can also be made of sounds in the Source Audio 1602, and these can be stored by the software along with one-to-one relationships between those Alternative Audible Recordings of Words 1610 and corresponding segments of the Source Audio 1602 based on their corresponding ranges of Timestamps 1600.

Prior art software can also store transcriptions of segments of the Source Audio 1602 that are longer (or shorter) than single words; for example, it can store Written English Phrase Transcriptions 1612 and Phonetic Phrase Transcriptions 1614 of sounds in the Source Audio 1602. Similarly, it can store translations in other written languages—such as Written Chinese Phrase Translations 1616—of segments of sounds in the Source Audio 1602 that are longer (or shorter) than single words. It can also store alternative interpretations of the Source Audio 1602, such as Alternative Written English Phrase Interpretations 1618 and Alternative Audible Phrase Recordings 1620, that use different words—or use words in a different order—from Written English Phrase Transcriptions 1612 and Source Audio 1602. This can be useful for paraphrasing and/or clarifying the original language data. When words and phrases are translated into other written languages, word choice can depend on the length of the segment of the Source Audio 1602 being translated, as illustrated in the different words used between Written Chinese Word Translations 1608 and Written Chinese Phrase Translations 1616. FIG. 16, which represents how language data and metadata are stored by prior art software, does not make explicit how individual or sets of language tokens such as Language Token “Hello,” 1622; Language Token “my” 1624; Language Token “name” 1626; Language Token “is” 1628; and Language Token “Bob.” 1630 correspond to subcomponents of “Bob is my name. Hi!” within Alternative Written English Phrase Interpretations 1618. This reflects how prior art software can determine that Language Token “Hello,” 1622 and Language Token “my” 1624 and Language Token “name” 1626 and Language Token “is” 1628 and Language Token “Bob.” 1630 correspond collectively to the entirety of “Bob is my name. Hi!” within Alternative Written English Phrase Interpretations 1618 but not preserve explicit information about which individual words or sets of words within “Bob is my name. Hi!” 1618 correspond to which individual language tokens or sets of language tokens 1622, 1624, 1626, 1628, and 1630.

FIG. 17 represents how language data and metadata are stored in one embodiment of the present disclosure. The Source Audio 1702 is stored and indexed via Timestamps In Source Audio 1700. Written English Phrasal Transcriptions 1704, Phonetic Phrasal Transcriptions 1706, phrasal translations in other written languages such as Written Chinese Phrasal Translations 1708, alternative written interpretations such as Alternative Written English Phrasal Interpretations 1710, and Alternative Audible Phrasal Recordings 1712 are split into individual language tokens by the embodiment of the present disclosure, and those language tokens are stored in data entries in Language Token Data Table 726 in database 108 (see FIG. 31). In FIG. 17, Written English Phrasal Transcriptions 1704 and Phonetic Phrasal Transcriptions 1706 can be split into language tokens by whitespace. In Written English Phrasal Transcriptions 1704, this produces Language Token “Hello,” 1718; Language Token “my” 1720; Language Token “name” 1722; Language Token “is” 1724; and Language Token “Bob.” 1726. In Written Chinese Phrasal Translations 1708, each character—such as Language Token “,” 1732 and Language Token “ [symbol] ” 1730—can be treated as a language token. In Alternative Audible Phrasal Recordings 1712, audible segments (highlighted in gray in the FIG. 17) separated by relative silence, such as Audible Language Token “name.” 1728, can be treated as language tokens. Each language token is stored in a separate data entry in Language Token Data Table 726 along with a numerical value range—being, in this embodiment of the present disclosure, a numerical value range corresponding to a range of timestamps from Beginning Timestamp 734 to Ending Timestamp 736—and a Reading Index (position in the sequence) 732, which is an indication of its position in the reading order of language tokens—all identifiable by the Associated Interpretation ID 728 that they share in common in Language Token Data Table 726—containing it. In FIG. 17, each language token's value range from Beginning Timestamp 734 to Ending Timestamp 736 is written directly beneath it, and each language token's Reading Index (position in the sequence) 732 is written directly below that.

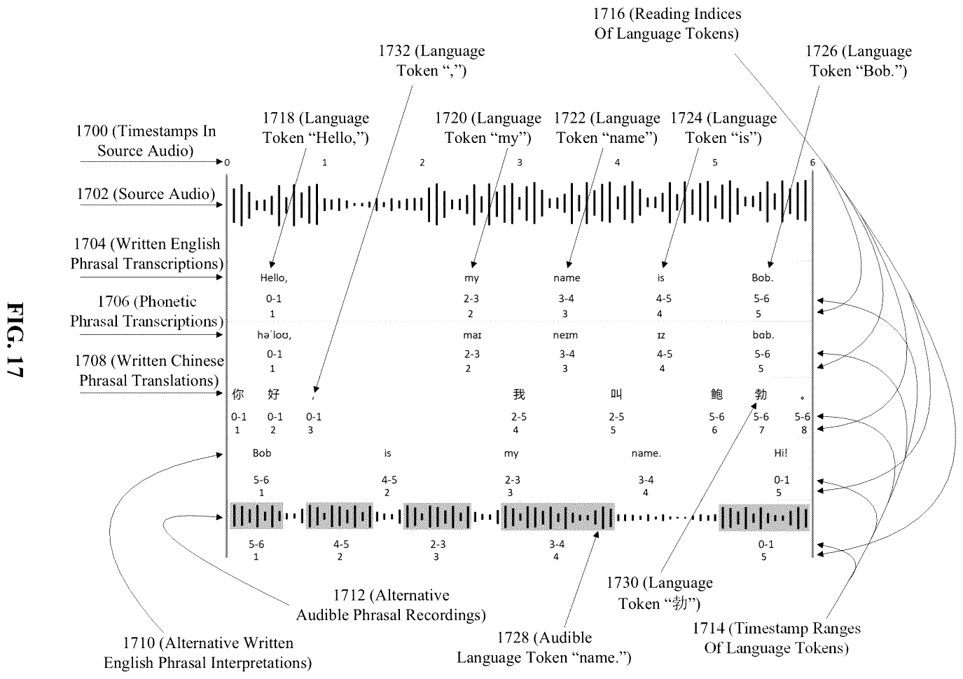

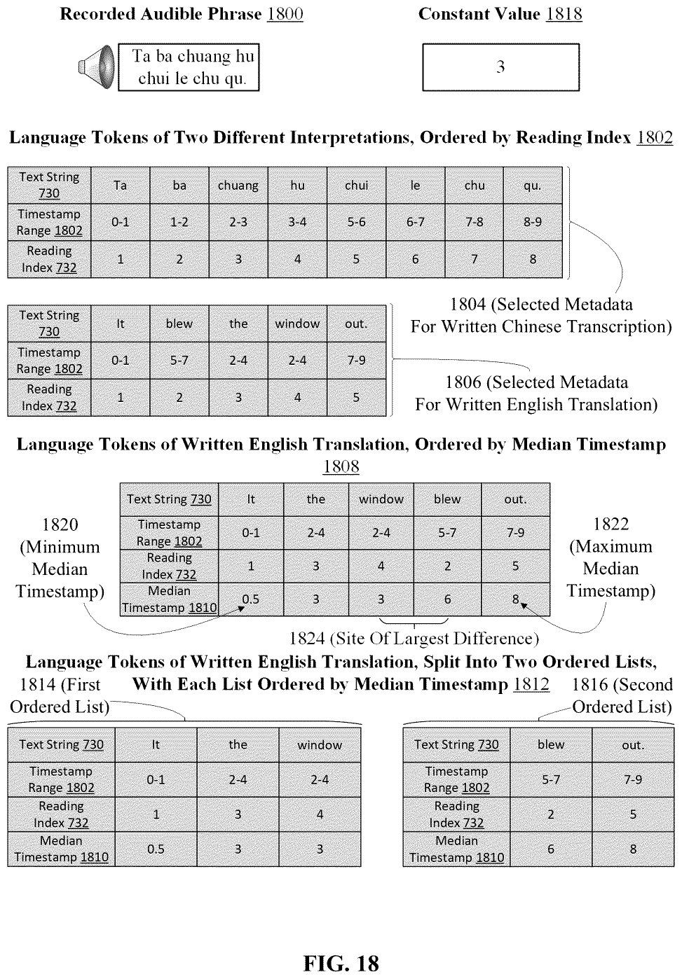

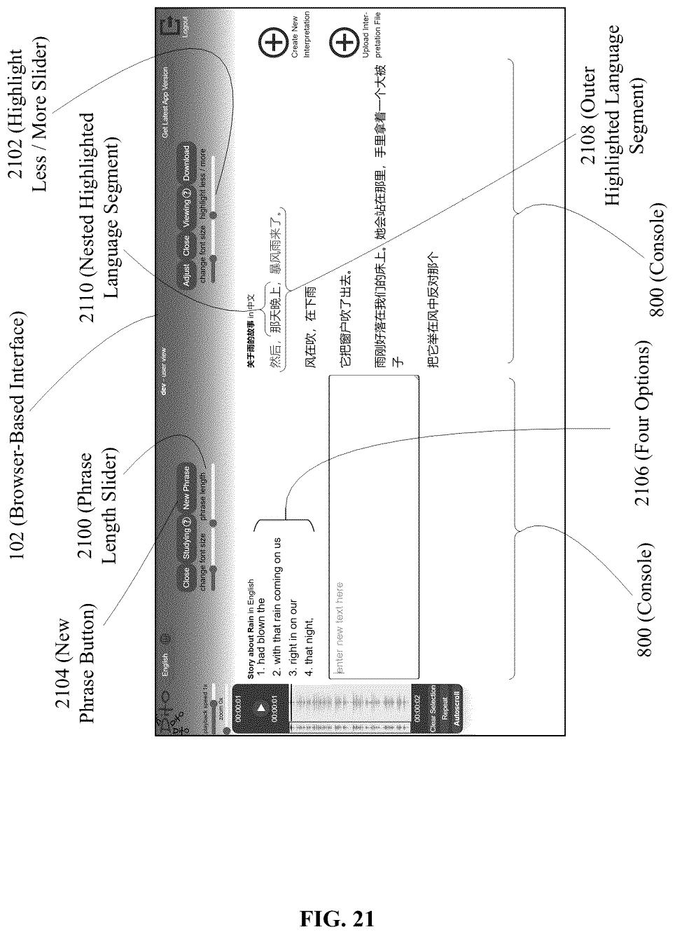

FIG. 18 and FIG. 19, viewed consecutively and from top to bottom, show how language data and metadata stored in Language Token Data Table 726 (see FIG. 7, FIG. 17, and FIG. 31) by the preferred embodiment of the present disclosure can, after being retrieved again by the preferred embodiment, be processed by it into a list of language segments 2000 of an approximate length set by user 110. In FIG. 18, Recorded Audible Phrase 1800 is a recording stored in database 106 of someone speaking the Chinese sentence, “Ta ba chuang hu chui le chu qu.” Constant Value 1818, which the user 110 defined by clicking with their pointer (or clicking on and dragging with their pointer) Phrase Length Slider 2100 (within a console 800 in Studying Mode; see FIG. 21) or Highlight Less/More Slider 2102 (within a console 800 in Viewing Mode; see FIG. 21), has a value of “3”. Selected Metadata For Written Chinese Transcription 1804 is a table displaying three selected fields Text String 730, Timestamp Range 1802, and Reading Index 732 from Language Token Data Table 726 for eight columnar language token data entries. Each of the eight language token columns is from the same interpretation, meaning that they each would have an identical Associated Interpretation ID 728 in Language Token Data Table 726. Selected Metadata For Written English Transcription 1806 is a table displaying three selected fields Text String 730, Timestamp Range 1802, and Reading Index 732 from Language Token Data Table 726 for five columnar language token data entries. Each of the five language token columns is from the same interpretation, meaning that they each would each have an identical Associated Interpretation ID 728 in Language Token Data Table 726.

In the two tables 1804 and 1806 in the section of FIG. 18 labeled Language Tokens of Two Different Interpretations, Ordered by Reading Index 1802, each value of Timestamp Range 1802 is associated with a Text String 730 value. The Timestamp Range 1802 value contains a Beginning Timestamp 734 value, a hyphen “-”, and then an Ending Timestamp 736 value, and those two timestamp values can be used by the preferred embodiment of the present disclosure to bracket the portion of Recorded Audible Phrase 1800 that corresponds with the associated Text String 730 value. For example, the Selected Metadata For Written Chinese Transcription 1804 table indicates that, in Recorded Audible Phrase 1800, an utterance corresponding with “chui” is audible between timestamps 5 and 6. Since Selected Metadata For Written Chinese Transcription 1804 contains language tokens of a transcription (and transcriptions are meant to represent uttered sounds one-to-one), ordering its language token data entries by their Reading Index 732 values puts the Text String 730 values in the same order that they can be heard uttered in in Recorded Audible Phrase 1800. In contrast, Selected Metadata For Written English Translation 1806 contains language tokens of a translation into another written language, and ordering its language token data entries by their Reading Index 732 values puts the Text String 730 values into an order that differs from the order in which their corresponding utterances can be heard in in Recorded Audible Phrase 1800. This is observable in table 1806 in section 1802: the Reading Index 732 values are in consecutive order, which causes the Text String 730 values to make grammatical sense when read from left to right, but the Timestamp Range 1802 values are not in consecutive order.

Given the Constant Value 1818 of “3”, defined by the user in interaction with Browser-Based Interface 102, the preferred embodiment of the disclosure can use the information in Selected Metadata For Written English Translation 1806 to identify language segments of multiple ordered language tokens in written English, with each segment corresponding to approximately three units of time in the Recorded Audible Phrase 1800 in spoken Chinese. First, the preferred embodiment can use the Timestamp Range 1802 values to create a new attribute, Median Timestamp 1810—the median value of Beginning Timestamp 734 and Ending Timestamp 736—for each language token. The preferred embodiment then reorders the language tokens by Median Timestamp 1810, as shown in the table called Language Tokens of Written English Translation, Ordered by Median Timestamp 1808. Then, the preferred embodiment calculates the difference between the Maximum Median Timestamp 1822 in the table and the Minimum Median Timestamp 1820 in the table. If the difference is greater than Constant Value 1818—which, in the example of FIG. 18, it is (7.5>3)—then the preferred embodiment also calculates the difference between each neighboring pair of median timestamps in the table 1808 given the current order of language tokens and identifies the Site Of Largest Difference 1824 (in FIG. 18, the largest difference is 6−3=3). If there is a tie for the largest difference, the preferred embodiment will choose the right-most of the options to be the Site Of Largest Difference 1824. The preferred embodiment then splits the table 1808 at the location of Site Of Largest Difference 1824; in FIG. 18, this results in the two tables First Ordered List 1814 and Second Ordered List 1816 shown in Language Tokens of Written English Translation, Split Into Two Ordered Lists, With Each List Ordered by Median Timestamp 1812. Since, for First Ordered List 1814, the maximum difference in median timestamp is 2.5 (3−0.5=2.5), and that is less than the Constant Value 1818 (2.5<3), the preferred embodiment does not further split First Ordered List 1814. Since, for Second Ordered List 1816, the maximum difference in median timestamp is 2 (8−6=2), and that is less than the Constant Value 1818 (2<3), the preferred embodiment does not further split Second Ordered List 1816.

Continuing from FIG. 18 into FIG. 19, the preferred embodiment of the present disclosure then reorders both First Ordered List 1814 and Second Ordered List 1816 based on each's Reading Index 732 values, sorting them (alongside their respective data entries) from smallest to largest. In FIG. 18 and FIG. 19, this results in no change between First Ordered List 1814 and Reordered First List 1902, nor between Second Ordered List 1816 and Reordered Second List 1904. In cases other than this example, the order of the language tokens in some or all of the lists may change during this step 1900. In the next step, Restoring Interior Language Tokens 1910, the preferred embodiment of the present disclosure expands each of Reordered First List 1902 and Reordered Second List 1904 to include all of the original language tokens from Selected Metadata For Written English Translation 1806 whose Reading Index 732 values are both greater than or equal to the respective list's Minimum Reading Index 1906 and lesser than or equal to the respective list's Maximum Reading Index 1908. This step creates Expanded First List 1912 and Expanded Second List 1914, each of which is ordered by its Reading Index 1810 values, smallest to largest. In the next step 1916, the ordered Text String 730 values (along with the Custom Delimiter 722 associated with the Interpretation ID 714 that matches all of the relevant language tokens' Associated Interpretation ID 728), Timestamp Range 1802 values, and Reading Index 732 values in Expanded First List 1912 are combined into, respectively, a Language Segment 1918 value, an encompassing Reading Index Range 1920 value, and an encompassing Larger Timestamp Range 1922 value. Similarly, the ordered Text String 730 values (along with the Custom Delimiter 722 associated with the Interpretation ID 714 that matches all of the relevant language tokens' Associated Interpretation ID 728), Timestamp Range 1802 values, and Reading Index 732 values in Expanded Second List 1914 are combined into, respectively, a Language Segment 1918 value, an encompassing Reading Index Range 1920 value, and an encompassing Larger Timestamp Range 1922 value. The Corresponding Audio to Timestamp Range 1924 values in step 1916 are based on their associated Larger Timestamp Range 1922 values; they are written representations of the utterances in Recorded Audible Phrase 1800 that will be associated with the newly defined Language Segment 1918 values by the preferred embodiment of the present disclosure. They may be verified by comparing the Larger Timestamp Range 1922 values for each Language Segment 1918 value with the Timestamp Range 1802 values for each Text String 730 in Selected Metadata For Written Chinese Transcription 1804. The results of step 1916, in conjunction with Recorded Audible Phrase 1800, can be useful—for example—within language learning activities in which a user 110 matches spoken Chinese phrases with written English phrases. Finally, since the two Reading Index Range 1920 values resulting from step 1916 overlap—meaning some words (language tokens) are included in both of the two Language Segment 1918 values—the preferred embodiment may further combine them (without duplication) along with their associated Language Segment 1918 values (including also any instances of the Custom Delimiter 722 associated with the Interpretation ID 714 that matches all the relevant language tokens' Associated Interpretation ID 728), Larger Timestamp Range 1922 values, and Corresponding Audio Timestamp Range 1924 values, as shown in step 1926. The results of step 1926 may be used by the preferred embodiment of the present disclosure—for example, to highlight the phrases of a written transcript that correspond to the different segments of an audio file (in this case, Recorded Audible Phrase 1800) as they play, one by one. In other embodiments, Step 1926 could be completed earlier, for example before step 1910 or before step 1916, by combining Reordered First List 1902 with Reordered Second List 1904 or combining Expanded First List 1912 with Expanded Second List 1914 based on their Minimum Reading Indices 1906 and Maximum Reading Indices 1908.

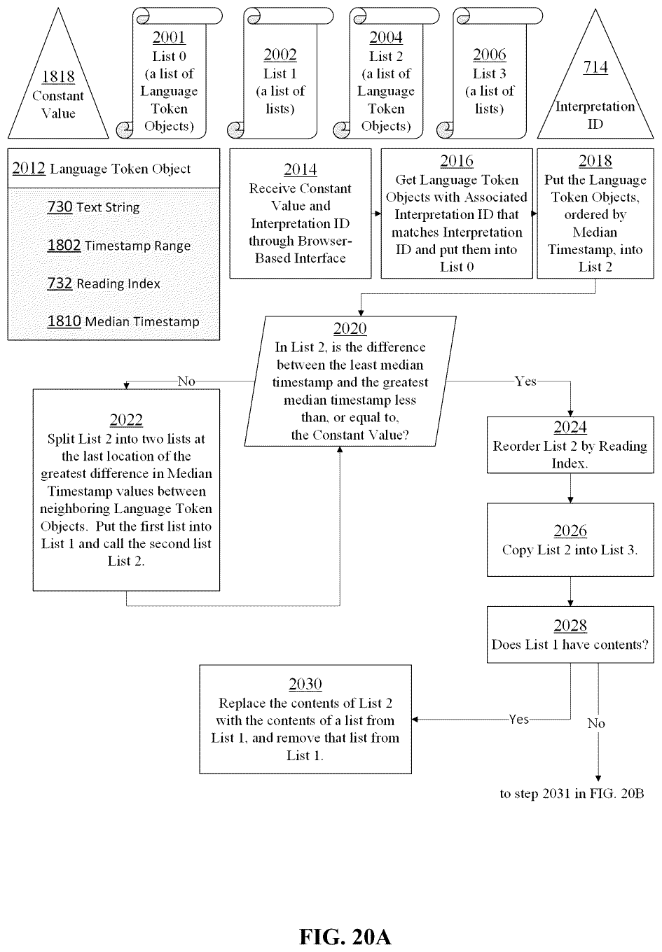

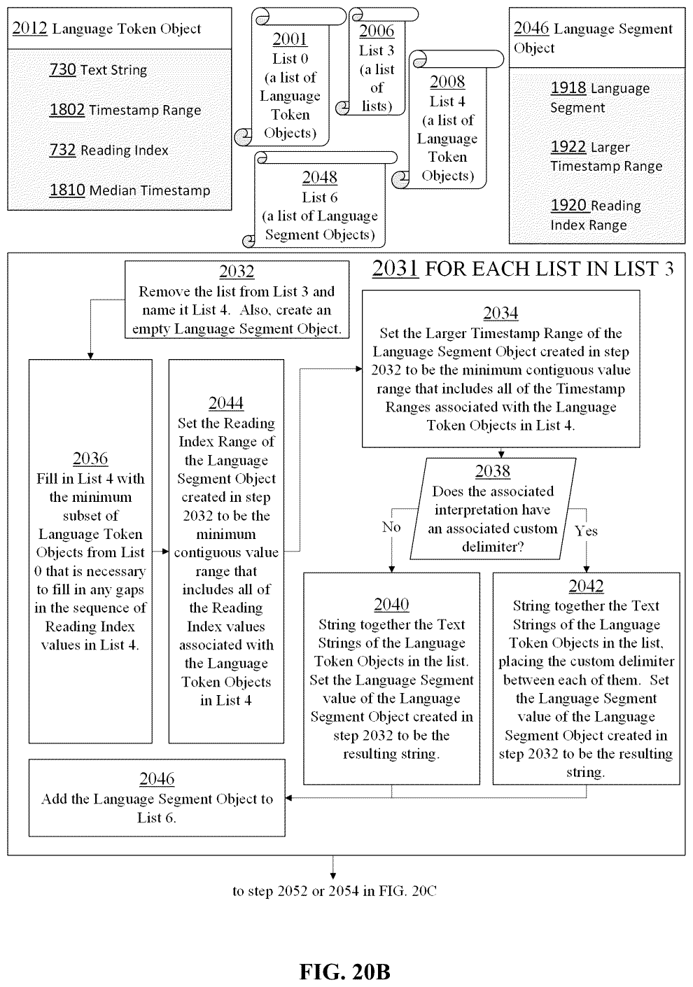

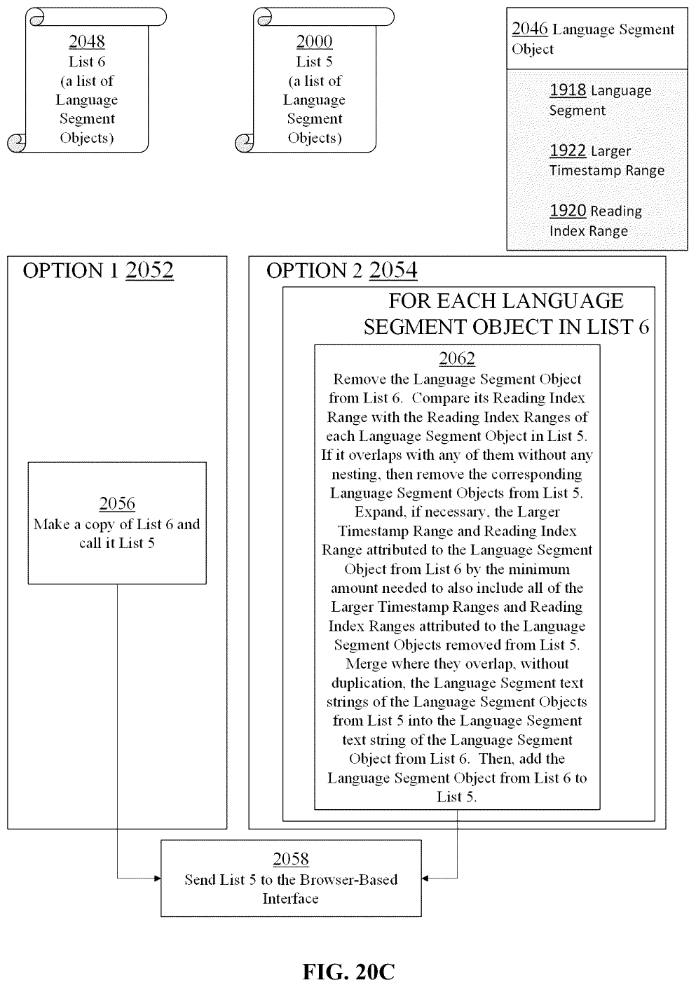

FIGS. 20A-20C are a flowchart illustrating how the preferred embodiment processes Language Token Objects 2012, which are metadata that is time-aligned to a set of audio data, in conjunction with an Interpretation ID 714 and user input of a Constant Value 1818 to create a list 2000 (see FIG. 20C) of Language Segment Objects 2046 (described in FIG. 20B) comprising Language Segments 1918 associated with Larger Timestamp Ranges 1922 and Reading Index Ranges 1920 that it then sends to be displayed or used in the Browser-Based Interface 102.

FIG. 20A is a view of steps of processing involving two lists 2001 and 2004 of Language Token Objects 2012, two lists 2002 and 2006 of lists, an Interpretation ID 714, and a Constant Value 1818. Each Language Token Object 2012 comprises a Text String 730, a Timestamp Range 1802, a Reading Index 732, and a Median Timestamp 1810. The flowchart logic begins, with step 2014, when a Constant Value 1818 is received through the Browser-Based Interface 102 in association with a console 800 preparing to display a set of time-aligned metadata identifiable by Interpretation ID 714. This causes, in step 2016, the processing portion of the preferred embodiment to create Language Token Objects 2012 from any data entries in Language Token Data Table 726 (described in FIG. 7) in database 108 that have an Associated Interpretation ID 728 matching the Interpretation ID 714 and put them into List 0 2001. The Timestamp Ranges 1802 of the Language Token Objects 2012 will range from the Beginning Timestamps 734 to the Ending Timestamps 736 of the data entries, and the Median Timestamps 1810 will be the averages of the Beginning Timestamp 734 and Ending Timestamp 736 values of the data entries. Next, in step 2018, the processing portion of the preferred embodiment puts the Language Token Objects 2012 from List 0 2001 into List 2 2004 in the order of their Median Timestamp 1810 values. Next, in step 2020, the processing portion of the preferred embodiment determines whether or not the difference between the Minimum Median Timestamp 1820 and Maximum Median Timestamp 1822 (see FIG. 18) of the Median Timestamps 1810 associated with the Language Token Objects 2012 in List 2 2004 is less than or equal to the Constant Value 1818. If it is not, then the processing portion of the preferred embodiment chooses the last location of the greatest difference 1824 (referenced in FIG. 18) in Median Timestamp 1810 values between neighboring Language Token Objects 2012 in List 2 2004, splits List 2 2004 at that location, and puts the first of the resulting lists into List 1 2002 as a list and names the second resulting list List 2 2004, returning it to step 2020 for further processing. Other embodiments of the present disclosure may choose a location of the greatest difference 1824 in Median Timestamp 1810 values between neighboring Language Token Objects 2012 in List 2 2004 that is not the last location and split List 2 2004 at that location.

If, on the other hand, in step 2020 the processing portion determines that the difference between the Minimum Median Timestamp 1820 and Maximum Median Timestamp 1822 of the Median Timestamps 1810 associated with Language Token Objects 2012 in List 2 2004 is less than or equal to the Constant Value 1818, then it commences step 2024 with List 2 2004. In step 2024, the processing portion of the preferred embodiment reorders the Language Token Objects 2012 in List 2 2004 by the order of their Reading Index 732 values. Following that, in step 2026, the processing portion of the preferred embodiment copies List 2 2004 into to List 3 2006, which is a list of lists. Next, in step 2028, the processing portion of the present embodiment evaluates whether List 1 2002 still contains any lists. If so, then, in step 2030, the processing portion of the preferred embodiment removes one of the lists from List 1 2002 and uses its contents to replace the contents of List 2 2004 and (then) sends List 2 2004 to step 2020 for further processing. If not, then the processing portion of the preferred embodiment moves to step 2050 in FIG. 20B. When this occurs, List 1 2002 should be empty of lists, and List 3 2006 should contain at least one list.

FIG. 20B is a view of steps of processing involving two lists 2001 and 2008 of Language Token Objects 2012, one list of lists 2006, and one list 2048 of Language Segment Objects 2046. Each Language Segment Object 2046 comprises a Language Segment 1918, a Larger Timestamp Range 1922, and a Reading Index Range 1920. The flowchart logic begins at step 2031 following on from logic in FIG. 20A. When this occurs, List 3 2006 should contain at least one list of Language Token Objects 2012. In step 2031, each list in List 3 2006 is processed as follows.

First, in step 2032, the list is removed from List 3 2006 and named List 4 2008; further, an empty Language Segment Object 2046 is created. Next, in step 2036, Language Token Objects 2012 are moved from List 0 2001 (see step 2016 of FIG. 20A) into List 4 2008 as necessary to fill in gaps in the sequence of Reading Indices 732 of Language Token Objects 2012 in List 4 2008. After this step is completed, the Reading Indices 732 of the Language Token Objects 2012 in List 4 2008 should be consecutive and in order. Then, in step 2044, the Reading Index Range 1920 of the Language Segment Object 2046 created in step 2032 is set to the minimum contiguous value range that includes all of the Reading Index 732 values that are associated with the Language Token Objects 2012 in List 4 2008. Next, in step 2034, the Larger Timestamp Range 1922 of the Language Segment Object 2046 created in step 2032 is set to the minimum contiguous value range that includes all of the Timestamp Ranges 1802 associated with the Language Token Objects 2012 in List 4 2008. Then, in step 2038, Interpretation ID 714 is used to check Interpretation Metadata Table 712 (see FIG. 7) in database 108 to see whether the set of time-aligned metadata being processed is associated with a Custom Delimiter 722. If yes, then, in step 2042, the processing portion of the preferred embodiment strings together the Text Strings 730 of the Language Token Objects 2012 in List 4 2008, placing the Custom Delimiter 722 between each one of them, and sets the value of Language Segment 1918 of the Language Segment Object 2046 created in step 2032 to be the resulting string. If no, then, in step 2040, the processing portion of the preferred embodiment strings together the Text Strings 730 of the Language Token Objects 2012 in List 4 2008 and sets the value of Language Segment 1918 of the Language Segment Object 2046 created in step 2032 to be the resulting string. Finally, after either step 2040 or step 2042 has completed, the processing portion of the preferred embodiment adds the Language Segment Object 2046 to List 6 2048. After steps 2032-2046 have completed for each list in List 3 2006, the processing portion of the preferred embodiment proceeds to either OPTION 1 2052 or OPTION 2 2054, shown in FIG. 20C.

FIG. 20C is a view of steps of processing involving two lists 2048 and 2000 of Language Segment Objects 2046 that concludes with sending list 2000 to be displayed or used in the Browser-Based Interface 102. In OPTION 1 2052, the processing portion of the preferred embodiment begins with step 2056, renaming List 6 2048 of Language Segment Objects 2046 to List 5 2000. In OPTION 2 2054, for each Language Segment Object 2046 in List 6 2048, the processing portion of the preferred embodiment conducts step 2062 as follows.

First, in step 2062, the processing portion of the preferred embodiment takes the Language Segment Object 2046 out of List 6 2048. Then, it compares the Language Segment Object's 2046 Reading Index Range 1920 with the Reading Index Range 1920 of each (if any) Language Segment Object 2046 in List 5 2000. If, in any of the comparisons of the Language Segment Objects 2046, the Reading Index Ranges 1920 overlap but do not nest one within the other, then the processing portion of the preferred embodiment removes the corresponding Language Segment Object 2046 from List 5 2000 and expands, if necessary, the Larger Timestamp Range 1922 and Reading Index Range 1920 of the Language Segment Object 2046 that was taken out of List 6 2048 by the minimum amount necessary to make them also include the Larger Timestamp Range 1922 and Reading Index Range 1920, respectively, of the Language Segment Object 2046 that was removed from List 5 2000. The processing portion of the preferred embodiment will also merge, without duplication, the Language Segment 1918 text string of the Language Segment Object 2046 that was removed from List 5 2000 into the Language Segment 1918 text string of the Language Segment Object 2046 that was taken from List 6 2048 based on the site where they overlap. Finally, concluding step 2062, the processing portion of the preferred embodiment will add to List 5 2000 the Language Segment Object 2046 that was taken out of List 6 2048.

After step 2056 concludes—or, alternatively, after step 2062 concludes for each Language Segment Object 2046 in List 6 2048—List 5 2000 will be a list of Language Segment Objects 2046, and the processing portion of the preferred embodiment will conduct step 2058. In step 2058, the processing portion of the preferred embodiment will send List 5 2000 of Language Segment Objects 2046 to the Browser-Based Interface 102.

FIG. 21 illustrates one view of the browser-based interface 102 as seen by a user 110 who is viewing two consoles 800 of time-aligned metadata for audio data 204. The user 110 has changed the left-most console into Studying mode via Interface Mode Dropdown Menu 1200. The right-most console remains in Viewing mode. The Phrase Length Slider 2100 in Studying mode and the Highlight Less/More Slider 2102 in Viewing mode can each be clicked and dragged by the user 110 to change the values of Constant Value 1818 associated with them. Whenever the Constant Value 1818 in a console 800 is changed, the preferred embodiment of the present disclosure generates a new list of language segments 2000 for the metadata being displayed in the respective console 800. It does so via the process charted in FIGS. 20A-20C and demonstrated in FIG. 18 and FIG. 19, and it adjusts its display of the metadata in the respective console 800 based on the resulting list 2000. Moving a slider within one console 800 has no effect on the content or display of any other console 800 except for secondary effects that could result from a consequent change to the selected region 1406 of, location of Current Time Marker 1414 within, or toggled play/pause setting (1410/1408) of Audio Player 408. Each console 800 lets the user 110 interact with a different set of metadata (identified by its Interpretation ID 714 and Associated Interpretation ID 728 in Interpretation Metadata Table 712 and Language Token Data Table 726, respectively).

In Viewing mode (on the right-hand side of FIG. 21), the Highlight Less/More Slider 2102's realized effect—via enabling user 110 to change Constant Value 1818—is to change the approximate minimum length of the sections of recorded audio whose corresponding language segments within the displayed metadata can be highlighted by the preferred embodiment of the present disclosure. In FIG. 21, two language segments—Nested Highlighted Language Segment 2110 and Outer Highlighted Language Segment 2108—are highlighted simultaneously; this occurs in the preferred embodiment of the present disclosure when there is assigned an identical Beginning Timestamp 734 to each of the language tokens that are exclusively in Outer Highlighted Language Segment 2108, a larger identical Beginning Timestamp 734 to each of the language tokens that is in Nested Highlighted Language Segment 2110, an even larger identical Ending Timestamp 736 to each of the language tokens in Nested Highlighted Language Segment 2110, and an even more large identical Ending Timestamp 736 to each of the language tokens that are exclusively in Outer Highlighted Language Segment 2108. With the Beginning Timestamps 734 and Ending Timestamps 736 so assigned, it is possible for the difference between the Median Timestamp 1810 of the language tokens in Nested Highlighted Language Segment 2110 and the Median Timestamp 1810 of the language tokens in Outer Highlighted Language Segment 2108 to be greater than Constant Value 1818. This will cause the process charted in FIGS. 20A-20C and demonstrated in FIG. 18 and FIG. 19 to determine that Nested Highlighted Language Segment 2110 and Outer Highlighted Language Segment 2108 are two different language segments, one of which has a Larger Timestamp Range 1922 that is nested inside the other's Larger Timestamp Range 1922. If the user 110 adjusts the Highlight Less/More Slider 2102 so that Constant Value 1818 increases to be greater than the difference between the Median Timestamp 1810 of the language tokens in Nested Highlighted Language Segment 2110 and the Median Timestamp 1810 of the language tokens in Outer Highlighted Language Segment 2108, then the process charted in FIGS. 20A-20C and demonstrated in FIG. 18 and FIG. 19 would produce Outer Highlighted Language Segment 2108, but not Nested Highlighted Language Segment 2110, in the resulting list of language segments 2000.

In Studying mode (demonstrated in the console 800 on the left-hand side of FIG. 21), the Phrase Length Slider 2100's realized effect—via enabling user 110 to change Constant Value 1818—is to change the approximate minimum length of the sections of recorded audio that the preferred embodiment of the present disclosure can play for the user 110 and whose corresponding language segments in the list of language segments 2000 can be selected from to compose the Four Options 2106 shown by the preferred embodiment to the user 110 as part of listening comprehension, reading comprehension, and language typing exercises.

The preferred embodiment's feature of allowing a user to change at any time the approximate minimum length of the sections of recorded audio they wish to study from using the time-aligned metadata (even when the time-aligned metadata is in a different language from the audio data, and without changing either the audio data or the sequence of time-aligned metadata) demonstrates the underlying efficiency of this embodiment of the disclosure at tasks of processing time-aligned metadata for language learning, teaching, and training activities. A single recording of audio data in one language, and a single translation of it into a written language—with each language token in the written language time-aligned to a region of the audio file—can be used by the preferred embodiment of the present disclosure to create language learning activities for any level of user: short activities for beginners, longer ones for advanced learners, and everything in between. Prior art cannot accomplish this, as is evident from FIG. 16. In the illustrated prior art method, if using a single Source Audio 1602 in English, then short spoken English to written Chinese language learning activities could be created using Written Chinese Word Translations 1608, and longer spoken English to written Chinese language learning activities could be created from Written Chinese Phrase Translations 1616. With such a method, a separate set of time-aligned metadata would be required for every desired length of phrase in language learning activities. The Written Chinese Word Translations 1608 could not be used in longer language activities because there is no information provided about what sequence to put them in to make an intelligible sentence; furthermore, the Written Chinese Word Translations 1608 sometimes different words than what would be used in a Written Chinese Phrase Translation 1616. By contrast, embodiments of the present disclosure overcome this limitation.

In Studying Mode, the user 110 can click on or retype whichever language segment of the Four Options 2106 best corresponds to the audio data being played from the Browser-Based Interface 102, and that action will trigger the preferred embodiment of the present disclosure to play a new segment of recorded audio and display, correspondingly, a new Four Options 2106 of language segment choices for the user 110 to select from for clicking on or retyping. Alternatively, the user 110 can click New Phrase Button 2104 to trigger the same response from the preferred embodiment of the present disclosure. The content of the console 800 in Viewing mode (on the right-hand side of FIG. 21) can help inform the user 110 as they complete the tasks in the console 800 in Studying mode (on the left-hand side of FIG. 21).

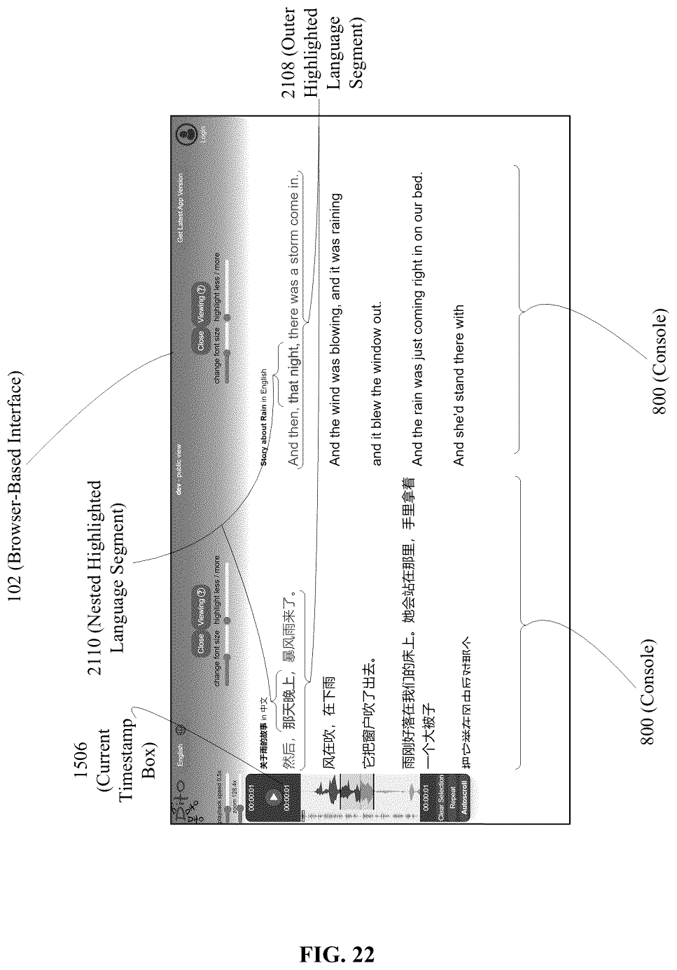

FIG. 22 illustrates one view of the browser-based interface 102 as seen by a user 110 who is viewing two consoles 800 of time-aligned metadata for audio data 204. Both consoles 800 are in Viewing mode, and both Highlight Less/More Sliders 2102 are dragged all the way to the left, causing the preferred embodiment of the present disclosure to work with very short Language Segments 1918 wherever it has enough data to identify them. In FIG. 22, the time in Current Timestamp Box 1506 is 00:00:01, and both consoles 800 show Nested Highlighted Language Segments 2110 and Outer Highlighted Language Segments 2108. In the right-most console 800, “that night,” corresponds to a Nested Highlighted Language Segment 2110 and is highlighted in dark gray, and “And then, . . . there was a storm come in.” corresponds to an Outer Highlighted Language Segment 2108 and is highlighted in light gray, indicating that “And then, that night, there was a storm come in.” and “that night,” have been identified as two different Language Segments 1918.

The preferred embodiment of the present disclosure highlights Language Segments 1918 of interpretations that are displayed in consoles 800 in Viewing mode based on whether or not their associated Larger Timestamp Ranges 1922 include the current timestamp of the audio data 204 that is being played or paused within Audio Player 408. The preferred embodiment chooses what color to use to highlight (display in a particular color) the Text Strings (of tokens' characters) 730 of individual language tokens based on how many Language Segments 1918 contain them that also have the current timestamp of the audio data 204 that is being played or paused within Audio Player 408 in their Larger Timestamp Ranges 1922. For example, the Text Strings (of tokens' characters) 730 of individual language tokens that are in three different Language Segments 1918 whose associated Larger Timestamp Ranges 1922 include the current timestamp of the audio data 204 that is being played or paused within Audio Player 408 could be highlighted in purple, those in two such Language Segments 1918 could be highlighted in blue, those in one such Language Segment 1918 could be highlighted in red, and those in no such Language Segments 1918 could be displayed in black. If the current timestamp of the audio data 204 that is being played or paused within Audio Player 408 moves to be no longer within the associated Larger Timestamp Range 1922 of a Nested Highlighted Language Segment 2110, but stays within the associated Larger Timestamp Range 1922 of an immediately larger Outer Highlighted Language Segment 2108, then the Text Strings (of tokens' characters) 730 of the individual language tokens in the Nested Highlighted Language Segment 2110 will change to become displayed in the same color that the Text Strings (of tokens' characters) 730 of the individual language tokens in the Outer Highlighted Language Segment 2108 were already (and still are) being displayed in (for example, from blue to red, or from purple to blue).

In a console 800 in Viewing mode, clicking on a Text String (of token's characters) 730 of an individual language token in a Language Segment 1918 causes the preferred embodiment of the present disclosure to identify the Language Segment 1918 (or, if multiple, the innermost nested Language Segment 1918) containing it, then create and play a corresponding Selected Audio Region 1406 of the audio data 204 loaded into Audio Player 408. The Selected Audio Region 1406 is identified based on the Larger Timestamp Range 1922 associated with the identified Language Segment 1918. When preparing a list of language segments 2000 for a console 800 in Viewing mode, the preferred embodiment ensures that overlapping Language Segments 1918 can only be nested one inside the other (not offset from one another) by completing step 1926.

One way of creating language metadata that the preferred embodiment of the disclosure can use to generate a Nested Highlighted Language Segment 2110 and an Outer Highlighted Language Segment 2108 is to use a Console 800 in Refining mode—described in FIG. 13—to first assign a large timestamp range to a sequence of language tokens, then assign a shorter timestamp range that is nested in the middle of the large timestamp range to a subset of the sequence of language tokens (including in the subset neither the first nor the last language token in the sequence of language tokens). For example, a user 110 could use a Console 800 in Refining mode as described in FIG. 13 to first associate “And then, that night, there was a storm come in.” with a long region of audio data, then associate “that night,” with a shorter region of audio data that is in the center of the long region of audio data.

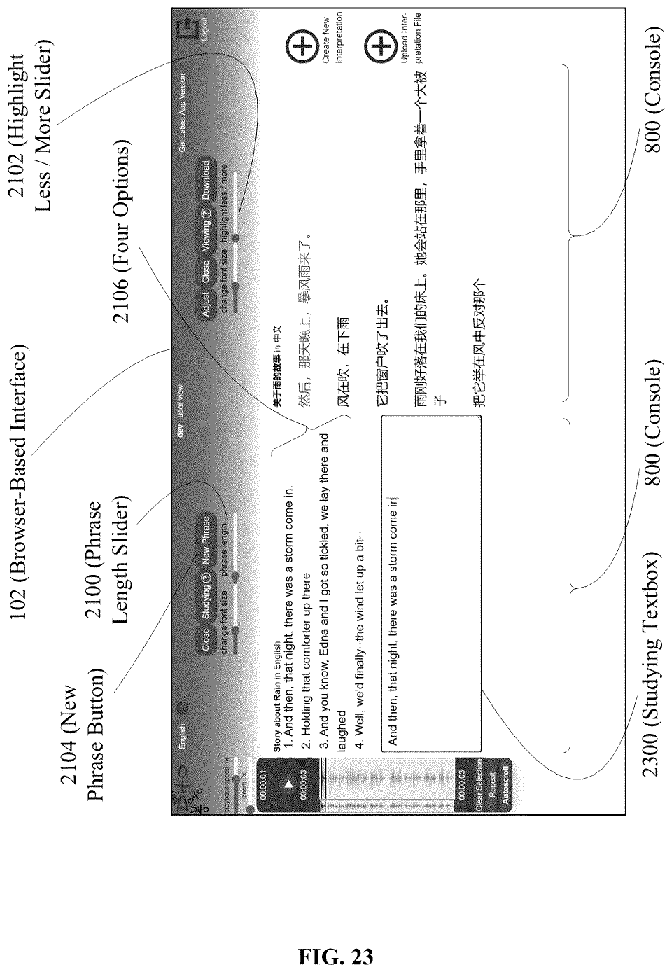

FIG. 23 illustrates one view of the browser-based interface 102 as seen by a user 110 who is viewing two consoles 800 of time-aligned metadata for audio data 204. The user 110 has changed the left-most Console 800 into Studying mode via Interface Mode Dropdown Menu 1200. The right-most Console 800 is in Viewing mode (the default mode). FIG. 23 is similar to FIG. 21, but in the left-most Console 800 of FIG. 23, Phrase Length Slider 2100 has been clicked and dragged slightly to the right by the user 110, causing the preferred embodiment of the present disclosure to use a larger Constant Value 1818 to generate Language Segments 1918 for the Console 800 on the left-hand side than it used in FIG. 21. As a result, the Four Options 2106 displayed in FIG. 23 are, on average, longer than the Four Options 2106 displayed in FIG. 21; and the Selected Audio Region 1406 of FIG. 23 is longer than the Selected Audio Region 1406 of FIG. 21 (in addition to the relatively larger footprint of Selected Audio Region 1406 in FIG. 23, the longer duration can be assessed by comparing the values in the timestamp boxes between the two figures: the Beginning Timestamp Boxes 1504 in FIG. 21 and FIG. 23 both display “00:00:01”, but the Ending Timestamp Box 1508 in FIG. 23 displays “00:00:03”, whereas the Ending Timestamp Box 1508 in FIG. 21 displays “00:00:02”). In addition, the right-most Console 800—which is in Viewing mode—of FIG. 23 is not highlighting any Nested Highlighted Language Segment 2110, indicating that the current timestamp (corresponding to the “00:00:03” displayed in the Current Timestamp Box 1506 of FIG. 23) of the audio data 204 that is paused within Audio Player 408 is included in the Larger Timestamp Range 1922 of only one Language Segment 1918 in the right-most Console's 800 corresponding list of language segments 2000. This can be contrasted with the left-most Console 800 of FIG. 22, which has a Current Timestamp Box 1506 displaying “00:00:01” and is displaying both a Nested Highlighted Language Segment 2110 and an Outer Highlighted Language Segment 2108 within the very same sentence “ [symbol] [symbol] ” of the same language metadata that is being highlighted as only a single Language Segment 2110 in the right-most Console 800 of FIG. 23. The difference in highlighted Language Segments 1918 corresponds to the different timestamps in Current Timestamp Box 1506 between the two figures.

In FIG. 23, the user 110 has almost completed typing a Language Segment 1918, chosen from among the Four Options 2106 and which—among them—most closely corresponds to the Selected Audio Region 1406 in Audio Player 408, into Studying Textbox 2300. Once the user 110 types the final “.” character of the Language Segment 1918, they will have completed the listening comprehension/reading comprehension/typing task, and the preferred embodiment of the present disclosure will display (and play through attached speakers) a new Selected Audio Region 1406 and also display a new Four Options 2106 of Language Segments 2000 chosen from its associated list of language segments 2000. The user 110 may then, again, choose a Language Segment 1918 from among the Four Options 2106 to click on with a pointer or type in full into Studying Textbox 2300. In the preferred embodiment of the present disclosure, only one Console 800 may be in Studying mode at a time; this is a limitation built into the preferred embodiment to prevent interference between two Studying consoles that might otherwise both try to generate Selected Audio Regions 1406 within Audio Player 408 at the same time.

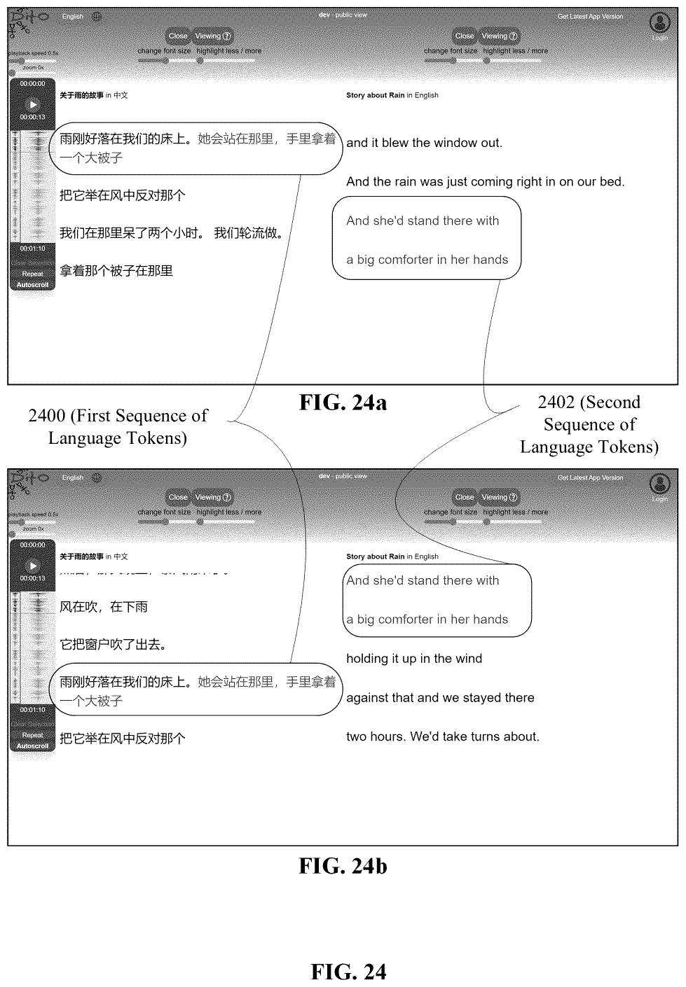

FIG. 24a and FIG. 24b are two similar views of the browser-based interface 102 as seen by a user 110 who is viewing two Consoles 800, each displaying different time-aligned metadata for audio data 204. In each of FIG. 24a and FIG. 24b, a First Sequence of Language Tokens 2400 and a Second Sequence of Language Tokens 2402 have been indicated. Comparison of FIG. 24a and FIG. 24b will reveal that the First Sequence of Language Tokens 2400 is identical between the two figures, as is the Second Sequence of Language Tokens 2402. The juxtaposition of the two similar views, FIG. 24a and FIG. 24b, illustrates the capability within the preferred embodiment of the present disclosure of Consoles 800 to be scrolled up and down independently of one another based on user input accepted through the Browser-Based Interface 102 (a graphical user interface displayed on a computer). Additionally, whenever a new Language Segment 1918 should become highlighted in any Console 800 in Viewing mode, the preferred embodiment of the present disclosure can scroll that Console 800 to ensure the display the highlighted Language Segment 1918 (or to display at least the first such Language Segment 1918 if there are multiple).

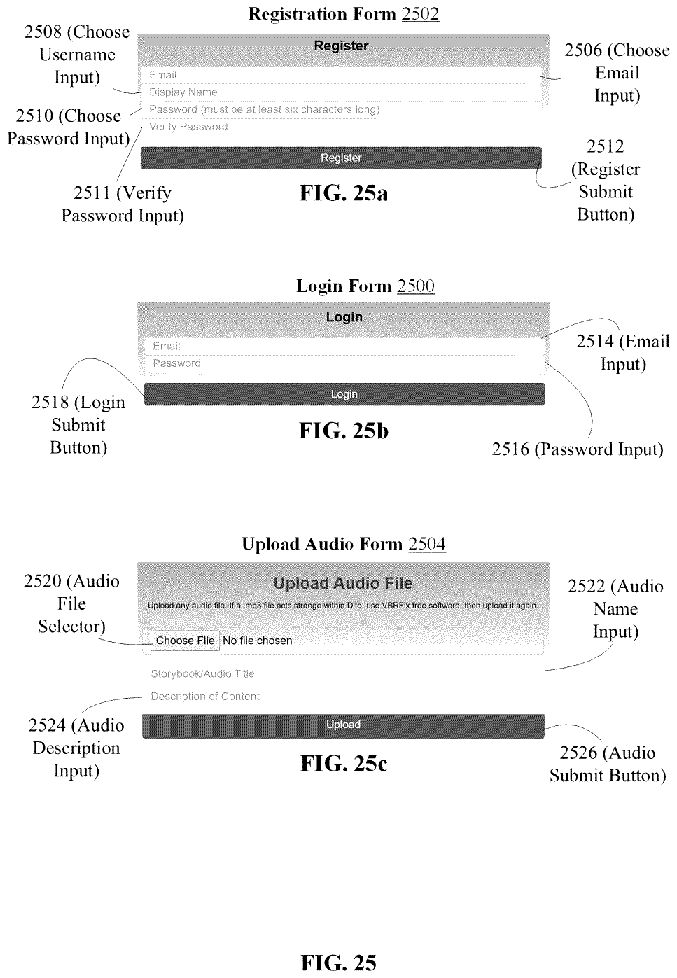

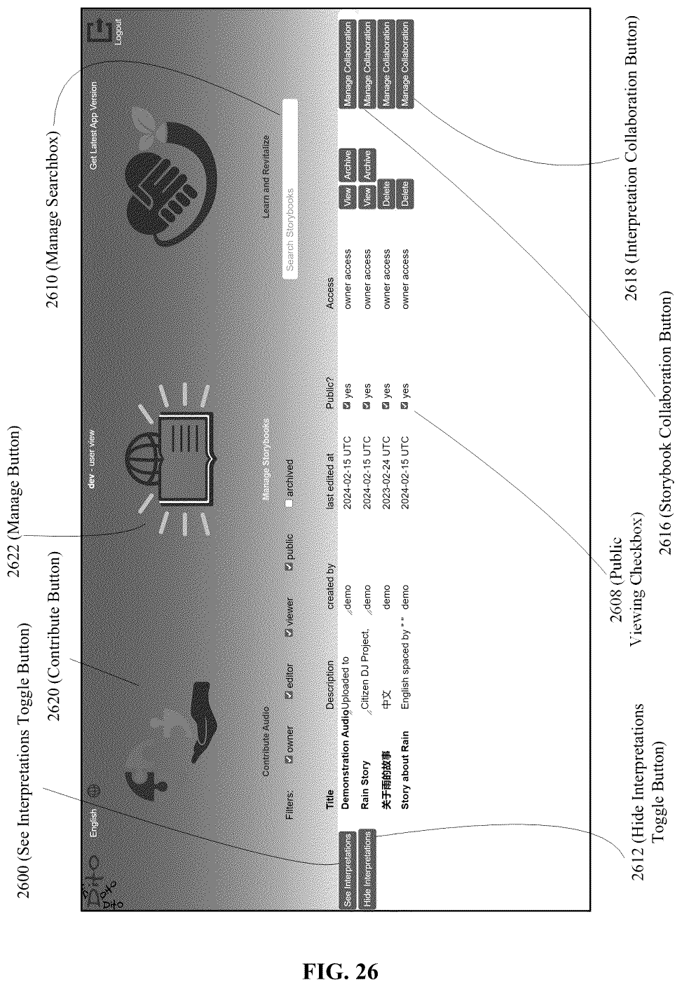

FIGS. 25a-25c shows views of Registration Form 2502, Login Form 2500, and Upload Audio Form 2504 in FIG. 25a, FIG. 25b, and FIG. 25c, respectively. The three forms are forms that the preferred embodiment of the present disclosure can display in the Browser-Based Interface 102, and through which it can accept user input. Login Form 2500 and Registration Form 2502 are displayed by the preferred embodiment when a logged-out user 110 clicks the Login Button 308. By typing an email address into Choose Email Input 2504 textbox, a new username of choice into Choose Username Input 2508 textbox, a password of choice into the Choose Password Input 2510, and the same password of choice into the Verify Password Input 2511 textbox, then clicking Register Submit Button 2512 with a pointer, a user 110 can cause the preferred embodiment of the present disclosure to deposit data into Database for Storing User Authentication Data 104. At any later time, using Login Form 2500, a logged-out user 110 may, by entering the same email address and password into Email Input 2514 and Password Input 2516 and then clicking Login Submit Button 2518, log into the preferred embodiment of the present disclosure. After logging in, the user 110 will see a view containing Contribute Button 2620 (as shown in FIG. 26) and, by clicking Contribute Button 2620, will be presented with Upload Audio Form 2504 by the preferred embodiment. By using Audio File Selector 2520 to select an audio file on the computer that is displaying Browser-Based Interface 102, typing an Audio Title 706 for the audio data contained in the selected audio file into Audio Name Input 2522 textbox, typing an Audio Description 708 for the audio data contained in the selected audio file into Audio Description Input 2524 textbox, and then clicking Audio Submit Button 2526 using a pointer, the logged-in user 110 can cause the preferred embodiment to send user input 200 to database 106 and database 108 as shown in more detail in FIG. 2.

FIG. 26 is a view of the Browser-Based Interface 102 as seen by a logged-in user 110 who has clicked Manage Button 2622 with a pointer, causing the preferred embodiment of the present disclosure to display information about the different sets of audio data 204 and some corresponding interpretations (time-aligned metadata) that the user 110 has access to. The user can interact with this view of the Browser-Based Interface 102 to search through the metadata by typing a text string into Manage Searchbox 2610 and pressing Enter on a keyboard that is attached to the computer displaying the Browser-Based Interface 102; this will cause the preferred embodiment to only display information about sets of audio data that have associated (based on corresponding Audio ID 704, Creating User ID 710, User ID 742, Associated Audio ID 716, Interpretation ID 714, and/or Associated Interpretation ID 728 values) metadata in Audio Metadata Table 702, Interpretation Metadata Table 712, Language Token Data Table 726, or User Data Table 740 that contains the text string. Users 110 can use Manage Searchbox 2610 to search for particular audio data 204 or time-aligned metadata; additionally, since some users 110 will make audio data 204 or time-aligned metadata that they create public using Public Viewing Checkboxes 2608, users 110 can use Manage Searchbox 2610 to explore what other users 110 have created.

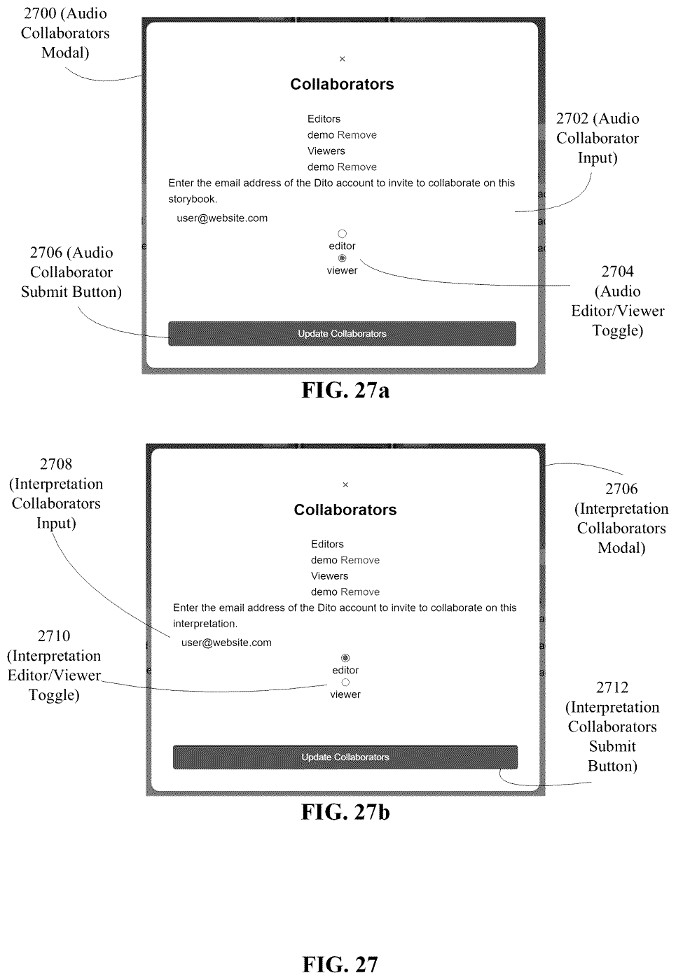

Clicking See Interpretations Toggle Button 2600 beside a row of information about a set of audio 204 will cause the preferred embodiment of the present disclosure to further display information about the sets of metadata (interpretations) associated with the set of audio 204, and it will cause See Interpretations Toggle Button 2600 to be replaced by Hide Interpretations Toggle Button 2612, which the user 110 can click to cause the preferred embodiment to stop displaying information about the sets of metadata associated with the set of audio 204. Sets of audio data 204 and sets of metadata each can be made public by the user 110 clicking on their corresponding Public Viewing Checkbox 2608 boxes in the Browser-Based Interface 102 to toggle them until the text “yes” appears beside them; this lets anybody with access to the Internet interact with them. While the text still says “no”, only the user 110 who created them, and any other user 110 that the first user 110 granted access to, will be able to interact with them. Furthermore, information about a set of audio data 204 has a Storybook Collaboration Button 2616 displayed beside it, and information about a set of metadata has an Interpretation Collaboration Button 2618 displayed beside it. Clicking Storybook Collaboration Button 2616 will open Audio Collaborators Modal 2700 in the Browser-Based Interface 102 (as pictured in FIG. 27a), and clicking Interpretation Collaboration Button 2618 will open Interpretation Collaborators Modal 2706 in the Browser-Based Interface 102.

FIG. 27a is a view of Audio Collaborators Modal 2700 as displayed in the Browser-Based Interface 102 to a user 110. By entering an email address into the Audio Collaborator Input 2702 textbox and selecting “editor” or “viewer” in Audio Editor/Viewer Toggle 2704, then clicking Audio Collaborator Submit Button 2706, a logged-in user 110 can allow another user 110 that logs in with the submitted email address to also interact with the set of audio data that is correlated with the Storybook Collaboration Button 2616 that the first user 110 clicked to cause Audio Collaborators Modal 2700 to display in the Browser-Based Interface 102.

FIG. 27b is a view of Interpretation Collaborators Modal 2706 as displayed in the Browser-Based Interface 102 to a user 110. By entering an email address into the Interpretation Collaborators Input 2708 textbox and selecting “editor” or “viewer” in Interpretation Editor/Viewer Toggle 2710, then clicking Interpretation Collaborators Submit Button 2712, a logged-in user 110 can allow another user 110 that logs in with the submitted email address to also interact with the set of metadata that is correlated with the Interpretation Collaboration Button 2618 that the first user 110 clicked to cause Interpretation Collaborators Modal 2706 to display in the Browser-Based Interface 102.

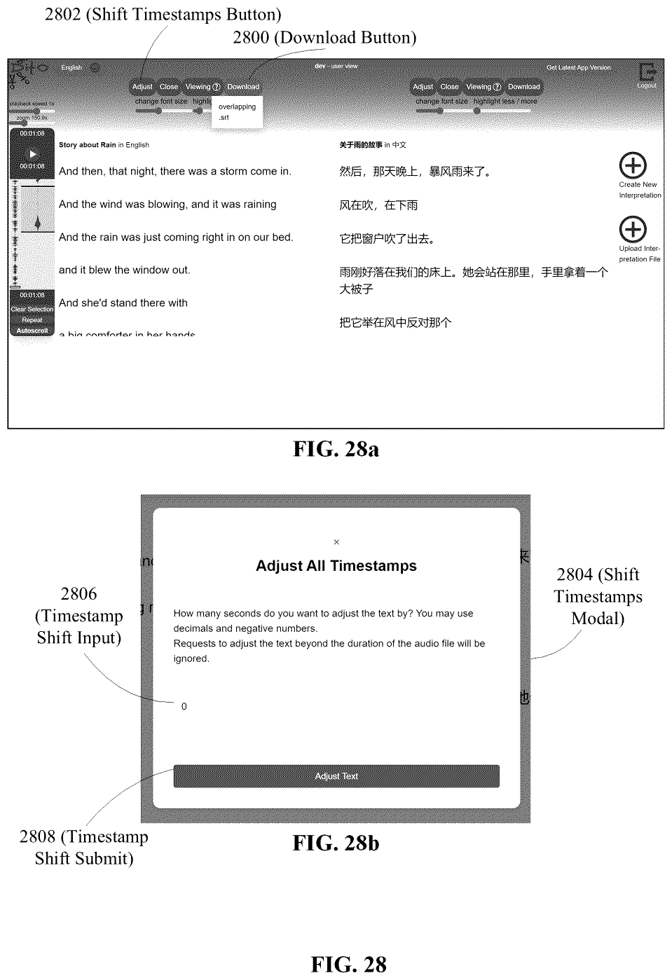

FIG. 28a is a view of Browser-Based Interface 102 as displayed to a user 110 showing two Consoles 800, each in Viewing mode. A user 110 that has access to and clicks Download Button 2800 with a pointer will have the option to download time-aligned metadata from the corresponding Console 800 as an SRT File 3400; this assists with collaboration between users 110 by allowing them to download time-aligned metadata from the preferred embodiment of the present disclosure to share with other users 110 or use outside of the system. Only logged-in users 110 whose User ID 742 matches the Creating User ID 724 of the metadata displayed in a Console 800 in Viewing mode have access to the Download Button 2800 in that Console 800. Downloaded time-aligned metadata will be Language Segments 1918 and their associated Larger Timestamp Ranges 1922; therefore, if a user 110 clicks and drags the Highlight Less/More Slider 2102 with a pointer, causing the Language Segments 1918 created by the preferred embodiment of the present disclosure to change, then the Language Segments 1918 and their associated Larger Timestamp Ranges 1922 available for download in an SRT File 3400 will also change, becoming, on average, longer or shorter.

FIG. 28a also shows Shift Timestamps Button 2802; any logged-in user 110 with editing access to time-aligned metadata being displayed in a Console 800 in Viewing mode can see this button in the corresponding Console 800. Clicking Shift Timestamps Button 2802 causes Shift Timestamps Modal 2804 to be shown to the user 110 in the Browser-Based Interface 102. The user 110 can enter a number of seconds—which can be a positive number, decimal number, or negative number—into Timestamp Shift Input 2806 and then click Timestamp Shift Submit 2808 to cause the timestamp ranges associated with all the language tokens in the set of time-aligned metadata corresponding to which the Shift Timestamps Button 2802 was clicked to shift forward in time by that number of seconds. If audio data 204 has been clipped, this feature is useful for correspondingly adjusting the timestamps of its time-aligned metadata.

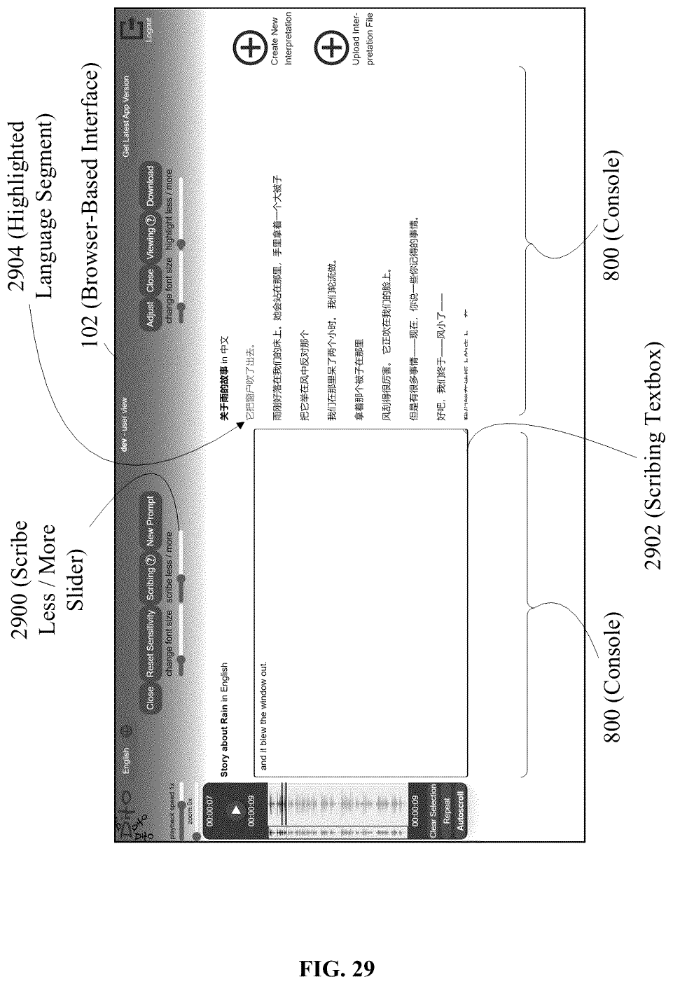

FIG. 29 is a view of the Browser-Based Interface 102 of the preferred embodiment of the present disclosure as seen by a logged-in user 110 viewing two Consoles 800, the left-most Console 800 being in Scribing mode and the right-most Console 800 being in Viewing mode. When a Console 800 is in Scribing mode, a user 110 can enter any text string into Scribing Textbox 2902, then press Enter on a keyboard attached to the computer displaying the Browser-Based Interface 102 to cause the text string to be split into language tokens deposited as Text Strings (of tokens' characters) 730 into Language Token Data Table 726 in database 108. The Text Strings (of tokens' characters) 730 will each be associated with an Associated Interpretation ID 728 clarifying the set of time-aligned metadata they belong to, a Reading Index (position in the sequence) 732 clarifying their positions in the reading sequence of the time-aligned metadata, a Beginning Timestamp 734 value and Ending Timestamp 736 value corresponding, respectively, to the values that were in Beginning Timestamp Box 1504 and Ending Timestamp Box 1508 when the user pressed Enter on the keyboard, and Creating User ID 738 identifying the logged-in user 110. Only one Console 800 can be set to Scribing view at a time; furthermore, the Browser-Based Interface 102 cannot simultaneously display a Console 800 in Scribing view and a Console 800 in Studying view. These constraints prevent interference between any Consoles 800 that might otherwise try to generate conflicting Selected Audio Regions 1406 within Audio Player 408.

When the user 110 presses Enter on the keyboard attached to the computer displaying the Browser-Based Interface 102, the text string in Scribing Textbox will disappear (in addition to being processed and deposited in database 108); the Selected Audio Region 1406 will disappear; a new, different Selected Audio Region 1406 will appear in its place; and audio data 204 corresponding to the new Selected Audio Region 1406 will begin to play through a speaker attached to the computer displaying the Browser-Based Interface 102. The user 110 may then type a text string corresponding to the audio data they hear into Scribing Textbox 2902 and press Enter again. This is a method of creating new time-aligned data corresponding to a set of audio data.

If the user 110 clicks and drags the Scribe Less/More Slider 2900 to the left, the preferred embodiment of the present disclosure will choose relatively shorter sections of audio data 204 to play for the user 110; clicking and dragging the Scribe Less/More Slider 2900 to the right causes the preferred embodiment to choose relatively longer sections of audio data 204. The preferred embodiment chooses a region of audio data 204 to play based on both an approximate length—controlled by the Scribe Less/More Slider 2900—and a detection of silence on both ends of the region. This function allows the user 110 to customize the length of phrase (and, correspondingly, the length of Selected Audio Regions 1406) for which they will write and submit text strings into Scribing Textbox 2902 for the preferred embodiment to then split and deposit as language tokens into Language Token Data Table 726.

FIGS. 28a and 28b further illustrates how the preferred embodiment of the present disclosure's method of processing and using one version of time-aligned metadata can help a user 110 create a different version of time-aligned metadata. The preferred embodiment will display a Highlighted Language Segment 2904 in the right-most Console 800 in Viewing mode whenever a Language Segment 1918's corresponding audio data 204 is played in Audio Player 408, and the Highlighted Language Segment 2904 can provide helpful contextual information to a user 110 about the currently playing audio data 204 as they try to figure out what text string to type into Scribing Textbox 2902 to correspond to it. Furthermore, the user 110 can click on a Language Segment 1918 in the right-most Console 800 in Viewing mode to cause the preferred embodiment to play a Selected Audio Region 1406 that corresponds to it. If the user 110 then submits a text string through Scribing Textbox 2902, the language tokens of the text string will be associated with the same Selected Audio Region 1406 via their Beginning Timestamp 734 and Ending Timestamp 736 values. Using this method of selecting portions of the audio data 204 to interact with, a user 110 can reuse existing segmentations of the audio data 204 from other versions of time-aligned metadata and create exactly corresponding Language Segments 1918 between the two versions. Though the preferred embodiment of the present disclosure never requires a user 110 to use this method, using it can save time for users 110 and creates a useful set of exactly paired Language Segments 1918 for two (or more) versions of time-aligned metadata.

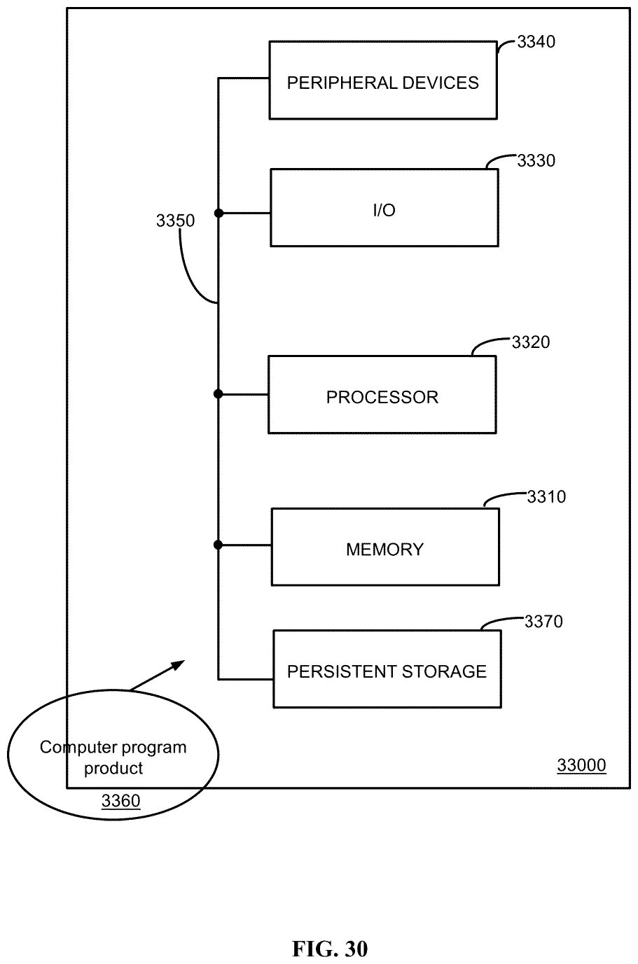

FIG. 30 shows an example of a computer system 33000, one or more of which may be used to implement one or more of the apparatuses, systems, and methods illustrated herein. Computer system 33000 executes instruction code contained in a computer program product 3360. Computer program product 3360 comprises executable code in an electronically readable medium that may instruct one or more computers such as computer system 33000 to perform processing that accomplishes the exemplary method steps performed.

The electronically readable medium may be any transitory or non-transitory medium that stores information electronically and may be accessed locally or remotely, for example via a network connection. The medium may include a plurality of geographically dispersed media each configured to store different parts of the executable code at different locations and/or at different times. The executable instruction code in an electronically readable medium directs the illustrated computer system 33000 to carry out various exemplary tasks described herein. The executable code for directing the carrying out of tasks described herein would be typically realized in software. However, it will be appreciated by those skilled in the art, that computers or other electronic devices might utilize code realized in hardware to perform many or all the identified tasks. Those skilled in the art will understand that many variations on executable code may be found that implement exemplary methods within the spirit and the scope of the disclosure.

The code or a copy of the code contained in computer program product 3360 may reside in one or more storage persistent media (not separately shown) communicatively coupled to system 33000 for loading and storage in persistent storage device 3370 and/or memory 3310 for execution by processor 3320. Computer system 3300 also includes I/O subsystem 3330 and peripheral devices 3340. I/O subsystem 3330, peripheral devices 3340, processor 3320, memory 3310, and persistent storage device 3370 are coupled via bus 3350. Like persistent storage device 3370 and any other persistent storage that might contain computer program product 3360, memory 3310 is a non-transitory media (even if implemented as a typical volatile computer memory device). Moreover, those skilled in the art will appreciate that in addition to storing computer program product 3360 for carrying out processing described herein, memory 3310 and/or persistent storage device 3370 may be configured to store the various data elements referenced and illustrated herein.

Those skilled in the art will appreciate computer system 33000 illustrates just one example of a system in which a computer program product in accordance with the disclosure may be implemented. To cite but one example, execution of instructions contained in a computer program product may be distributed over multiple computers, such as, for example, over the computers of a distributed computing network.

Instructions for implementing embodiments of the present disclosure may reside in computer program product 3360. When processor 3320 is executing the instructions of computer program product 3360, the instructions, or a portion thereof, are typically loaded into working memory 3310 from which the instructions are readily accessed by processor 3320.

Processor 3320 may comprise multiple processors which may comprise respective additional working memories (additional processors and memories not individually illustrated) including one or more graphics processing units (GPUs) comprising at least thousands of arithmetic logic units supporting parallel computations on a large scale. GPUs are often utilized in deep learning applications because they can perform the relevant processing tasks more efficiently than typical general-purpose processors (CPUs). Processor 3320 may additionally or alternatively comprise one or more specialized processing units comprising systolic arrays and/or other hardware arrangements that support efficient parallel processing. Such specialized hardware may work in conjunction with a CPU and/or GPU to carry out the various processing described herein. Such specialized hardware may comprise application specific integrated circuits and the like (which may refer to a portion of an integrated circuit that is application-specific), field programmable gate arrays and the like, or combinations thereof. However, a processor such as processor 3320 may be implemented as one or more general purpose processors (preferably having multiple cores) without necessarily departing from the spirit and scope of the present disclosure.

The preferred embodiment of the present disclosure uses audio data as a basis for associating timestamp ranges with language tokens in written interpretations of that audio data. Other embodiments of the present disclosure might use written data or other types of data as a basis for associating value ranges with language tokens in written interpretations of that data. Still other embodiments of the present disclosure might use audible language tokens and use median timestamp values in place of the “reading index” described above (which was used for storing information about how language tokens would be arranged in sequence). Some examples of language tokens that may be used by embodiments of the present disclosure include characters, strings of characters, or audio clips. The present disclosure is not limited in application to particular formats of language data and metadata.

### Additional Embodiments

Embodiment 1. A system that, given two versions of audible and/or written language containing corresponding information, then given any subset of one of the two versions, identifies the smallest subset of the other version that contains the corresponding information to the given subset of the first version even when either or both of the version subsets is/are not contiguous.

Embodiment 2. The system of embodiment 1 in which different subsets overlap with one another in either one or both language versions.

Embodiment 3. A system that, given two versions of audible and/or written language containing corresponding information, then given any subset of one of the two versions, identifies the smallest subset of the other version that contains the corresponding information to the given subset of the first version even when the subsets given for one version are represented in the language in a different sequence from the subsets identified in the other version.

Embodiment 4. The system of embodiment 3 in which different subsets overlap with one another in either one or both language versions.

Embodiment 5. A system that, given two versions of audible and/or written language containing corresponding information, generates a set of paired language segments—each pair comprising one language segment from each language version—that correspond to one another in whole or in part.

Embodiment 6. The system of embodiment 5 wherein one or more language segments is nested within one or more other language segments in the language version it was sourced from.

Embodiment 7. The system of embodiment 5 wherein one or more language segments overlaps with one or more other language segments in the language version it was sourced from.

Embodiment 8. A system that, given two versions of audible and/or written language containing corresponding information, generates groups of language segments—each group comprising one language segment from one language version and at least one language segment from the other language version—within which the language segment from the first version corresponds to the language segment(s) from the other version in whole or in part, or the language segment(s) from the other version correspond to the language segment from the first version in whole or in part.

Embodiment 9. The system of embodiment 8 wherein one or more language segments is nested within one or more other language segments in the language version it was sourced from.

Embodiment 10. The system of embodiment 8 wherein one or more language segments overlaps with one or more other language segments in the language version it was sourced from.

Embodiment 11. A system that teaches people about two language versions' corresponding language segments in the context of recursively longer corresponding language segments.

Embodiment 12. The system of embodiment 11 wherein the upper limit of language segment lengths are the lengths of the language versions.

Embodiment 13. A system that teaches machines about two language versions' corresponding language segments in the context of recursively longer corresponding language segments.

Embodiment 14. The system of embodiment 13 wherein the upper limit of language segment lengths are the lengths of the language versions.

Embodiment 15. A system for assigning timestamp ranges associated with language tokens in a fixed sequence of language tokens.

Embodiment 16. The system of embodiment 15 wherein the timestamp ranges do not necessarily increase in order from one language token to the next in the fixed sequence.

Embodiment 17. The system of embodiment 16 wherein the assigning of the timestamp ranges associated with the language tokens does not alter the fixed sequence of the language tokens.

Embodiment 18. A system for revising timestamp ranges associated with language tokens in a fixed sequence of language tokens.

Embodiment 19. The system of embodiment 18 wherein the timestamp ranges do not necessarily increase in order from one language token to the next in the fixed sequence.

Embodiment 20. The system of embodiment 19 wherein the revising of the timestamp ranges associated with the language tokens does not alter the fixed sequence of the language tokens.

Embodiment 21. A system for assigning and revising timestamp ranges associated with language tokens in a fixed sequence of language tokens.

Embodiment 22. The system of embodiment 21 wherein the timestamp ranges do not necessarily increase in order from one language token to the next in the fixed sequence.

Embodiment 23. The system of embodiment 22 wherein the assigning and revising of the timestamp ranges associated with the language tokens does not alter the fixed sequence of the language tokens.

Embodiment 24. A system that displays more than two written language versions side-by-side, wherein the user chooses which written versions to view and in what order to view them.

Embodiment 25. A system that displays more than three written language versions side-by-side, wherein the user chooses which written versions to view and in what order to view them.

Embodiment 26. A system that stores and displays portfolios and/or items in portfolios of time-aligned metadata (including but not limited to transcriptions and translations) along with the audio data described or referenced by that metadata.

Embodiment 27. The system of embodiment 26 wherein whatever portions of the time-aligned metadata correspond to whatever portion of the audio data is currently being played or is paused are highlighted, displayed at a specified vertical or horizontal location on the screen, displayed alone, or otherwise drawn attention to.

Embodiment 28. The system of embodiment 27 wherein a setting that can be changed by the user influences how little or how much of the time-aligned metadata is highlighted, displayed at a specified vertical or horizontal location on the screen, displayed alone, or otherwise drawn attention to at any one time.

Embodiment 29. A system that enables users to create, store, and display in one or more portfolios time-aligned metadata (including but not limited to transcriptions and translations) as well as the audio data that is referenced by the metadata.

Embodiment 30. The system of embodiment 29 wherein whatever portions of the time-aligned metadata correspond to whatever portion of the audio data is currently being played or is paused are highlighted, displayed at a specified vertical or horizontal location on the screen, displayed alone, or otherwise drawn attention to.

Embodiment 31. The system of embodiment 30 wherein a setting that can be changed by the user influences how little or how much of the time-aligned metadata is highlighted, displayed at a specified vertical or horizontal location on the screen, displayed alone, or otherwise drawn attention to at any one time.

Embodiment 32. A system that simultaneously highlights different language segments (contiguous strings of language tokens optionally separated by a delimiter) that are nested one inside another, wherein the highlights use colors that correspond to how deeply each segment is nested, and wherein the decisions about which language segments to highlight—and when, and in what colors—are based at least on information about two different orders with which the language tokens could be arranged.

Embodiment 33. The system of embodiment 32 wherein the decision about which phrases to highlight is also based on a given timestamp.

Embodiment 34. The system of embodiment 32 wherein it is applied to multiple written language versions at the same time.

Embodiment 35. A system storing one or more sequences of language tokens, wherein each language token may be associated with a value or value range, yet a user can reorder the sequence or sequences of language tokens without changing the values or value ranges associated with those language tokens.

Embodiment 36. A system storing one or more sequences of language tokens, wherein each language token may be associated with a timestamp or timestamp range, yet a user can reorder the sequence or sequences of language tokens without changing the timestamp or timestamp ranges associated with those language tokens.

Embodiment 37. A system that identifies language segments to present to the user based on how well those language segments correspond to a given length of time (e.g. 3 seconds, 10 seconds, 1.5 minutes).

Embodiment 38. A method of processing language data and/or metadata that uses at least the position of each language token in a sequence of language tokens, an associated numerical value for each language token, and a constant number to identify language segments within the language data and/or metadata, the method comprising:
i) creating an ordered list of language tokens (some examples of language tokens that could be used are characters, strings of characters, and audio clips)—in which the list is ordered by the numerical value associated with each language token—then splitting the list over and over, with each split occurring wherever there is the largest difference (or at one instance thereof in cases in which multiple locations all qualify as having the largest difference) between the associated numerical values of neighboring language tokens in the same sequence or subsequence of the list
ii) stopping the splitting of each sequence or subsequence of the list when a function involving the constant and the difference between the smallest numerical value associated with a token in the sequence or subsequence and the largest numerical value associated with a token in the same sequence or subsequence evaluates to be true (or false, depending on how the function is written); examples of such functions include, but are not limited to, the difference is less than the constant, the difference equals the constant, the difference is less than or equal to the constant, the constant is greater than the difference, the constant equals the difference, and the constant is greater than or equal to the difference
iii) for each sequence or subsequence of the list that remains after all splitting has stopped, identifying a first language token and a last language token (based on the language tokens' positions in the original sequence of language tokens, not based on their associated numerical values), then stringing those two tokens together—optionally using one or more delimiters between them—with all of the language tokens that came between them in the original sequence of language tokens and adhering to the original sequence of language tokens while doing so, next identifying the resulting string as a language segment, and finally optionally associating that language segment with a numerical range inclusive of the numerical values that were associated with each of the language tokens that were strung together
iv) optionally combining together any language segments (and their associated numerical ranges) that overlap with one another—but which are not perfectly nested one within another—based on the original sequence of language tokens

Embodiment 39. A method of processing language data and/or metadata that uses at least the position of each language token in a sequence of language tokens, a numerical value calculated (for example, by taking the median of a range) for each language token, and a constant number to identify language segments within the language data and/or metadata, the method comprising:
i) creating an ordered list of language tokens (some examples of language tokens that could be used are characters, strings of characters, and audio clips)—in which the list is ordered by the numerical value calculated for each language token—then splitting the list over and over, with each split occurring wherever there is the largest difference (or at one instance thereof in cases in which multiple locations all qualify as having the largest difference) between the numerical values calculated for neighboring language tokens in the same sequence or subsequence of the list
ii) stopping the splitting of each sequence or subsequence of the list when a function involving the constant and the difference between the smallest numerical value calculated for a token in the sequence or subsequence and the largest numerical value calculated for a token in the same sequence or subsequence evaluates to be true (or false, depending on how the function is written); examples of such functions include, but are not limited to, the difference is less than the constant, the difference equals the constant, the difference is less than or equal to the constant, the constant is greater than the difference, the constant equals the difference, and the constant is greater than or equal to the difference
iii) for each sequence or subsequence of the list that remains after all splitting has stopped, identifying a first language token and a last language token (based on the language tokens' positions in the original sequence of language tokens, not based on their calculated numerical values), then stringing those two tokens together—optionally using one or more delimiters between them—with all of the language tokens that came between them in the original sequence of language tokens and adhering to the original sequence of language tokens while doing so, next identifying the resulting string as a language segment, and finally optionally associating that language segment with a range inclusive of all values that were used to calculate the numerical value for each of the language tokens that were strung together
iv) optionally combining together any language segments (and their associated ranges) that overlap with one another—but which are not perfectly nested one within another—based on the original sequence of language tokens

Embodiment 40. The method of embodiment 38 wherein the numerical value associated with each language token is a timestamp.

Embodiment 41. The method of embodiment 39 wherein the values used to calculate the numerical value associated with each language token are timestamps.

Embodiment 42. A system that creates a language-learning activity based on audio data and some timestamped metadata associated with the audio data such as (but not limited to) a transcription, translation, interpretation, description, or rerecording of the audio.

Embodiment 43. A system that creates multiple language-learning activities based on audio data and some timestamped metadata associated with the audio data such as (but not limited to) a transcription, translation, interpretation, description, or rerecording of the file.

Embodiment 44. A method of editing language metadata as continuous text wherein each language token in the metadata may be already associated with data properties in storage and those data properties associated with each language token (except for the data property identifying the language token's position in the sequence of language tokens that comprise the continuous text) need not change even if the sequence of language tokens in the continuous text/metadata is changed during the editing process, the method comprising
storing information about the original language metadata; presenting the original language metadata to the user (a machine, person, group of either or both, or another entity) as a continuous text in editable form; allowing the user to edit the text; storing information about the new (edited) version of the language metadata; comparing the sequence of language tokens in the original language metadata to the sequence of language tokens in the new (edited) language metadata using a difference algorithm to determine which language tokens have been added, moved, deleted, and/or displaced in the sequence of language tokens by the user; and using the results of the difference algorithm to effect the replacement of the original language metadata being stored with the new (edited) language metadata by removing language tokens from storage if they were deleted by the user, adding language tokens to storage if they were inserted by the user (but not moved from another location in the continuous text), and—for language tokens that were moved or displaced by the user—updating the data property that contains information about each language token's location in the sequence of language tokens that comprise the continuous text.

Embodiment 45. A method of editing the value ranges associated with language tokens wherein the sequence of the language tokens in the data or metadata is unaffected by any changes to the value ranges associated with them, the method comprising
specifying, or letting a user specify, beginning and ending values of a value range; specifying, or letting a user specify, a set of language tokens by their “reading index” values; and updating data properties of those language tokens in the database (identified based on their reading index values) with information that describes, or can be used to deduce, the beginning and ending values of the specified value range.

Embodiment 46. A method of editing the timestamp ranges associated with language tokens wherein the sequence of the language tokens in the data or metadata is unaffected by any changes to the timestamp ranges associated with them, the method comprising
specifying, or letting a user specify, beginning and ending values of a timestamp range; specifying, or letting a user specify, a set of language tokens by their “reading index” values; and updating data properties of those language tokens in the database (identified based on their reading index values) with information that describes, or can be used to deduce, the beginning and ending values of the specified timestamp range.

Embodiment 47. The system of embodiment 26 wherein the time-aligned metadata in the system can be searched with text strings by users.

Embodiment 48. The system of embodiment 27 wherein the time-aligned metadata in the system can be searched with text strings by users.

Embodiment 49. The system of embodiment 28 wherein the time-aligned metadata in the system can be searched with text strings by users.

Embodiment 50. The system of embodiment 29 wherein the time-aligned metadata in the system can be searched with text strings by users.

Embodiment 51. A method of using one or more computers to process two or more versions of language data containing corresponding information, the method comprising using the one or more computers to execute processing comprising:
selecting one or more subsets of a first version of the language data, and,
for each selected subset of the first version of the language data, the selected subset of the first version containing information,
identifying a smallest subset, if any, of each of one or more other versions of the language data, the smallest subset containing information corresponding to the information contained in the selected subset of the first version.

Embodiment 52. The method of embodiment 51 wherein subsets of a first version of the language data can be null sets.

Embodiment 53. The method of embodiment 51 wherein, if a smallest subset is not identified, it can be substituted by a null set.

Embodiment 54. The method of embodiment 51 wherein language tokens containing language information in the first version of the language data each can have an associated numerical range that corresponds to a segment of a primary other version of the language data, the segment of the primary other version containing information that corresponds to the language information contained in the language token.

Embodiment 55. The method of embodiment 54 wherein identifying a smallest subset of the primary other version of the language data comprises:
creating a set of the associated numerical ranges of language tokens in the selected subset of the first version of the language data;
creating an updated set of the associated numerical ranges by merging at their intersections, without duplication, any associated numerical ranges that overlap within the set; and
determining which subset of the primary other version of the language data corresponds to the numerical ranges in the updated set.

Embodiment 56. The method of embodiment 54 wherein identifying a smallest subset of the primary other version of the language data comprises:
creating a set of the associated numerical ranges of language tokens in the selected subset of the first version of the language data;
determining the minimum range of numerical values that includes all numerical ranges in the set; and
determining which subset of the primary other version of the language data corresponds to the minimum range of numerical values.

Embodiment 57. The method of embodiment 54 wherein
the primary other version of the language data is an audible version of the language data,
the associated numerical ranges are ranges of timestamps that correspond to positions in the primary other version of the language data, and
the segments of the primary other version of the language data are contiguous sections of audio data.

Embodiment 58. The method of embodiment 54 wherein
the primary other version of the language data is a written version of the language data and comprises a primary sequence of language tokens,
the associated numerical ranges are ranges of positions of language tokens in the primary sequence of language tokens, and
the segments of the primary other version of the language data are subsequences of language tokens in the primary sequence of language tokens.

Embodiment 59. The method of embodiment 51 further comprising displaying some or all of the smallest subsets of the one or more other versions of the language data in a graphical user interface (GUI) of the one or more computers.

Embodiment 60. The method of embodiment 51 further comprising indicating some or all of the smallest subsets of the one or more other versions of the language data in a graphical user interface (GUI) of the one or more computers.

Embodiment 61. The method of embodiment 51 further comprising playing some or all of the smallest subsets of the one or more other versions of the language data through at least one speaker attached to the one or more computers.

Embodiment 62. The method of embodiment 55 or 56 wherein
segments of nonprimary other versions of the language data each contain secondary information and can have an associated secondary numerical range, wherein
the associated secondary numerical range corresponds to a primary version segment containing information that corresponds to the secondary information.

Embodiment 63. The method of embodiment 62 wherein identifying a smallest subset of each of any nonprimary other versions of the language data comprises, for each of the any nonprimary other versions of the language data, determining which least subset of segments of the nonprimary other version has associated secondary numerical ranges that include the numerical ranges in the updated set described in embodiment 55.

Embodiment 64. The method of embodiment 62 wherein identifying a smallest subset of each of any nonprimary other versions of the language data comprises, for each of the any nonprimary other versions of the language data, determining which least subset of segments of the nonprimary other version has associated secondary numerical ranges that include the minimum range of numerical values described in embodiment 56.

Embodiment 65. The method of embodiment 54 wherein the first version of the language data is a written version of the language data that comprises a sequence of language tokens, wherein each language token is a string of one or more characters.

Embodiment 66. The method of embodiment 54 wherein the first version of the language data is an audible version of the language data, and each language token in the first version is a mutually exclusive and continuous segment of the first version that can be referred to by a timestamp range.

Embodiment 67. The method of embodiment 51 wherein user input accepted through a graphical user interface (GUI) of the one or more computers influences which subsets of the first version of the language data are selected.

Embodiment 68. The method of embodiment 51 further comprising creating a set of groups, wherein each group comprises one selected subset of the first version and one smallest subset of each of the one or more other versions of the language data, each smallest subset containing information corresponding to information contained in the selected subset of the first version.

Embodiment 69. The method of embodiment 68 further comprising displaying some or all of the set of groups in a graphical user interface (GUI) of the one or more computers.

Embodiment 70. The method of embodiment 68 further comprising playing some or all of the set of groups through at least one speaker attached to the one or more computers.

Embodiment 71. The method of embodiment 68 further comprising, for some or all groups within the set of groups, displaying written elements from the groups in a graphical user interface (GUI) of the one or more computers and playing audible elements in the groups through at least one speaker attached to the one or more computers.

Embodiment 72. The method of embodiment 68 further comprising creating an ordered list of groups by ordering the set of groups according to a size of each group's smallest subset of a same other version of the language data.

Embodiment 73. The method of embodiment 72 further comprising, sequentially in order of the ordered list of groups, displaying written elements of each group in a graphical user interface (GUI) of the one or more computers.

Embodiment 74. The method of embodiment 72 further comprising, sequentially for groups within the ordered list of groups, indicating written elements in the group in a graphical user interface (GUI) of the one or more computers.

Embodiment 75. The method of embodiment 72 further comprising, sequentially for groups within the ordered list of groups, playing audible elements in each group through at least one speaker attached to the one or more computers.

Embodiment 76. The method of embodiment 68 further comprising highlighting some or all of the set of groups in a graphical user interface (GUI) of the one or more computers.

Embodiment 77. The method of embodiment 68 further comprising, for each of some or all groups within the set of groups, indicating written elements in the group in a graphical user interface (GUI) of the one or more computers while playing audible elements in the group through at least one speaker attached to the one or more computers.

Embodiment 78. The method of embodiment 73, 74, or 75 wherein some groups within the ordered list of groups are skipped.

Embodiment 79. The method of embodiment 73, 74, or 75 wherein no groups within the ordered list of groups are skipped.

Embodiment 80. The method of embodiment 51 further comprising subsets and smallest subsets being displayed in areas of a graphical user interface (GUI) of the one or more computers that are each dedicated to respective versions of language data.

Embodiment 81. The method of embodiment 80 further comprising accepting user input through the GUI that defines which areas of the GUI are dedicated to which respective versions of language data.

Embodiment 82. The method of embodiment 51 wherein the first version of the language data and at least one of the one or more other versions of the language data are in the same language.

Embodiment 83. The method of embodiment 51 wherein the first version of the language data and at least one of the one or more other versions of the language data are in different languages.

Embodiment 84. The method of embodiment 51 wherein, of the first version of the language data, one of the one or more other versions of the language data, and another one of the one or more other versions of the language data; two versions are in the same language and one version is in a different language.

Embodiment 85. The method of embodiment 51 wherein at least one selected subset of the first version is not internally contiguous.

Embodiment 86. The method of embodiment 51 wherein every selected subset of the first version is internally contiguous.

Embodiment 87. The method of embodiment 51 wherein at least one smallest subset of at least one of the one or more other versions of the language data is not internally contiguous.

Embodiment 88. The method of embodiment 51 wherein every smallest subset of each of the one or more other versions of the language data is internally contiguous.

Embodiment 89. The method of embodiment 51 wherein a largest subset of the first version of the language data is a whole first version of the language data.

Embodiment 90. The method of embodiment 51 wherein at least one of the selected subsets of the first version overlaps with another one of the selected subsets of the first version.

Embodiment 91. The method of embodiment 51 wherein none of the selected subsets of the first version overlap with one another.

Embodiment 92. The method of embodiment 51 wherein at least one of the smallest subsets overlaps with another one of the smallest subsets within a same other version of the language data.

Embodiment 93. The method of embodiment 51 wherein, for each other version of the language data, the smallest subsets are all mutually exclusive.

Embodiment 94. The method of embodiment 51 wherein at least one of the selected subsets of the first version is itself a subset of another of the selected subsets of the first version.

Embodiment 95. The method of embodiment 51 wherein none of the selected subsets of the first version are subsets of any other of the selected subsets of the first version.

Embodiment 96. The method of embodiment 51 wherein at least one of the smallest subsets of at least one other version of the language data is itself a subset of another of the smallest subsets of a same other version of the language data.

Embodiment 97. The method of embodiment 51 wherein, for each other version of the language data, none of the smallest subsets are subsets of any other of the smallest subsets.

Embodiment 98. The method of embodiment 51 wherein the two or more versions of language data include at least one transcription.

Embodiment 99. The method of embodiment 51 wherein the two or more versions of language data include at least one translation.

Embodiment 100. The method of embodiment 51 wherein the two or more versions of language data include at least one set of annotations.

Embodiment 101. The method of embodiment 51 wherein the two or more versions of language data include at least one interpretation.

Embodiment 102. The method of embodiment 51 wherein the two or more versions of language data include at least one set of subtitles.

Embodiment 103. The method of embodiment 51 wherein at least some of at least one of the two or more versions of language data is displayed through a graphical user interface (GUI) of the one or more computers as a component of a portfolio of language work.

Embodiment 104. The method of embodiment 51 wherein at least some of at least one of the two or more versions of language data is displayed through a graphical user interface (GUI) of the one or more computers as a component of a collection of research data.

Embodiment 105. The method of embodiment 51 wherein at least some of at least one of the two or more versions of language data is displayed through a graphical user interface (GUI) of the one or more computers as a component of an archive.

Embodiment 106. The method of embodiment 51 wherein at least some of at least one of the two or more versions of language data is displayed through a graphical user interface (GUI) of the one or more computers as a component of a linguistic portfolio.

Embodiment 107. The method of embodiment 51 wherein at least some of at least one of the two or more versions of language data is displayed through a graphical user interface (GUI) of the one or more computers as a component of a language lesson.

Embodiment 108. The method of embodiment 51 wherein at least some of at least one of the two or more versions of language data is displayed through a graphical user interface (GUI) of the one or more computers as a component of a language-learning activity.

Embodiment 109. The method of embodiment 51 wherein at least some of at least one of the two or more versions of language data is displayed through a graphical user interface (GUI) of the one or more computers as a component of homework.

Embodiment 110. The method of embodiment 51 wherein at least some of at least one of the two or more versions of language data is displayed through a graphical user interface (GUI) of the one or more computers as a component of lesson preparation.

Embodiment 111. The method of embodiment 51 wherein at least some of at least one of the two or more versions of language data is displayed through a graphical user interface (GUI) of the one or more computers as a component of a publication.

Embodiment 112. The system of embodiment 30 wherein the time-aligned metadata in the system can be searched with text strings by users.

Embodiment 113. The system of embodiment 31 wherein the time-aligned metadata in the system can be searched with text strings by users.

Embodiment 114. A method of using one or more computers to process a sequence of time-aligned tokens, the time-alignments of which do not necessarily increase in order of the sequence, into reading segments, some of which are nested within others, the method comprising using the one or more computers to execute processing comprising:
specifying an approximate time duration;
reordering the time-aligned tokens into a new sequence in order of its time-alignments;
splitting the new sequence into subsequences, each subsequence spanning a duration not more than the approximate time duration;
for each subsequence,
   identifying a first token and a last token according to original positions of tokens in the sequence of time-aligned data and
   creating a reading subsequence comprising all tokens in the sequence of time-aligned tokens from the first token to the last token;
merging together without duplication any overlapping reading subsequences that are not nested; and
stringing together each reading subsequence into a reading segment.

Embodiment 115. A method of using one or more computers to create a sequence of time-aligned tokens, the time-alignments of which do not necessarily increase in order of the sequence, the method comprising using the one or more computers to execute processing comprising:
displaying a sequence of tokens;
specifying designated tokens within the sequence of tokens;
accepting user input specifying a timestamp range;
assigning the timestamp range to the designated tokens within the sequence of tokens.

Embodiment 116. A method of using one or more computers to process a sequence of time-aligned tokens, the time-alignments of which do not necessarily increase in order of the sequence, into reading segments, the method comprising using the one or more computers to execute processing comprising:
specifying an approximate time duration;
reordering the time-aligned tokens into a new sequence in order of its time-alignments;
splitting the new sequence into subsequences, each subsequence spanning a duration not more than the approximate time duration;
for each subsequence,
   identifying a first token and a last token according to original positions of tokens in the sequence of time-aligned data and
   creating a reading subsequence comprising all tokens in the sequence of time-aligned tokens from the first token to the last token; and
stringing together each reading subsequence into a reading segment.

Embodiment 117. The method of embodiment 116 wherein user input accepted through a graphical user interface (GUI) of the one or more computers defines the approximate time duration.

Embodiment 118. The method of embodiment 116 further comprising displaying one or more of the reading segments to one or more users through a graphical user interface (GUI) of the one or more computers.

Embodiment 119. The method of embodiment 116 further comprising, before stringing any reading subsequence into a reading segment, merging together without duplication any overlapping reading subsequences that are not nested.

Embodiment 120. The method of embodiment 116 further comprising:
displaying the sequence of time-aligned tokens through a graphical user interface (GUI) of the one or more computers;
associating each reading segment with a timestamp range inclusive of the time-alignment of each time-aligned token it contains;
playing audio data corresponding to the sequence of time-aligned tokens through at least one speaker attached to the one or more computers;
tracking the current playing timestamp of said audio data; and
for each reading segment, whenever the current playing timestamp is within the reading segment's associated timestamp range,
highlighting a portion of the sequence of time-aligned tokens being displayed through the GUI, the portion corresponding to the reading segment.

Embodiment 121. The method of embodiment 120 wherein at least one reading segment is nested within another reading segment.

Embodiment 122. The method of embodiment 121 wherein an interior nested segment is highlighted in a different color than an exterior nested segment.

Embodiment 123. The method of embodiment 120 wherein the method is applied to different sequences of time-aligned data at the same time for a single playing audio data.

Embodiment 124. The method of embodiment 116 wherein the approximate time duration is specified based on user input accepted through a graphical user interface (GUI) of the one or more computers.

Embodiment 125. A method of using one or more computers to process audio data and a sequence of time-aligned tokens, the time-alignments of which do not necessarily increase in order of the sequence, into a list of pairs of language segments, the method comprising using the one or more computers to execute processing comprising:
specifying an approximate time duration;
identifying subsequences of the sequence of time-aligned tokens that match the approximate time duration as time-aligned subsequences; and
creating a list of pairs of one time-aligned subsequence and one corresponding audio clip each.

Embodiment 126. A method of using one or more computers to process audio data and a sequence of time-aligned tokens, the time-alignments of which do not necessarily increase in order of the sequence, into a language-learning activity.

Embodiment 127. A method of using one or more computers to update positions of language tokens in a first sequence of language tokens, the method comprising using the one or more computers to execute processing comprising:
creating a duplicate of the first sequence of language tokens;
rearranging language tokens in the duplicate of the first sequence of language tokens to create a new sequence of language tokens;
using a difference algorithm to create a description of an order of changing the positions of language tokens in the first sequence of language tokens that would make the first sequence of language tokens identical to the new sequence of language tokens; and
updating the positions of the language tokens in the sequence of language tokens by implementing the description of the order of changing the positions of language tokens in the sequence of language tokens to make the sequence of language tokens identical to the new sequence of language tokens.

Embodiment 128. The method of embodiment 127 wherein user input accepted through a graphical user interface (GUI) of the one or more computers defines how the language tokens in the duplicate of the sequence of language tokens become rearranged to create the new sequence of language tokens.

Embodiment 129. The method of embodiment 128 wherein the GUI:
displays the duplicate of the sequence of language tokens;
allows a user to create a rearrangement of language tokens from the duplicate of the sequence of language tokens; and
accepts the rearrangement of language tokens as the new sequence of language tokens.

Embodiment 130. The method of embodiment 127 wherein the other information associated with the language tokens in the sequence of language tokens includes numerical values.

Embodiment 131. The method of embodiment 127 wherein the other information associated with the language tokens in the sequence of language tokens includes timestamp ranges.

Embodiment 132. The method of embodiment 127 wherein the language tokens belong to a set of time-aligned metadata.

Embodiment 133. The method of embodiment 127 wherein the other information associated with the language tokens in the sequence of language tokens includes beginning values and ending values of timestamp ranges.

Embodiment 134. The method of embodiment 127 wherein the other information associated with the language tokens in the sequence of language tokens includes median values of time stamps in the timestamp ranges and durations of timestamp ranges.

Embodiment 135. The method of embodiment 127 wherein the other information associated with the language tokens in the sequence of language tokens includes median values of timestamp ranges and half-durations of timestamp ranges.

Embodiment 136. A method of using one or more computers to update positions of language tokens in a sequence of language tokens without affecting other information associated with the language tokens in the sequence of language tokens, the method comprising using the one or more computers to execute processing comprising:
creating a duplicate of the sequence of language tokens;
rearranging language tokens in the duplicate of the sequence of language tokens to create a new sequence of language tokens;
using a difference algorithm to create a description of an order of changing the positions of language tokens in the sequence of language tokens that would make the sequence of language tokens identical to the new sequence of language tokens; and
updating the positions of the language tokens in the sequence of language tokens by implementing the description of the order of changing the positions of language tokens in the sequence of language tokens to make the sequence of language tokens identical to the new sequence of language tokens.

Embodiment 137. The method of embodiment 136 wherein user input accepted through a graphical user interface (GUI) of the one or more computers defines how the language tokens in the duplicate of the sequence of language tokens become rearranged to create the new sequence of language tokens.

Embodiment 138. The method of embodiment 137 wherein the GUI:
displays the duplicate of the sequence of language tokens;
allows a user to create a rearrangement of language tokens from the duplicate of the sequence of language tokens; and
accepts the rearrangement of language tokens as the new sequence of language tokens.

Embodiment 139. The method of embodiment 136 wherein the other information associated with the language tokens in the sequence of language tokens includes information about ranges of numerical values.

Embodiment 140. The method of embodiment 136 wherein the other information associated with the language tokens in the sequence of language tokens includes information about timestamp ranges.

Embodiment 141. The method of embodiment 136 wherein the language tokens belong to a set of time-aligned metadata.

Embodiment 142. The method of embodiment 136 wherein the other information associated with the language tokens in the sequence of language tokens includes beginning values and ending values of timestamp ranges.

Embodiment 143. The method of embodiment 136 wherein the other information associated with the language tokens in the sequence of language tokens includes median values of timestamp ranges and durations of timestamp ranges.

Embodiment 144. The method of embodiment 136 wherein the other information associated with the language tokens in the sequence of language tokens includes median values of timestamp ranges and half-durations of timestamp ranges.

Embodiment 145. A system for interacting with audio data and time-aligned metadata, the system comprising:
one or more computers,
a creator of audio data,
a repository of audio data,
a creator of time-aligned metadata,
a processor of audio data and time-aligned metadata.
a player of audio data, and
a repository of time-aligned metadata.

Embodiment 146. The system of embodiment 145 wherein the creator of time-aligned metadata can create a sequence of time-aligned language tokens.

Embodiment 147. The system of embodiment 146 wherein each time-aligned language token can be associated with a timestamp range by the creator of time-aligned metadata.

Embodiment 148. The system of embodiment 147 wherein the timestamp ranges associated with different time-aligned language tokens can overlap.

Embodiment 149. The system of embodiment 147 wherein the timestamp ranges associated with different time-aligned language tokens can be nested.

Embodiment 150. The system of embodiment 147 wherein the timestamp ranges associated with different time-aligned language tokens cannot overlap.

Embodiment 151. The system of embodiment 147 wherein the timestamp ranges associated with different time-aligned language tokens do not necessarily increase in order of the sequence of time-aligned language tokens.

Embodiment 152. The system of embodiment 146 wherein each time-aligned language token can be associated with a timestamp.

Embodiment 153. The system of embodiment 152 wherein the timestamps associated with different time-aligned language tokens can be identical.

Embodiment 154. The system of embodiment 152 wherein the timestamps associated with different time-aligned language tokens cannot be identical.

Embodiment 155. The system of embodiment 152 wherein the timestamps associated with different time-aligned language tokens do not necessarily increase in order of the sequence of time-aligned language tokens.

Embodiment 156. The system of embodiment 145 wherein the creator of time-aligned metadata can accept user input through a graphical user interface (GUI) of the one or more computers.

Embodiment 157. The system of embodiment 145 wherein the creator of audio data can accept user input through a graphical user interface (GUI) of the one or more computers.

Embodiment 158. The system of embodiment 145 wherein the repository of audio data is a database maintained by the one or more computers.

Embodiment 159. The system of embodiment 145 wherein the player of audio data can play audio data through a speaker attached to the one or more computers.

Embodiment 160. The system of embodiment 145 wherein the repository of time-aligned metadata is a database maintained by the one or more computers.

Embodiment 161. The system of embodiment 145 further comprising an editor of time-aligned metadata.

Embodiment 162. The system of embodiment 161 wherein the editor of time-aligned metadata can update a sequence of time-aligned language tokens.

Embodiment 163. The system of embodiment 161 wherein the editor of time-aligned metadata can update a timestamp range associated with a language token in a sequence of time-aligned language tokens.

Embodiment 164. The system of embodiment 163 wherein the timestamp ranges associated with different time-aligned language tokens can overlap.

Embodiment 165. The system of embodiment 163 wherein the timestamp ranges associated with different time-aligned language tokens can be nested.

Embodiment 166. The system of embodiment 163 wherein the timestamp ranges associated with different time-aligned language tokens cannot overlap.

Embodiment 167. The system of embodiment 163 wherein the timestamp ranges associated with different time-aligned language tokens do not necessarily increase in order of the sequence of time-aligned language tokens.

Embodiment 168. The system of embodiment 161 wherein the editor of time-aligned metadata can update a timestamp associated with a language token in a sequence of time-aligned language tokens.

Embodiment 169. The system of embodiment 168 wherein the timestamps associated with different time-aligned language tokens can be identical.

Embodiment 170. The system of embodiment 168 wherein the timestamps associated with different time-aligned language tokens cannot be identical.

Embodiment 171. The system of embodiment 168 wherein the timestamps associated with different time-aligned language tokens do not necessarily increase in order of the sequence of time-aligned language tokens.

Embodiment 172. The system of embodiment 161 wherein the editor of time-aligned metadata can accept user input through a graphical user interface (GUI) of the one or more computers.

Embodiment 173. The system of embodiment 161 wherein the editor of time-aligned metadata can receive time-aligned metadata and other data from the repository of time-aligned metadata.

Embodiment 174. The system of embodiment 161 wherein the editor of time-aligned metadata can deposit time-aligned metadata and other data into the repository of time-aligned metadata.

Embodiment 175. The system of embodiment 161 wherein the editor of time-aligned metadata can update time-aligned metadata and other data in the repository of time-aligned metadata.

Embodiment 176. The system of embodiment 145 wherein, by causing the one or more computers to execute processing:
the creator of audio data can deposit audio data into the repository of audio data,
the player of audio data can receive audio data from the repository of audio data,
the processor of audio data and time-aligned metadata can receive time-aligned metadata from the repository of time-aligned metadata,
the player of audio data can receive information about timestamps within the audio data from the processor of audio data and time-aligned metadata,
the player of audio data can send information about timestamps within the audio data to the processor of audio data and time-aligned metadata,
the creator of time-aligned metadata can receive information about timestamps from the processor of audio data and time-aligned metadata,
the creator of time-aligned metadata can send time-aligned metadata to the processor of audio data and time-aligned metadata, and
the processor of audio data and time-aligned metadata can deposit time-aligned metadata into the repository of time-aligned metadata.

Embodiment 177. The system of embodiment 145 wherein the repository of audio data can also store other data.

Embodiment 178. The system of embodiment 145 wherein the repository of time-aligned metadata can also store other data.

Embodiment 179. The system of embodiment 161 wherein the editor of time-aligned metadata can receive time-aligned metadata from the processor of audio data and time-aligned metadata.

Embodiment 180. The system of embodiment 161 wherein time-aligned metadata received by the editor of time-aligned metadata from the processor of audio data and time-aligned metadata can be different from time-aligned metadata received by the processor of audio data and time-aligned metadata from the repository of time-aligned metadata.

Embodiment 181. The system of embodiment 161 wherein:
the editor of time-aligned metadata can receive information about timestamps from the processor of audio data and time-aligned metadata,
the editor of time-aligned metadata can send information about timestamps to the processor of audio data and time-aligned metadata,
the editor of time-aligned metadata can send time-aligned metadata to the processor of audio data and time-aligned metadata, and
the processor of audio data and time-aligned metadata can update time-aligned metadata in the repository of time-aligned metadata.

Embodiment 182. The system of embodiment 145 further comprising a renderer of time-aligned metadata.

Embodiment 183. The system of embodiment 145 wherein:
the renderer of time-aligned metadata can receive information about timestamps from the processor of audio data and time-aligned metadata and
the renderer of time-aligned metadata can receive time-aligned metadata from the processor of audio data and time-aligned metadata.

Embodiment 184. The system of embodiment 183 wherein time-aligned metadata received by the renderer of time-aligned metadata from the processor of audio data and time-aligned metadata can be different from time-aligned metadata received by the processor of audio data and time-aligned metadata from the repository of time-aligned metadata.

Embodiment 185. The system of embodiment 182 wherein the renderer of time-aligned metadata can display language tokens in a graphical user interface (GUI) of the one or more computers while the player of audio data plays corresponding audio data through one or more speakers attached to the one or more computers.

Embodiment 186. The system of embodiment 145 further comprising a creator of language learning activities.

Embodiment 187. The system of embodiment 183 wherein:
the creator of language learning activities can receive information about timestamps from the processor of audio data and time-aligned metadata and
the creator of language learning activities can receive time-aligned metadata from the processor of audio data and time-aligned metadata.

Embodiment 188. The system of embodiment 187 wherein time-aligned metadata received by the creator of language learning activities from the processor of audio data and time-aligned metadata can be different from time-aligned metadata received by the processor of audio data and time-aligned metadata from the repository of time-aligned metadata.

Embodiment 189. The system of embodiment 186 wherein the creator of language learning activities can display language tokens in a graphical user interface (GUI) of the one or more computers while the player of audio data plays corresponding audio data through one or more speakers attached to the one or more computers

Embodiment 190. The system of embodiment 186 wherein the creator of language learning activities can receive user input through a graphical user interface (GUI) of the one or more computers while the player of audio data plays corresponding audio data through one or more speakers attached to the one or more computers.

Embodiment 191. The system of embodiment 145 wherein the processor of audio data and time-aligned metadata can, by causing the one or more computers to execute processing, process time-aligned data that it receives from the repository of time-aligned metadata into different time-aligned metadata.

Embodiment 192. The system of embodiment 191 wherein the different time-aligned metadata comprises time-aligned language segments.

Embodiment 193. The system of embodiment 192 wherein the time-aligned language segments comprise a string of language tokens from the time-aligned metadata stored in the repository of time-aligned metadata, associated with a range of timestamps.

Embodiment 194. The system of embodiment 193 wherein the range of timestamps includes every timestamp that, in the repository of time-aligned metadata, was associated with a language token in the string of language tokens.

Embodiment 195. The system of embodiment 193 wherein the range of timestamps includes every timestamp range that, in the repository of time-aligned metadata, was associated with a language token in the string of language tokens.

Embodiment 196. The system of embodiment 192 wherein ranges of timestamps associated with different time-aligned language segments can be nested.

Embodiment 197. The system of embodiment 192 wherein ranges of timestamps associated with different time-aligned language segments can overlap.

Embodiment 198. The system of embodiment 192 wherein ranges of timestamps associated with different time-aligned language segments are mutually exclusive.

Embodiment 199. The system of embodiment 193 wherein one language token can be used to create more than one time-aligned language segment in the different time-aligned metadata.

Embodiment 200. A system of one or more computers configured for interacting with audio data and time-aligned metadata, the system comprising:
one or more data repositories configured to store audio data and metadata; and
one or more processors in communication with the one or more data repositories and configured to:
   generate and store time-aligned meta data in response input received from a user interface wherein the time-aligned meta data is time-aligned with audio data stored in the one or more databases; and
   generate, in response to input received through a user interface, a sequence of time-aligned language tokens wherein the time-aligned language tokens are time-aligned with the audio data.

Embodiment 201. A computer program product comprising computer executable instructions stored in a non-transitory medium that, when executed by one or more processors, cause the one or more processors to execute processing comprising the method of any of embodiments 1-200.

1-81. (canceled)

82. A method of using one or more computing devices to process a sequence of tokens, at least two of the tokens in the sequence each having a respective timestamp, the method comprising using the one or more computing devices to execute processing comprising:
identifying one or more subsequences of the sequence of tokens, each of the one or more subsequences being associated with a respective range of timestamps, wherein at least one timestamp is common to all of the respective ranges of timestamps that are associated with the one or more subsequences.

83. The method of claim 82 wherein the respective timestamps are not in monotonically increasing order in the sequence of tokens.

84. The method of claim 82 wherein one or more subsequences comprises two or more subsequences, and, for one or more of the respective ranges of timestamps, the at least one timestamp is not located at either boundary of the respective range of timestamps.

85. The method of claim 82 wherein one or more subsequences comprises three or more subsequences.

86. The method of claim 82 wherein each respective timestamp is based on a respective supporting set or range of one or more timestamps.

87. The method of claim 82 wherein the processing further comprises specifying a reference timestamp, and wherein at least one timestamp comprises at least the reference timestamp.

88. The method of claim 82 wherein at least one token is common to all of the one or more subsequences.

89. The method of claim 82 wherein identifying one or more subsequences of the sequence of tokens comprises:
arranging tokens that have respective timestamps into a new sequence in order of their respective timestamps;
selecting one or more timestamp-ordered subsequences from within the new sequence;
for each selected timestamp-ordered subsequence,
identifying a first token and a last token within the selected timestamp-ordered subsequence according to original positions of tokens in the sequence of tokens and
creating a reading subsequence comprising all tokens in the sequence of tokens from the first token to the last token, inclusive;
for each reading subsequence, associating said reading subsequence with an inclusive range of timestamps, the inclusive range of timestamps being inclusive of the timestamps of all tokens used in the reading subsequence; and
identifying, as the one or more subsequences of the sequence of tokens, at least one reading subsequence, wherein each identified reading subsequence has the at least one timestamp included in its associated inclusive range of timestamps.

90. The method of claim 89 wherein:
each respective timestamp is based on a respective supporting set or range of one or more timestamps that contains it; and
the inclusive range of timestamps being inclusive of the timestamps of all tokens used in the reading subsequence comprises the inclusive range of timestamps being inclusive of all timestamps contained in the respective supporting sets or ranges of one or more timestamps that correspond to each token used in the reading subsequence.

91. The method of claim 89 wherein selecting one or more timestamp-ordered subsequences from within the new sequence comprises splitting the new sequence into timestamp-ordered subsequences and selecting one or more of said timestamp-ordered subsequences.

92. The method of claim 89 wherein selecting one or more timestamp-ordered subsequences from within the new sequence comprises selecting the new sequence as a timestamp-ordered subsequence.

93. The method of claim 89 wherein identifying one or more subsequences of the sequence of tokens further comprises, prior to associating any reading subsequence with an inclusive range of timestamps, merging together, without duplication, any overlapping reading subsequences that are not nested, with each result of such merging being itself considered a reading subsequence.

94. The method of claim 89 wherein identifying one or more subsequences of the sequence of tokens further comprises, prior to associating each reading subsequence with an inclusive range of timestamps:
for each reading subsequence, stringing together the tokens contained in the reading sequence, in order, with zero or more delimiters inserted between tokens.

95. The method of claim 82 wherein the processing further comprises displaying, highlighting, bolding, italicizing, or otherwise visually indicating at least one of the one or more subsequences of the sequence of tokens through a graphical user interface (GUI).

96. The method of claim 82 wherein timestamps correspond to audio data and wherein the processing further comprises:
loading, pausing, or causing to start to play through one or more speakers a segment of the audio data that corresponds to part or all of a respective range of timestamps associated with at least one of the one or more subsequences.

97. The method of claim 82 wherein timestamps correspond to audio data and wherein the processing further comprises:
displaying, highlighting, bolding, italicizing, or otherwise visually indicating at least one of the one or more subsequences of the sequence of tokens through a graphical user interface (GUI); and
loading, pausing, or causing to start to play through one or more speakers a segment of the audio data that corresponds to part or all of a respective range of timestamps associated with at least one of the one or more subsequences.

98. The method of claim 82 wherein a first portion of the processing is performed by a first computing device, and a second portion of the processing is performed by a second computing device remote from the first computing device.

99. A computer program product comprising computer-executable instructions stored on a non-transitory medium, wherein execution of the instructions by one or more processors causes the one or more processors to perform processing of a sequence of tokens, at least two of the tokens in the sequence each having a respective timestamp, the processing comprising:
identifying one or more subsequences of the sequence of tokens, each of the one or more subsequences being associated with a respective range of timestamps, wherein at least one timestamp is common to all of the respective ranges of timestamps that are associated with the one or more subsequences.

100. The computer program product of claim 99 wherein the respective timestamps are not in monotonically increasing order in the sequence of tokens.

101. The computer program product of claim 99 wherein one or more subsequences comprises two or more subsequences, and, for one or more of the respective ranges of timestamps, the at least one timestamp is not located at either boundary of the respective range of timestamps.

102. The computer program product of claim 99 wherein one or more subsequences comprises three or more subsequences.

103. The computer program product of claim 99 wherein each respective timestamp is based on a respective supporting set or range of one or more timestamps.

104. The computer program product of claim 99 wherein the processing further comprises specifying a reference timestamp, and wherein at least one timestamp comprises at least the reference timestamp.

105. The computer program product of claim 99 wherein at least one token is common to all of the one or more subsequences.

106. The computer program product of claim 99 wherein identifying one or more subsequences of the sequence of tokens comprises:
arranging tokens that have respective timestamps into a new sequence in order of their respective timestamps;
selecting one or more timestamp-ordered subsequences from within the new sequence;
for each selected timestamp-ordered subsequence,
identifying a first token and a last token within the selected timestamp-ordered subsequence according to original positions of tokens in the sequence of tokens and
creating a reading subsequence comprising all tokens in the sequence of tokens from the first token to the last token, inclusive;
for each reading subsequence, associating said reading subsequence with an inclusive range of timestamps, the inclusive range of timestamps being inclusive of the timestamps of all tokens used in the reading subsequence; and
identifying, as the one or more subsequences of the sequence of tokens, at least one reading subsequence, wherein each identified reading subsequence has the at least one timestamp included in its associated inclusive range of timestamps.

107. The computer program product of claim 106 wherein:
each respective timestamp is based on a respective supporting set or range of one or more timestamps that contains it; and
the inclusive range of timestamps being inclusive of the timestamps of all tokens used in the reading subsequence comprises the inclusive range of timestamps being inclusive of all timestamps contained in the respective supporting sets or ranges of one or more timestamps that correspond to each token used in the reading subsequence.

108. The computer program product of claim 106 wherein selecting one or more timestamp-ordered subsequences from within the new sequence comprises splitting the new sequence into timestamp-ordered subsequences and selecting one or more of said timestamp-ordered subsequences.

109. The computer program product of claim 106 wherein selecting one or more timestamp-ordered subsequences from within the new sequence comprises selecting the new sequence as a timestamp-ordered subsequence.

110. The computer program product of claim 106 wherein identifying one or more subsequences of the sequence of tokens further comprises, prior to associating any reading subsequence with an inclusive range of timestamps, merging together, without duplication, any overlapping reading subsequences that are not nested, with each result of such merging being itself considered a reading subsequence.

111. The computer program product of claim 106 wherein identifying one or more subsequences of the sequence of tokens further comprises, prior to associating each reading subsequence with an inclusive range of timestamps:
for each reading subsequence, stringing together the tokens contained in the reading sequence, in order, with zero or more delimiters inserted between tokens.

112. The computer program product of claim 99 wherein the processing further comprises displaying, highlighting, bolding, italicizing, or otherwise visually indicating at least one of the one or more subsequences of the sequence of tokens through a graphical user interface (GUI).

113. The computer program product of claim 99 wherein timestamps correspond to audio data and wherein the processing further comprises:
loading, pausing, or causing to start to play through one or more speakers a segment of the audio data that corresponds to part or all of a respective range of timestamps associated with at least one of the one or more subsequences.

114. The computer program product of claim 99 wherein timestamps correspond to audio data and wherein the processing further comprises:
displaying, highlighting, bolding, italicizing, or otherwise visually indicating at least one of the one or more subsequences of the sequence of tokens through a graphical user interface (GUI); and
loading, pausing, or causing to start to play through one or more speakers a segment of the audio data that corresponds to part or all of a respective range of timestamps associated with at least one of the one or more subsequences.

115. The computer program product of claim 99 wherein a first portion of the processing is performed by a first computing device, and a second portion of the processing is performed by a second computing device remote from the first computing device.
